(19) United States
(12) Patent Application Publication
(10) Pub. No.: US 2018/0167586 A1
(43) Pub. Date: Jun. 14, 2018

(54) SATELLITE IMAGING SYSTEM WITH EDGE PROCESSING

(71) Applicant: Elwha LLC, Bellevue, WA (US)

(72) Inventors: Phillip Rutschman, Seattle, WA (US); Ehren Brav, Bainbridge Island, WA (US); Russell Hannigan, Sammamish, WA (US); Roderick A. Hyde, Redmond, WA (US); Muriel Y. Ishikawa, Livermore, CA (US); 3ric Johanson, Seattle, WA (US); Jordin T. Kare, San Jose, CA (US); Tony S. Pan, Bellevue, WA (US); Clarence T. Tegreene, Mercer Island, WA (US); Charles Whitmer, North Bend, WA (US); Lowell L. Wood, JR., Bellevue, WA (US); Victoria Y.H. Wood, Livermore, CA (US); Travis P. Dorschel, Issaquah, WA (US)

(73) Assignee: Elwha LLC, Bellevue, WA (US)

(21) Appl. No.: 15/844,293

(22) Filed: Dec. 15, 2017

Related U.S. Application Data
(63) Continuation-in-part of application No. 15/787,075, filed on Oct. 18, 2017.
Application No. 15/787,075 is a continuation-in-part of application No. 15/698,147, filed on Sep. 7, 2017.
Application No. 15/698,147 is a continuation-in-part of application No. 15/697,893, filed on Sep. 7, 2017.
Application No. 15/697,893 is a continuation-in-part of application No. 14/838,114, filed on Aug. 27, 2015.
Application No. 14/838,114 is a continuation-in-part of application No. 14/838,128, filed on Aug. 27, 2015.
Application No. 14/838,128 is a continuation-in-part of application No. 14/791,160, filed on Jul. 2, 2015, now Pat. No. 9,866,765.
Application No. 14/791,160 is a continuation-in-part of application No. 14/791,127, filed on Jul. 2, 2015, now Pat. No. 9,924,109.
Application No. 14/791,127 is a continuation-in-part of application No. 14/714,239, filed on May 15, 2015.
Application No. 14/714,239 is a continuation-in-part of application No. 14/951,348, filed on Nov. 24, 2015, now Pat. No. 9,866,881.
Application No. 14/951,348 is a continuation-in-part of application No. 14/945,342, filed on Nov. 18, 2015, now Pat. No. 9,942,583.
Application No. 14/945,342 is a continuation-in-part of application No. 14/941,181, filed on Nov. 13, 2015, now abandoned.
(60) Provisional application No. 62/180,040, filed on Jun. 15, 2015.
(60) Provisional application No. 62/156,162, filed on May 1, 2015.
(60) Provisional application No. 62/082,002, filed on Nov. 19, 2014.
(60) Provisional application No. 62/082,001, filed on Nov. 19, 2014.
(60) Provisional application No. 62/081,560, filed on Nov. 18, 2014.
(60) Provisional application No. 62/081,559, filed on Nov. 18, 2014.
(60) Provisional application No. 62/522,493, filed on Jun. 20, 2017.
(60) Provisional application No. 62/532,247, filed on Jul. 13, 2017.
(60) Provisional application No. 62/384,685, filed on Sep. 7, 2016.
(60) Provisional application No. 62/429,302, filed on Dec. 2, 2016.
(60) Provisional application No. 62/537,425, filed on Jul. 26, 2017.
(60) Provisional application No. 62/571,948, filed on Oct. 13, 2017.

(51) Int. Cl. H04N 7/18; H04N 5/33; H04N 5/247; H04N 5/232

(52) U.S. Cl. CPC H04N 7/181; H04N 5/23296; H04N 5/247; H04N 5/33

(57) ABSTRACT

In one embodiment, a satellite imaging system with edge processing includes, but is not limited to, at least one first imaging unit configured to capture and process imagery of a first field of view; at least one second imaging unit configured to capture and process imagery of a second field of view that is proximate to and larger than a size of the first field of view; and a hub processing unit linked to the at least one first imaging unit and the at least one second imaging unit.

### PRIORITY CLAIM

This application claims priority to and/or the benefit of the following patent applications under 35 U.S.C. 119 or 120, and any and all parent, grandparent, or continuations or continuations-in-part thereof: U.S. Non-Provisional application Ser. No. 14/838,114 filed Aug. 27, 2015 (Docket No. 1114-003-003-000000); U.S. Non-Provisional application Ser. No. 14/838,128 filed Aug. 27, 2015 (Docket No. 1114-003-007-000000); U.S. Non-Provisional application Ser. No. 14/791,160 filed Jul. 2, 2015 (Docket No. 1114-003-006-000000); U.S. Non-Provisional application Ser. No. 14/791,127 filed Jul. 2, 2015 (Docket No. 1114-003-002-000000); U.S. Non-Provisional application Ser. No. 14/714,239 filed May 15, 2015 (Docket No. 1114-003-001-000000); U.S. Non-Provisional application Ser. No. 14/951,348 filed Nov. 24, 2015 (Docket No. 1114-003-008-000000); U.S. Non-Provisional application Ser. No. 14/945,342 filed Nov. 18, 2015 (Docket No. 1114-003-004-000000); U.S. Non-Provisional application Ser. No. 14/941,181 filed Nov. 13, 2015 (Docket No. 1114-003-009-000000); U.S. Non-Provisional application Ser. No. 15/698,147 filed Sep. 7, 2017 (Docket No. 1114-003-010A-000000); U.S. Non-Provisional application Ser. No. 15/697,893 filed Sep. 7, 2017 (Docket No. 1114-003-010B-000000); U.S. Non-Provisional application Ser. No. 15/787,075 filed Oct. 18, 2017 (Docket No. 1114-003-010B-000001); U.S. Provisional Application 62/180,040 filed Jun. 15, 2015 (Docket No. 1114-003-001-PR0006); U.S. Provisional Application 62/156,162 filed May 1, 2015 (Docket No. 1114-003-005-PR0001); U.S. Provisional Application 62/082,002 filed Nov. 19, 2014 (Docket No. 1114-003-004-PR0001); U.S. Provisional Application 62/082,001 filed Nov. 19, 2014 (Docket No. 1114-003-003-PR0001); U.S. Provisional Application 62/081,560 filed Nov. 18, 2014 (Docket No. 1114-003-002-PR0001); U.S. Provisional Application 62/081,559 filed Nov. 18, 2014 (Docket No. 1114-003-001-PR0001); U.S. Provisional Application 62/522,493 filed Jun. 20, 2017 (Docket No. 1114-003-011-PR0001); U.S. Provisional Application 62/532,247 filed Jul. 13, 2017 (Docket No. 1114-003-012-PR0001); U.S. Provisional Application 62/384,685 filed Sep. 7, 2016 (Docket No. 1114-003-010-PR0001); U.S. Provisional Application 62/429,302 filed Dec. 2, 2016 (Docket No. 1114-003-010-PR0002); U.S. Provisional Application 62/537,425 filed Jul. 26, 2017 (Docket No. 1114-003-013-PR0001); U.S. Provisional Application 62/571,948 filed Oct. 13, 2017 (Docket No. 1114-003-014-PR0001).

The foregoing applications are incorporated by reference in their entirety as if fully set forth herein.

### FIELD OF THE INVENTION

Embodiments disclosed herein relate generally to a satellite imaging system with edge processing.

### SUMMARY

In one embodiment, a satellite imaging system with edge processing includes, but is not limited to, at least one first imaging unit configured to capture and process imagery of a first field of view; at least one second imaging unit configured to capture and process imagery of a second field of view that is proximate to and larger than a size of the first field of view; and a hub processing unit linked to the at least one first imaging unit and the at least one second imaging unit.

In another embodiment, a satellite constellation includes, but is not limited to, an array of satellites that each include a satellite imaging system including at least at least one first imaging unit configured to capture and process imagery of a first field of view; at least one second imaging unit configured to capture and process imagery of a second field of view that is proximate to and that is larger than a size of the first field of view; and a hub processing unit linked to the at least one first imaging unit and the at least one second imaging unit.

In a further embodiment, a satellite with image edge processing includes, but is not limited to, a satellite bus with an imaging system including at least an array of nine first imaging units arranged in a grid and each configured to capture and process imagery of a respective first field of view; an array of six second imaging units each configured to capture and process imagery of a respective second field of view that is proximate to and larger than the first field of view; an array of eleven independently movable third imaging units each configured to capture and process imagery of a third field of view that is smaller than the first field of views and that is directable at least within the first field of views and the second field of views; at least one fourth imaging unit configured to capture and process imagery of an fourth field of view that at least includes the first field of views and the second field of views; and a hub processing unit linked to each of the nine first imaging units, the six second imaging units, the eleven independently movable third imaging units, and the at least one fourth imaging unit.

### BRIEF DESCRIPTION OF THE DRAWINGS

Embodiments are described in detail below with reference to the following drawings:

FIG. 1 is perspective view of a satellite imaging system with edge processing, in accordance with an embodiment;

FIG. 2 is a perspective view of a global imager component of a satellite imaging system with edge processing, in accordance with an embodiment;

FIGS. 3A and 3B are perspective and cross-sectional views of a spot imager component of a satellite imaging system with edge processing, in accordance with an embodiment;

FIG. 4 is a field of view diagram of a satellite imaging system with edge processing, in accordance with an embodiment;

FIGS. 5-15 are component diagrams of a satellite imaging system with edge processing, in accordance with various embodiments;

FIG. 16 is a perspective view of a satellite constellation of an array of satellites that each include a satellite imaging system, in accordance with an embodiment;

FIG. 17 is a diagram of a communications system involving the satellite constellation, in accordance with an embodiment;

FIG. 18 is a component diagram of a satellite constellation of an array of satellites that each include a satellite imaging system, in accordance an embodiment;

FIG. 19 is a sample mass budget of a satellite imaging system, in accordance with an embodiment;

FIG. 20 is a sample mass estimate for a global imaging array, in accordance with an embodiment;

FIG. 21 is a possible power budget of an imaging system, in accordance with an embodiment;

FIG. 22 is a possible Delta-V budget that can be used as part of a launch strategy, in accordance with an embodiment; and

FIGS. 23-33 are Earth coverage charts of various satellite configurations (e.g., percentage of time with at least one satellite in view above specified elevation angles relative to the horizon at certain latitudes OR percentage of time a specified number of satellites are above specified elevation angle at certain latitudes), in accordance with various embodiments.

### DETAILED DESCRIPTION

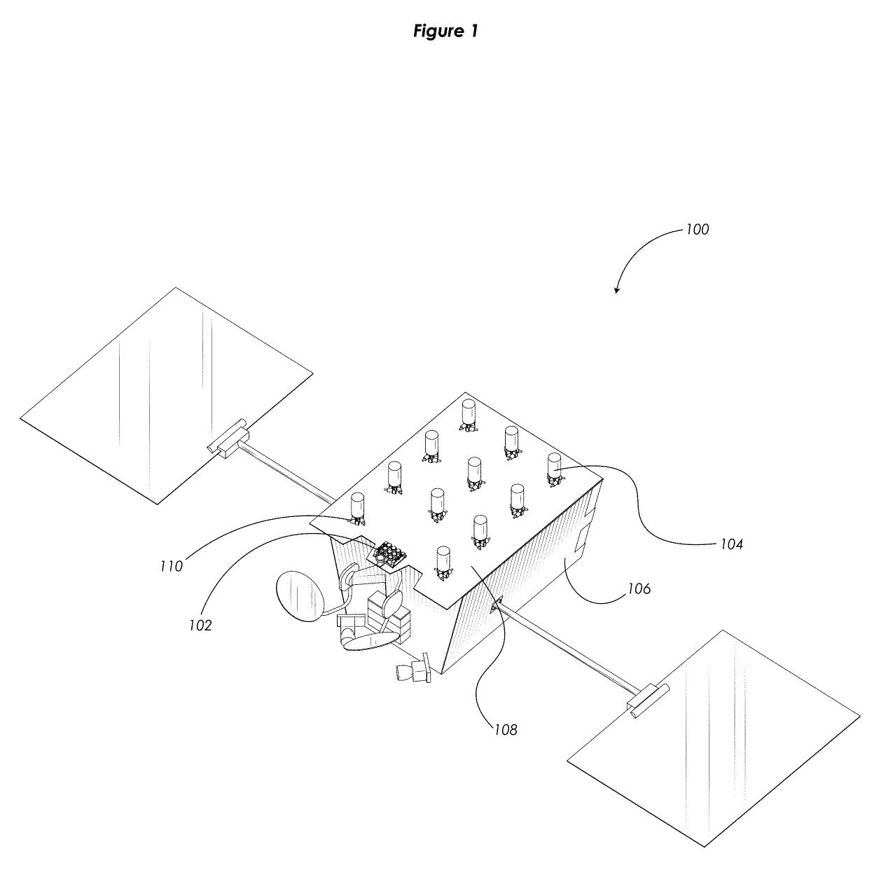

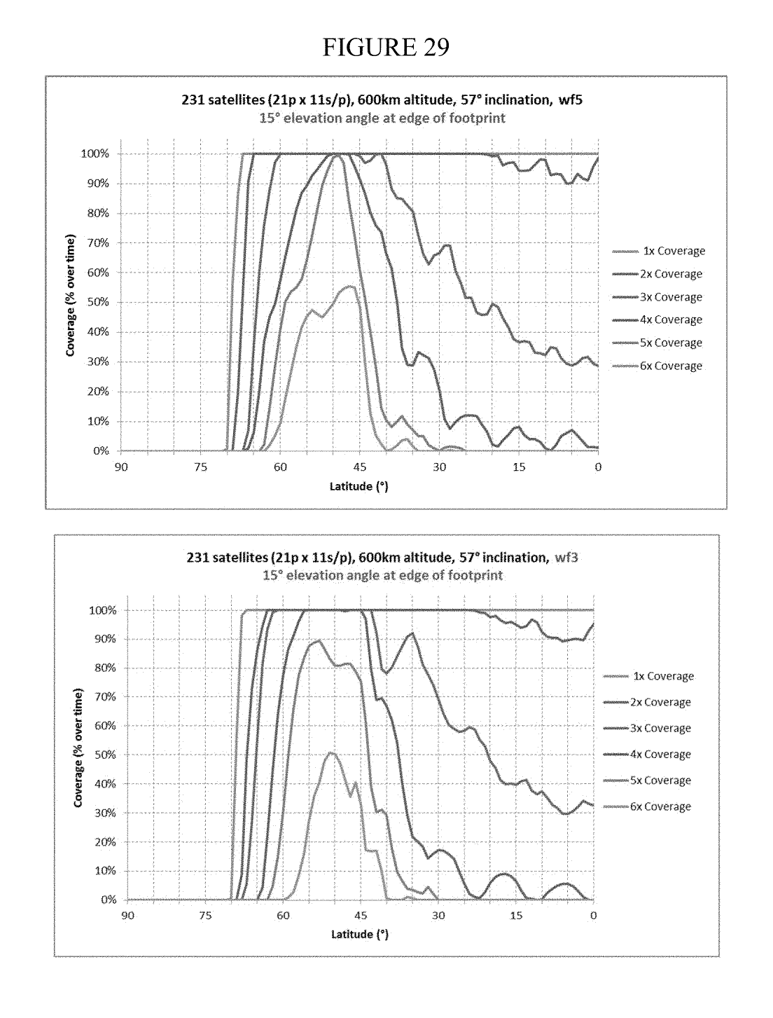

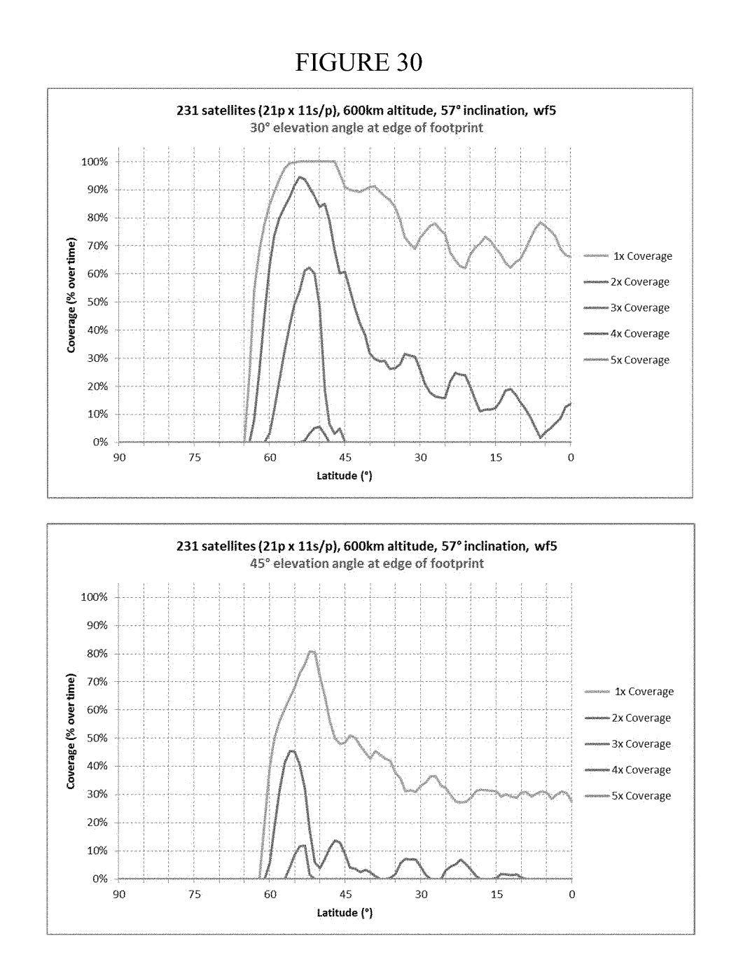

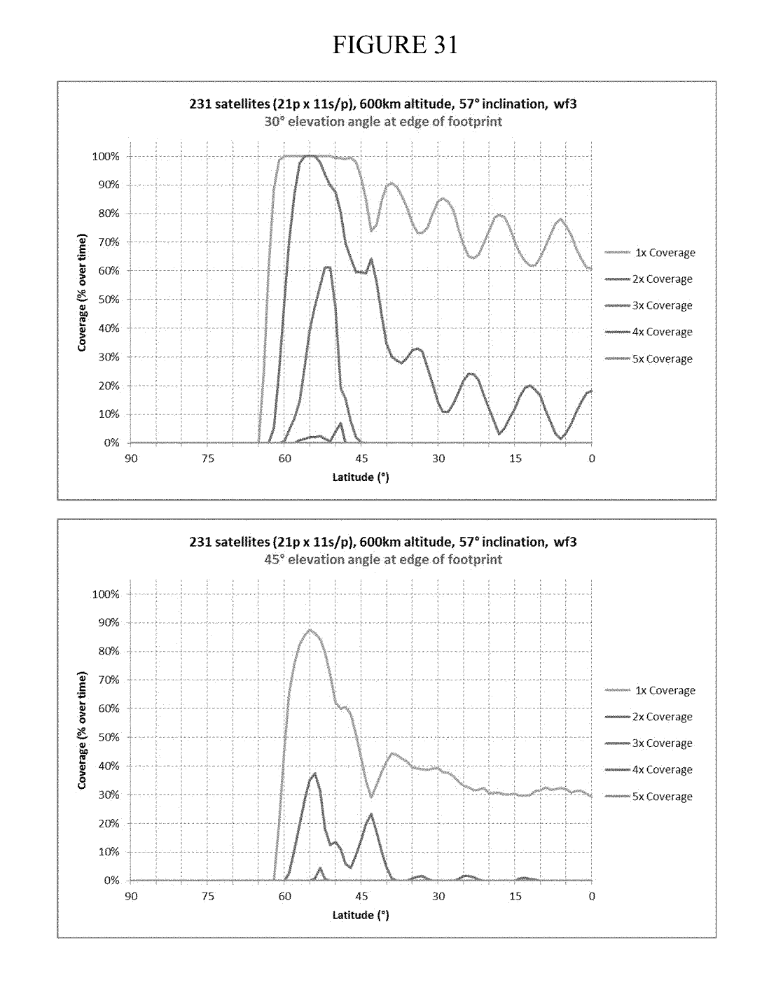

Embodiments disclosed herein relate generally to a satellite imaging system with edge processing. Specific details of certain embodiments are set forth in the following description and in FIGS. 1-33 to provide a thorough understanding of such embodiments.

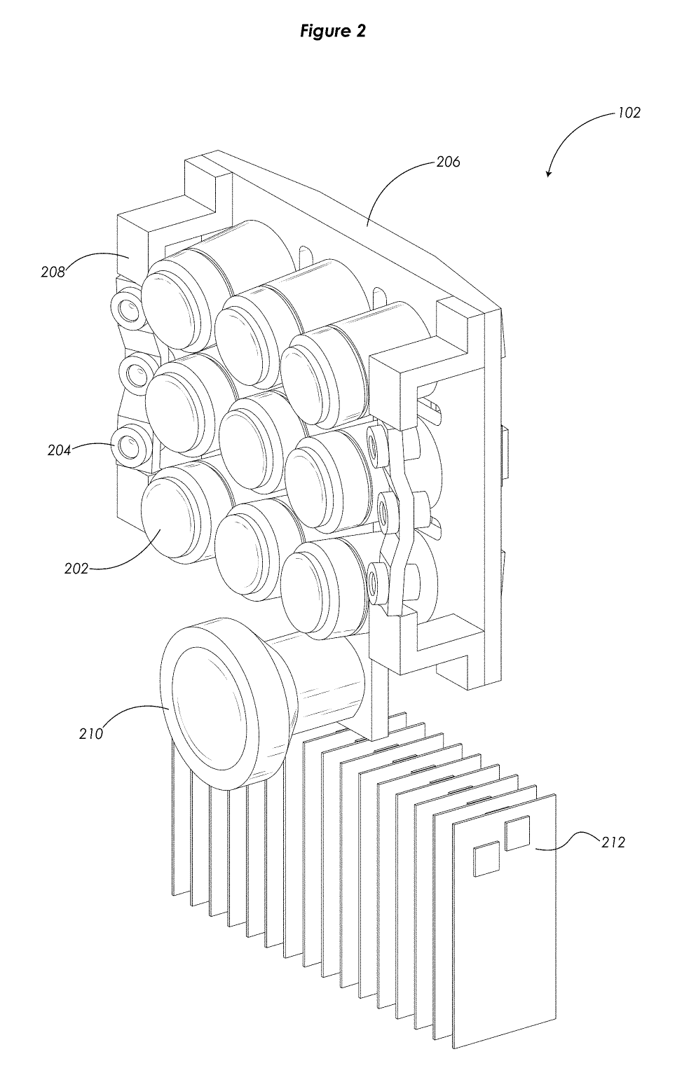

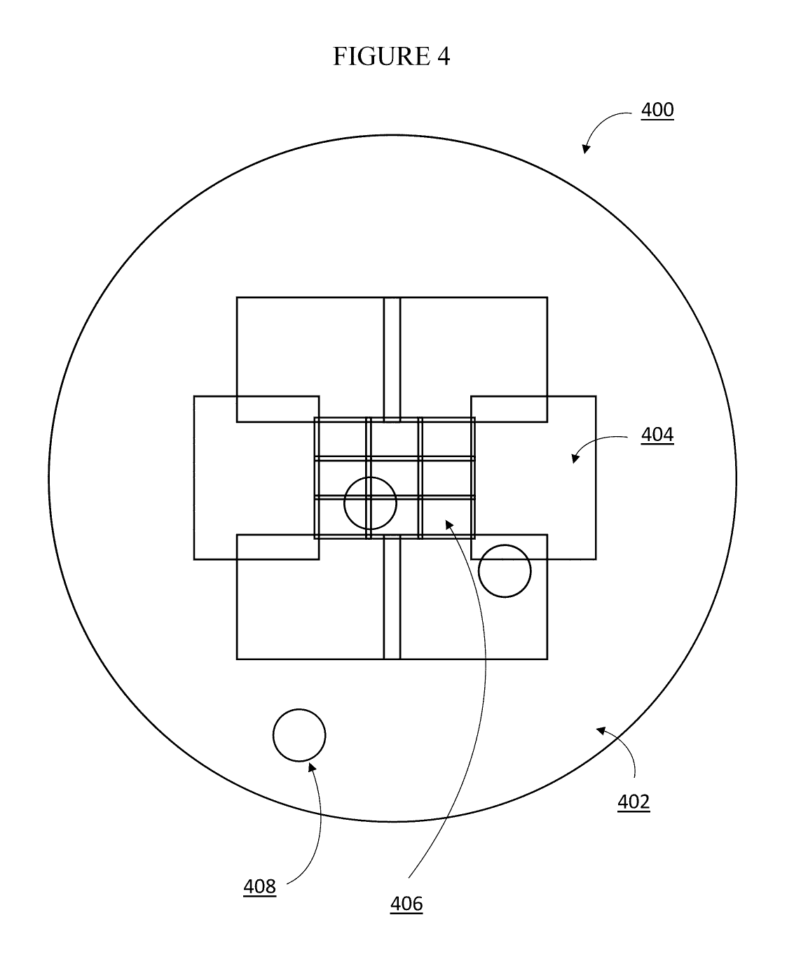

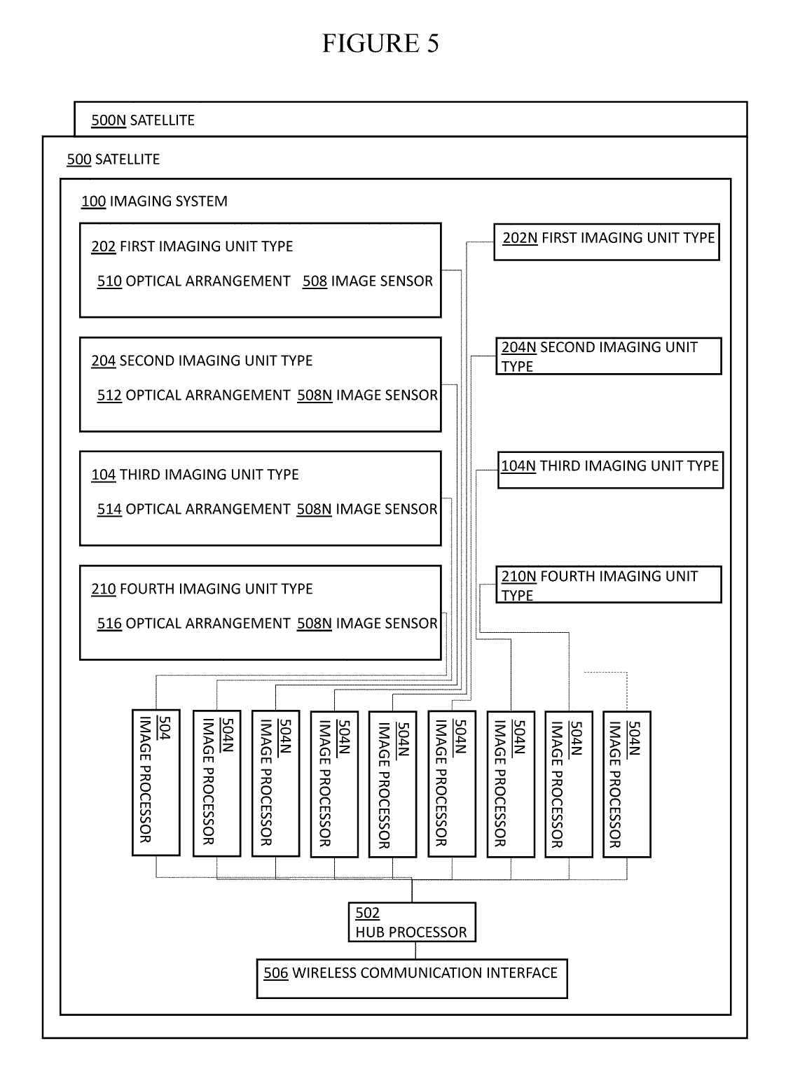

FIG. 1 is perspective view of a satellite imaging system with edge processing, in accordance with an embodiment. In one embodiment, a satellite imaging system 100 with edge processing includes, but is not limited to, (i) a global imaging array 102 including at least one first imaging unit (FIG. 2) configured to capture and process imagery of a first field of view (FIG. 4), at least one second imaging unit (FIG. 2) configured to capture and process imagery of a second field of view (FIG. 4) that is proximate to and larger than a size of the first field of view, and/or at least one fourth imaging unit (FIG. 2) configured to capture and process imagery of a field of view (FIG. 4) that at least includes the first field of view and the second field of view; and/or (ii) at least one third imaging unit 104 configured to capture and process imagery of a movable field of view (FIG. 4) that is smaller than the first field of view. The satellite imaging system 100 includes a hub processing unit (FIG. 5) linked to the at least one first imaging unit, the at least one second imaging unit, the at least one third imaging unit 104, and/or the at least one fourth imaging unit; and at least one wireless communication interface (FIG. 5) linked to the hub processing unit. The satellite imaging system 100 is mounted to at least one satellite bus 106.

In one embodiment, the satellite imaging system 100 includes one global imaging array 102 and nine steerable spot imagers 104. The steerable spot imagers 104 can include two additional backup steerable spot imagers 104 for a total of eleven. The steerable spot imagers 104 and the global imaging array 102 are mounted to a plate 108, with the global imaging array 102 fixed and the steerable spot imagers 104 being pivotable, such as via gimbals 110. The plate 108 is positioned on the satellite bus 106 and can include a shock absorber to absorb vibration. In certain embodiments, there can be included two or more instances of the global imaging array 102. The global imaging array 102 can itself be movable relative to the plate 108, such as via a track or gimbal. Likewise, there can be more or fewer of the steerable spot imagers 104 and any of the steerable spot imagers can be fixed and non-movable.

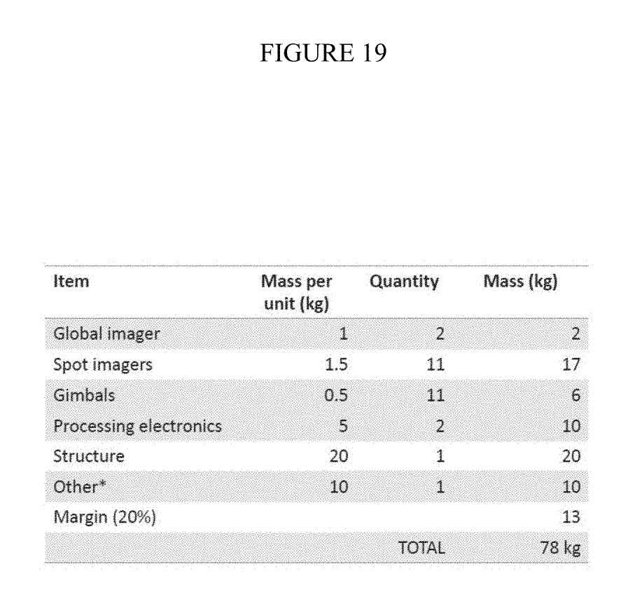

The satellite bus 106 can be a kangaroo-style AIRBUS ONEWEB SATELLITE bus that is deployable from a stowed state, such as by using a one-time hinge, and can be compliant for a SOYUZ/OW dispenser (4 meter class). Shielding can be provided to protect the global imaging array 102 and the steerable spot imagers 104 in the space environment, such as to protect against radiation. A possible mass budget of the satellite imaging system 100 is provided in FIG. 19 with the entire satellite mass being approximately 150 kg in this embodiment.

The global imaging array 102 can include approximately ten to twenty imagers (FIG. 2) to provide horizon-to-horizon imaging coverage in the visible and/or infrared/near-infrared ranges at a resolution of approximately 0.5-40 meters (nadir). The approximately nine to eleven steerable spot imagers 104 can each provide a respective field of view of twenty km in diagonal in the visible and/or infrared/near-infrared ranges at a resolution of approximately 0.5-3 meters (nadir). The steerable spot imagers 104 are independently pointable at specific areas of interest and each provide high to super-high resolution (e.g., one to four meter resolution) RGB and/or near IR video. The global imaging array 102 blankets substantially an entire field of view from horizon-to-horizon with low to medium resolution (e.g., twenty-five to one-hundred meter resolution) RGB and/or near IR video. Combined, the satellite imaging system 100 can include up to seventy or more imagers, with fewer or greater numbers of any particular imaging units.

The satellite imaging system 100 can capture hundreds of gigabytes per second of image data (e.g., using an array of sensors each capturing approximately twenty megapixels of imagery at twenty frames per second). The image data is processed onboard the satellite imaging system 100 through use of up to forty, fifty, sixty, or more processors. The onboard processing reduces the image data to that which is requested or required to reduce bandwidth requirements and overcome the space-to-ground bandwidth bottleneck, thereby enabling use of relatively low transmission bandwidths limited to up to between a few bytes per second to approximately a couple hundred megabytes per second or even a few gigabytes per second.

Applications of the satellite imaging system 100 are numerous and can include, for example, providing real-time high resolution horizon-to-horizon and close-up video of Earth that is user-controlled; providing augmented video/imagery; enabling simultaneous user access; enabling games; hosting local applications for enabling machine vision for interpretation of raw pre- or non-transmitted high resolution image data; providing a constantly updated video Earth model, or other useful purpose.

For example, high-resolution real-time or near-real-time video imagery of approximately one to three to ten or more meter resolution and approximately twenty-frames per second can be provided for any part of Earth in view under user control. This is accomplished in part using techniques such as pixel decimation to retain and transmit image content where resolution is held substantially constant independent of zoom level. That is, pixels are discarded or retained based on a level of zoom requested. Additional bandwidth reduction can be performed to remove imagery outside selected areas, remove previously transmitted static objects, remove previously transmitted imagery, remove overlapping imagery of simultaneous request(s), or other pixel reduction operation. Compression on remaining image data can also be used. The overall result of one or more of these techniques is enabling data transfer of select imagery at high resolutions using only a few to a hundred megabits per second of bandwidth. Live deep-zooming of imagery is enabled where image resolution is effectively decoupled from bandwidth and where multiple simultaneous users can access the image data and have full control over the field of view, pan, and zoom within an overall Earth scene.

Augmented video mode enables augmentation of imagery with information that is relevant to or of user interest. For instance, real-time news regarding an area of focus can be added to imagery. The augmentations can be dependent on zoom and/or the viewing window, such as to provide time and scene dependent information of potential interest, such as news, tweets, event information, product information, travel offers, stories, or other information that enhances a media experience.

Multiple simultaneous or near-simultaneous users can independently control pan and zoom within a scene of Earth for a customized experience. Further, multiple simultaneous or near-simultaneous user request can be satisfied by transmitting only once overlapping or previously transmitted imagery for reconstitution with non-duplicative or changing imagery at a ground station or server prior to transmission to a user.

Games that use real-time or near-real-time imagery can be augmented or complimented by time-dependent or location-dependent information, such as treasure hunts, POKEMON GO style games, or other games that evolve in-line with events on the ground.

Additionally, satellite-based hosting of applications and the onboard processing of the raw imagery data can enable satellite-level interpretation and analysis, also referred to as machine vision, artificial intelligence, or on-board processing. Applications can be uploaded for hosting, which applications have direct pre-transmission continuous local access to full pixel data of an entire captured scene for analysis and interpretation on a real-time, near-real-time, periodic, or non-real-time basis. Hosted applications can be customized for business or user needs and can perform functions such as monitoring, analyzing, interpreting, or reporting on certain events or objects or features. Output of the image processing, which can be imagery, textual, or binary data, can be transmitted in real-time or near-real-time, thereby enabling remote client access to output and/or high resolution imagery without unnecessary bandwidth burdens. Multiple applications can operate in parallel, using the same or different imagery data for different purposes. For instance, one application can search and monitor for large ships and/or airliners while another application can monitor for large ice shelves calving or animal migration. Specific examples of applications include, but are not limited to (1) constant monitoring of substantially entire planet to detect, analyze, and report on forest fires to enable early detection and reduce fire-fighting man-power and costs; (2) constant monitoring, analyzing, and reporting of calving and break-up of sea-ice and other Artic and Antartic phenomena for use in global climate change modeling or evaluating shipping lanes; (3) constant monitoring, detecting, analyzing, and reporting on volcano hots spots or eruptions as they occur for use in science, weather, climate, commercial, or air traffic management applications; (4) detecting and monitoring events in advance of positioning satellite assets; (5) constant monitoring, analyzing, and reporting on croplands (e.g. 1.22-1.71 billion hectares of Earth), crop growth, maturation, stress, harvesting, such as to determine when and where to irrigate, fertilize, seed crops, use herbicides for increasing yields or reducing costs; (6) tracking objects independent of visual noise or other objects (e.g., vehicles, ships, whale breaches, airplanes); (7) comparing airplane and ship image data to flight plan, ADS-B, and AIS information to identify and/or determine legality of presence or activity; (8) identify specific large animals such as whales using signatures detected through temporal changes from frame-to-frame; (9) monitor animal migration, feeding, or patterns; (10) tracking moving assets in real-time; (11) detecting velocity, heading, and altitude of objects; (12) detecting temporal effects such as a whale spout, lightning strikes, explosions, collisions, eruptions, earthquakes, and/or natural disasters; (13) detect anomalies; (14) 3D reconstruction using multiple 2D images or video streams; (15) geofencing or area security; (16) border control; (17) infrastructure monitoring; (18) resource monitoring; (19) food security monitoring; (20) disaster warning (21) geological change monitoring; (22) urban area change monitoring; (23) urban traffic management; (24) aircraft and ship traffic management; (25) logistics, (26) auto-change detection (e.g., monitoring to detect movement or change in coverage area and notifying a user or performing a task), or the like.

A historical earth video model can be built and regularly updated to enable a historical high-definition archive of Earth video imagery, such as for playing, fast-forwarding, rewinding for (1) viewing events, changes, and/or metadata related to the same; (2) performing post detection identification; (3) performing predictive modeling; (4) asset counting; (5) accident investigation; (6) providing virtual reality content; (7) performing failure, disaster, missing asset investigations; or the like.

The above functionality can be useful in fields or contexts such as, but not limited to, news reporting, maritime activities, national security or intelligence, border control, tsunami warning, floods, launch vehicle flight tracking, oil/gas spillage, asset transportation, live and interactive learning/teaching, traffic management, volcanic activities, forest fires, consumer curiosity, animal migration tracking, media, environmental, socializing, education, exploration, tornado detection, business intelligence, illegal fishing, shipping, mapping, agriculture, weather forecasting, environmental monitoring, disaster support, defense, analytics, finance, social media, interactive learning, games, television, or the like.

FIG. 2 is a perspective view of a global imager component of a satellite imaging system with edge processing, in accordance with an embodiment. In one embodiment, the global imaging array 102 includes, but is not limited to, at least one first imaging unit 202 configured to capture and process imagery of a first field of view (FIG. 4); at least one second imaging unit 204 configured to capture and process imagery of a second field of view (FIG. 4) that is proximate to and larger than a size of the first field of view; and a hub processing unit (FIG. 5) linked to the at least one first imaging unit 202 and the at least one second imaging unit 204. In one particular embodiment, the at least one first imaging unit 202 includes an array of nine first imaging units 202 arranged in a grid and each configured to capture and process imagery of a respective field of view as tiles of at least a portion of a scene. In another particular embodiment, the at least one second imaging unit 204 includes array of six second imaging units 204 arranged on opposing sides of the at least one first imaging unit 202 and each configured to capture and process imagery of a respective field of view as tiles of at least a portion of a scene. In a further particular embodiment, at least one fourth imaging unit 210 is provided and configured to capture and process imagery of a field of view (FIG. 4) that at least includes the first field of view and the second field of view.

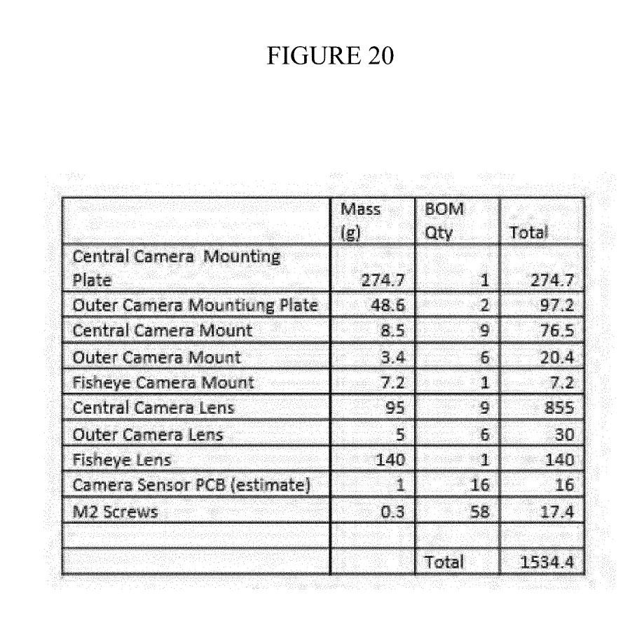

In one embodiment, the global imaging array 102 includes, but is not limited to, a central mounting plate 206; an outer mounting plate 208; mounting hardware for each of the inner imaging units 202, the outer imaging units 204, and fisheye imaging unit 210; and one or more image processors 212. The inner imaging units 202 and the fisheye imaging unit 210 are mounted to the central mounting plate 206 using mounting hardware. The outer imaging units 204 are mounted to the outer mounting plate 208 using mounting hardware, which outer mounting plate 208 is secured to the central mounting plate 206 using fasteners. The central mounting plate 206 and the outer mounting plate 208 can comprise aluminum machined frames. Furthermore, the central mounting plate 206 and the outer mounting plate 208 and/or the mounting hardware can provide for lateral slop to allow accurate setting and pointing of each of the respective the inner imaging units 202, the outer imaging units 204, and the fisheye imaging unit 210. Any of the inner imaging units 202, the outer imaging units 204, and the fisheye imaging unit 210 can be focusable. A sample mass estimate for the global imaging array 102 is provided in FIG. 20.

Many modifications to the global imaging array 102 are possible. For example, fewer or greater numbers of the inner imaging units 202, the outer imaging units 204, and the fisheye imaging unit 210 are possible (e.g., zero to tens to hundreds of respective imaging units). Furthermore, the arrangement of any of the inner imaging units 202, the outer imaging units 204, and the fisheye imaging unit 210 can be different. The arrangement can be linear, circular, spherical, cubical, triangular, or any other regular or irregular pattern. The arrangement can also include the outer imaging units 204 positioned above, below, beside, on some sides, or on all sides of the inner imaging units 202. The fisheye imaging unit 210 can be similarly positioned above, below, or to one or more sides of either the inner imaging units 202 or the outer imaging units 204. Likewise, changes can be made to the central mounting plate 206 and/or the outer mounting plate 208, including a unitary structure that combines the central mounting plate 206 and the outer mounting plate 208. The central mounting plate 206 and/or the outer mounting plate 208 can be square, rectangular, oval, curved, convex, concave, partially or fully spherical, triangular, or another regular or irregular two or three-dimensional shape. Furthermore, the image processors 212 are depicted as coupled to the central mounting plate 206, but the image processors 212 can be moved to one or more different positions as needed or off of the global imaging array 102.

The fisheye imaging unit 210 provides a super wide field of view for an overall scene view. Typically, one or two fisheye imaging unit 210 is provided per global imaging array 102 and includes a lens, image sensor (infrared and/or visible), and an image processor, which may be dedicated or part of a pool of available image processors (FIG. 5). The lens can comprise a ½ Format, C-Mount, 1.4 mm focal length lens from EDMUND OPTICS. This particular lens has the following characteristics: focal length 1.4; maximum sensor format ½″, field of view for ½″ sensor 185×185 degrees; working distance of 100 mm-infinity; aperture f/1.4-f/16; diameter 56.5 mm; length 52.2 mm; weight 140 g; mount C; fixed focal length; and RoHS C. Other lenses of similar characteristics can be substituted for this particular example lens.

The inner imaging unit 202 provides a more narrow field of view for central imaging. Typically, up to approximately nine first imaging units 202 are provided per global imaging array 102 and each includes a lens, image sensor (infrared and/or visible), and an image processor, which may be dedicated or part of a pool of available image processors (FIG. 5). The lens can comprise a 22 mm, F/1.8, high resolution, ⅔″ format, machine vision lens from THORLABS. Characteristics of this lens include a focal length of 25 mm, F-number F/1.8-16; image size 6.6×8.8 mm; diagonal field of view 24.9 degrees, working distance 0.1 m, mount C, front and rear aperture 18.4 mm, temperature range 10 to 50 centigrade, resolution 200 p/mm at center and 160p/mm at corner. Other lenses of similar characteristics can be substituted for this particular example lens.

The outer imaging unit 204 provides a slightly or significantly wider field of view for more peripheral imaging. Typically, up to approximately six first imaging units 204 are provided per global imaging array 102 and each includes a lens, image sensor (infrared and/or visible), and an image processor, which may be dedicated or part of a pool of available image processors (FIG. 5). The lens can comprise a 8.0 mm FL, high resolution, infinite conjugate micro video lens. Characteristics of this lens include a field of view on ½″ sensor of 46 degrees; working distance of 400 mm to infinity; maximum resolution full field 20 percent at 160 lp/mm; distortion-diagonal at full view −10 percent; aperture f/2.5; and maximum MTF listed at 160 lp/mm. Other lenses of similar characteristics can be substituted for this particular example lens.

The global imaging array 102 is configured, therefore, to provide horizon-to-horizon type tiled imaging in the visible and/or infrared or near-infrared ranges, such as for overall Earth scene context and high degrees of central acuity. Characteristics of the field of view of the imaging array 102 can include super wide horizon-to-horizon field of view; approximately 98 degree H×84 degree V central field of view; spatial resolution of approximately 1-100 meters from 400-700 km; and low volume/low mass platform (e.g., less than approximately 200×200×100 mm in volume and around 1 kg in mass). Changes in lens selection, imaging unit quantities, mounting structure, and the like can change this set of example characteristics.

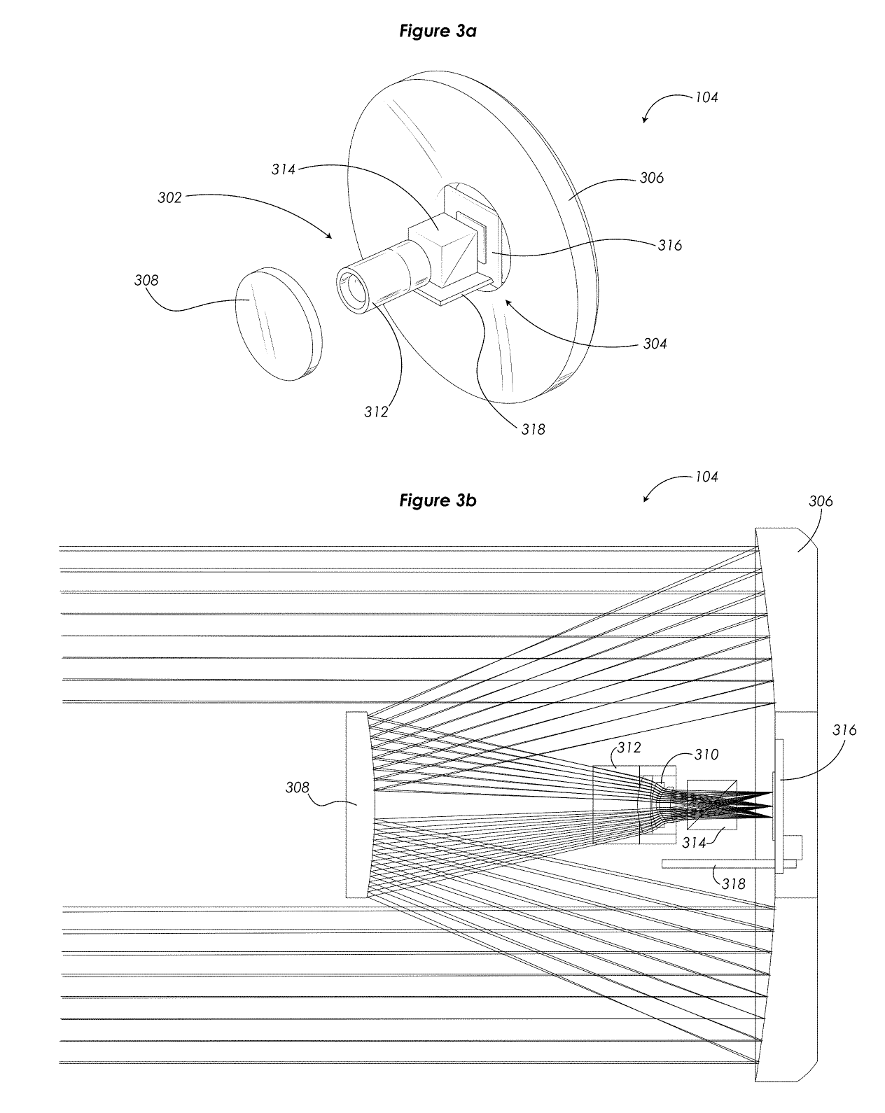

FIGS. 3A and 3B are perspective and cross-sectional views of a spot imager component of a satellite imaging system with edge processing, in accordance with an embodiment. In one embodiment, the satellite imaging system 100 further includes at least one third imaging unit 104 that includes a third optical arrangement 302, a third image sensor 304, and a third image processor (FIG. 5) that is configured to capture and process imagery of a movable field of view (FIG. 4) that is smaller than the first field of view.

In certain embodiments, the steerable spot imager 104 provides a movable spot field of view with ultra high resolution imagery. A catadioptric design can include a aspheric primary reflector 306 of greater than approximately 130 mm diameter, a spherical secondary reflector 308; three meniscus singlets as refractive elements 310 positioned within a lens barrel 312; a beamsplitter cube 314 to split visible and infrared channels; a visible image sensor 316; and an infrared image sensor 318. The primary reflector 306 and the secondary reflector 308 can include mirrors of Zerodur or CCZ; a coating of aluminum having approximately 10 A RMS surface roughness; a mirror substrate thickness to diameter ratio of approximately 1:8. The dimensions of the steerable spot imager 104 include an approximately 114 mm tall optic that is approximately 134 mm in diameter across the primary reflector 306 and approximately 45 mm in diameter across the secondary reflector 308. Characteristics of the steerable spot imager 104 include temperature stability; low mass (e.g., approximately 1 kg of mass); little to no moving parts; and positioning of image sensors within the optics.

Baffling in and around the steerable spot imager 104 (e.g., a housing) can be provided to reduce stray light, such as light that misses the primary reflector 306 and strikes the secondary reflector 308 or the refractive elements 310. Further, the primary reflector 306 and the secondary reflector 308 are configured and arranged to reduce scatter contributions that can potentially reduce image contrast. The lens barrel 312 can further act as a shield to reduce stray light.

In operation, light is reflected and focused by the primary reflector 306 onto the secondary reflector 308. The secondary reflector 308 reflects and focuses the light into the lens barrel 312 and through the refractive elements 310. The refractive elements 310 focus light through the beam splitter 314, where visible light passes to the visible sensor 316 and infrared light is split to the infrared sensor 318.

The steerable spot imager 104 can be mounted to the plate 108 of the satellite imaging system 100 using a gimbal 110 (FIG. 1), such as that available from TETHERS UNLIMITED (e.g., COBRA-C or COBRA-C+). The gimbal 110 can be a three degree of freedom gimbal that provides a substantially full hemispherical workspace; precision pointing; precision motion control; open/closed loop operation; 1G operation tolerance; continuous motion; and high slew rates (e.g., greater than approximately 30 degrees per second) with no cable wraps or slip rings. An extension can be used to provide additional degrees of freedom. The gimbal 110 characteristics can include approximately 487 g mass; approximately 118 mm diameter; approximately 40 mm stack height; approximately 85.45 mm deployed height; resolution of approximately less than 3 arcsec; accuracy of approximately <237 arcsec; and max power consumption of approximately 3.3 W. The gimbal 110 can be arranged with and pivot close to or at the center of gravity of the steerable spot imager 104 to reduce negative effects of slewing. Additionally, movement of one steerable spot imager 104 can be offset by movement of another steerable spot imager 104 to minimize effects of slewing and cancel out movement.

The satellite imaging system 100 can include approximately nine to twelve steerable spot imagers 104 that are independently configured to focus, dwell, and/or scan for select targets. Each spot imager 104 can pivot approximately +/− seventy degrees and can include proximity sensing to avoid lens crashing. The steerable spot imagers 104 can provide an approximately 20 km diagonal field of view of approximately 4:3 aspect ratio. Resolution can be approximately one to three meters (nadir) in the visible and infrared or near-infrared range obtained using image sensors 316 and 318 of approximately 8 million pixels per square degree. Resolution can be increased to super-resolution when the spot imagers 104 dwell on a particular target to collect multiple image frames, which multiple image frames are combined to increase the resolution of a still image.

Many other steerable spot imager 104 configurations are possible, including a number of all-refractive type lens arrangements. For instance, one possible spot imager 104 achieving less than approximately a 3 m resolution at 500 km orbit includes an approximately 209.2 mm focal length, approximately 97 mm opening lens height; approximately 242 mm lens track; less than approximately F/2.16; spherical and aspherical lenses of approximately 1.3 kg; and a beam splitter for a 450 nm-650 nm visible channel and an 800 nm to 900 nm infrared channel.

Another steerable spot imager 104 configuration includes a 165 mm focal length; F/1.7; 2.64 degree diagonal object space; 7.61 mm diagonal image; 450-650 nm waveband; fixed focus; limited diffraction anomalous-dispersion glasses; 1.12 um pixel pitch; and a sensor with 5408×4112 pixels. Potential optical designs include a 9-element all-spherical design with a 230 mm track and a 100 mm lens opening height; a 9-element all-spherical design with 1 triplet and a 201 mm track with a 100 mm lens opening height; and an 8-element design with 1 asphere and a 201 mm track with a 100 mm lens opening height. Other steerable spot imager 104 configurations can include any of the following lens or lens equivalents having focal lengths of approximately 135 mm to 200 mm: OLYMPUS ZUIKO; SONY SONNAR T*; CANON EF; ZEISS SONNAR T*; ZEISS MILVUS; NIKON DC-NIKKOR; NIKON AF-S NIKKOR; SIGMA HSM DG ART LENS; ROKINON 135M-N; ROKINON 135M-P, or the like.

FIG. 4 is a field of view diagram of a satellite imaging system with edge processing, in accordance with an embodiment. In one embodiment, the satellite imaging system 100 is configured to capture imagery of a field of view 400. Field of view 400 comprises a fisheye field of view 402; outer cone 404; inner cone 406; and one or more spot cones 408. The fisheye field of view 402 is captured using the fisheye imaging unit 210. The outer cone 404 is captured using the outer imaging units 204 (e.g., 6×8 mm focal length EDMUNDS OPTICS 69255). The inner cone 406 is captured using the inner imaging units 202 (e.g., 9×25 mm focal length THORLABS MVL25TM23). The spot cones 408 (three depicted as circles) are captured using the steerable spot imagers 104 (e.g., catadioptric design FIG. 3). The field of view 400 can include visible and/or infrared or near-infrared imagery in whole or in part.

The inner cone 406 comprises nine sub fields of view, which can at least partially overlap as depicted. The inner cone 406 can span approximately 40 degrees (e.g., 9×10.5 degree×13.8 degree subfields) and be associated with imagery of approximately 40 m resolution (nadir). The outer cone 404 comprises six sub fields of view, which can at least partially overlap as depicted and can form a perimeter around the inner cone 406. The outer cone 404 can span approximately 90 degrees (6×42.2 degree×32.1 degree subfields) and be associated with imagery of approximately 95 m resolution (nadir). The fisheye field of view can comprise a single field of view and span approximately 180 degrees. The spot cones 408 comprises approximately 10-12 cones, which are independently movable across any portion of the fisheye field of view 402, the outer cone 404, or the inner cone 406. The spot cones 408 provide a narrow field of view of limited degree that is approximately 20 km in diameter across the Earth surface from approximately 400-700 km altitude. The inner cone 406 and the outer cone 404 and the subfields of view within each form tiles of a central portion of the overall field of view 400. Note that overlap in the adjacent fields and subfields of view associated with the outer cone 404 and the inner cone 406 may not be uniform across the entire field depending upon lens arrangement and configuration and any distortion.

The field of view 400 therefore includes the inner core 406, outer core 404, and fisheye field of view 402 to provide overall context with low to high resolution imagery from the periphery to the center. Each of the subfields of the inner core 406, the subfields of the outer core 404, and the fisheye field of view are associated with separate imaging units and separate image processors, to enable capture of low to high resolution imagery and parallel image processing. Overlap of the subfields of the inner core 406, the subfields of the outer core 404, and the fisheye field of view enable stitching of adjacent imagery obtained by different image processors. Likewise, the spot cones 408 are each associated with separate imaging units and separate image processors to enable capture of super-high resolution imagery and parallel image processing.

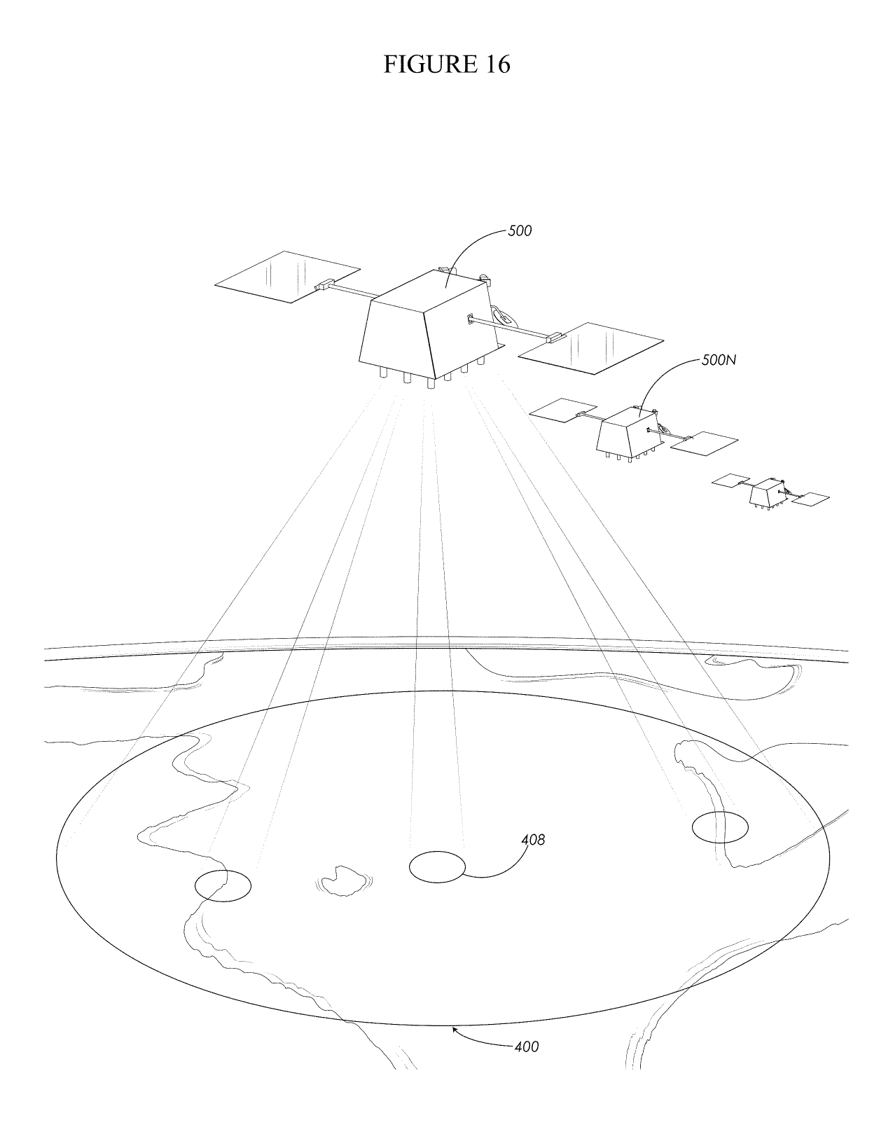

The field of view 400 captures imagery associated with an Earth scene below the satellite imaging system 100 (e.g., nadir). Because the satellite imaging system 100 orbits and moves relative to Earth, the content of the field of view 400 changes over time. In a constellation of satellite imaging systems 100 (FIG. 16), an array of fields of view 400 capture video or static imagery simultaneously to provide substantially complete coverage of Earth from space.

The field of view 400 is provided as an example and many changes are possible. For example, the sizes of the fisheye field of view 402, the outer core 404, the inner core 406, or the spot cones 408 can be increased or decreased or omitted as desired for a particular application. Additional cores, such as a mid-core between the inner core 406 and the outer core 404, or a core outer to the outer core 404 can be included. Likewise, the subfields of the outer core 404 or the inner core 406 can be increased or decreased in size or quantity. For example, the inner core 406 can comprise a single subfield and the outer core 404 can comprise a single subfield. Alternatively, the inner core 406 can comprise tens or hundreds of subfields and the outer core 404 can comprise tens or hundreds of subfields. The fisheye field of view 402 can include two, three, four, or more redundant or at least partially overlapping subfields of view. The spot cones 408 can be one to dozens or hundreds in quantity and can range in size from approximately 1 km diagonal to tens or hundreds of km diagonal. Furthermore, any given satellite imaging system 100 can include more than one field of view 400, such as a front field of view 400 and a back field of view 400 (e.g., one pointed at Earth and another directed to outer space). Alternatively, an additional field of view 400 can be directed ahead, behind, or to a side of an orbital path of a satellite. The fields of view 400 in this context can be different or identical.

FIG. 5 is a component diagram of a satellite imaging system with edge processing, in accordance with an embodiment. In one embodiment, a satellite 500 with image edge processing, includes, but is not limited to, an imaging system 100 including at least an array of first imaging unit types 202 and 202N arranged in a grid and each configured to capture and process imagery of a respective first field of view; an array of second imaging unit types 204 and 204N each configured to capture and process imagery of a respective second field of view that is proximate to and larger than the first field of view; an array of independently movable third imaging unit types 104 and 104N each configured to capture and process imagery of a third field of view that is smaller than the first field of view and that is directable at least within the first field of view and the second field of view; and at least one fourth imaging unit type 210/210N configured to capture and process imagery of a fourth field of view that at least includes the first field of view and the second field of view; an array of image processors 504 and 504N linked to respective ones of the array of first imaging unit types 202 and 202N, the array of second imaging unit types 204 and 204N, the array of independently movable third imaging unit types 104 and 104N, and the at least one fourth imaging unit type 210/210N; a hub processing unit 502 linked to each of array of image processors 504 and 504N; and a wireless communication interface 506 linked to the hub processor 502.

The optical arrangement 510 of the array of first imaging unit types 202 and 202N can include any of those discussed herein or equivalents thereof. For example, an optical arrangement 510 can comprise a 22 mm, F/1.8, high resolution ⅔″ format machine vision lens from THORLABS. Characteristics of this optical arrangement include a focal length of 25 mm; F-number F/1.8-16; image size 6.6×8.8 mm; diagonal field of view 24.9 degrees; working distance 0.1 m; mount C; front and rear effective aperture 18.4 mm; temperature range 10 to 50 centigrade, resolution 200 p/mm at center and 160 p/mm at corner. Other optical arrangements of similar characteristics can be substituted for this particular example.

The optical arrangement 512 of the array of second imaging unit types 204 and 204N can include any of those discussed herein or equivalents thereof. For example, an optical arrangement 512 can comprise a 8.0 mm focal length, high resolution, infinite conjugate micro video lens. Characteristics of this optical arrangement include a field of view on ½″ sensor of 46 degrees; working distance 400 mm to infinity; maximum resolution full field 20 percent at 160 lp/mm; distortion-diagonal at full view −10 percent; aperture f/2.5; and maximum MTF listed at 160 lp/mm. Other optical arrangements of similar characteristics can be substituted for this particular example.

The optical arrangement 514 of the an array of independently movable third imaging unit types 104 and 104N can include any of those discussed herein or equivalents thereof. For example, a catadioptric design 514 can include a aspheric primary reflector 306 of greater than approximately 130 mm diameter, a spherical secondary reflector 308; three meniscus singlets as refractive elements 310 positioned within a lens barrel 312; and a beamsplitter cube 314 to split visible and infrared channels. The primary reflector 306 and the secondary reflector 308 can include mirrors of Zerodur or CCZ; a coating of aluminum having approximately 10 A RMS surface roughness; a mirror substrate thickness to diameter ratio of approximately 1:8. The dimensions can include an approximately 114 mm tall optic that is approximately 134 mm in diameter across the primary reflector 306 and approximately 45 mm in diameter across the secondary reflector 308. Further characteristics can include temperature stability; low mass (e.g., approximately 1 kg of mass); few to no moving parts; and positioning of image sensors within the optics.

Many other optical arrangements are possible, including a number of all-refractive type lens arrangements. For instance, one optical arrangement achieving less than approximately a 3 m resolution at 500 km orbit includes an approximately 209.2 mm focal length; approximately 97 mm opening lens height; approximately 242 mm lens track; less than approximately F/2.16; spherical and aspherical optics of approximately 1.3 kg; and a beam splitter for a 450 nm-650 nm visible channel and an 800 nm to 900 nm infrared channel.

Another optical arrangement includes a 165 mm focal length; F/1.7; 2.64 degree diagonal object space; 7.61 mm diagonal image; 450-650 nm waveband; fixed focus; limited diffraction; and anomalous-dispersion lenses. Potential designs include a 9-element all-spherical design with a 230 mm track and a 100 mm lens opening height; a 9-element all-spherical design with 1 triplet and a 201 mm track with a 100 mm lens opening height; and an 8-element design with 1 asphere and a 201 mm track with a 100 mm lens opening height. Other configurations can include any of the following optics or equivalents having focal lengths of approximately 135 mm to 200 mm: OLYMPUS ZUIKO; SONY SONNAR T*; CANON EF; ZEISS SONNAR T*; ZEISS MILVUS; NIKON DC-NIKKOR; NIKON AF-S NIKKOR; SIGMA HSM DG ART LENS; ROKINON 135M-N; ROKINON 135M-P, or the like.

The optical arrangement 516 of the at least one fourth imaging unit type 210/210N can include any of those discussed herein or equivalents thereof. For example, the optical arrangement 516 can comprise a ½ Format, C-Mount, Fisheye Lens with a 1.4 mm focal length from EDMUND OPTICS. This particular arrangement has the following characteristics: focal length 1.4; maximum sensor format ½″, field of view for ½″ sensor 185×185 degrees; working distance of 100 mm-infinity; aperture f/1.4-f/16; maximum diameter 56.5 mm; length 52.2 mm; weight 140 g; mount C; fixed focal length; and RoHS C. Other optics of similar characteristics can be substituted for this particular example.

The image sensor 508 and 508N of the array of first imaging unit types 202 and 202N, the array of second imaging unit types 204 and 204N, the array of independently movable third imaging unit types 104 and 104N, and the at least one fourth imaging unit type 210/210N can each comprise an IMX 230 21 MegaPixel image sensor or similar alternative. The IMX 230 includes characteristics of 1×2.4 inch panel; 5408 H×4112 V pixels; and 5 Watts of power usage. Alternative image sensors include those comprising approximately 9 megapixel capable of approximately 17 Gigabytes per second of image data and having at least approximately 10,000 pixels per square degree. Image sensors can include even higher MegaPixel sensors as available (e.g., 250 megapixel plus image sensors). The image sensors 508 and 508N can be the same or different for each of the array of first imaging unit types 202 and 202N, the array of second imaging unit types 204 and 204N, the array of independently movable third imaging unit types 104 and 104N, and the at least one fourth imaging unit type 210/210N.

The image processors 504 and 504N and/or the hub processor 502 can each comprise a LEOPARD/INTRINSYC ADAPTOR coupled with a SNAPDRAGON 820 SOM. Incorporated in the SNAPDRAGON 820 SOM are one or more additional technologies such as SPECTRA ISP; HEXAGON 680 DSP; ADRENO 530; KYRO CPU; and ADRENO VPU. SPECTRA ISP is a 14-bit dual-ISP that supports up to 25 megapixels at 30 frames per second with zero shutter lag. HEXAGON 680 DSP with HEXAGON VECTOR EXTENSIONS supports advanced instructions optimized for image and video processing; KYRO 280 CPU includes dual quad core CPUs optimized for power efficient processing. The vision platform hardware pipeline of the image processors 504 and 504N can include ISP to convert camera bit depth, exposure, and white balance; DSP for image pyramid generation, background subtraction, and object segmentation; GPU for optical flow, object tracking, neural net processing, super-resolution, and tiling; CPU for 3D reconstruction, model extraction, and custom applications; and VPT for compression and streaming. Software frameworks utilized by the image processors 504 can include any of OPENGL, OPEN CL, FASTCV, OPENCV, OPENVX, and/or TENSORFLOW. The image processors 504 and 504N can be tightly coupled and/or in close proximity to the respective image sensors 508N and/or the hub processor 502 for high speed data communication connections (e.g., conductive wiring or copper traces).

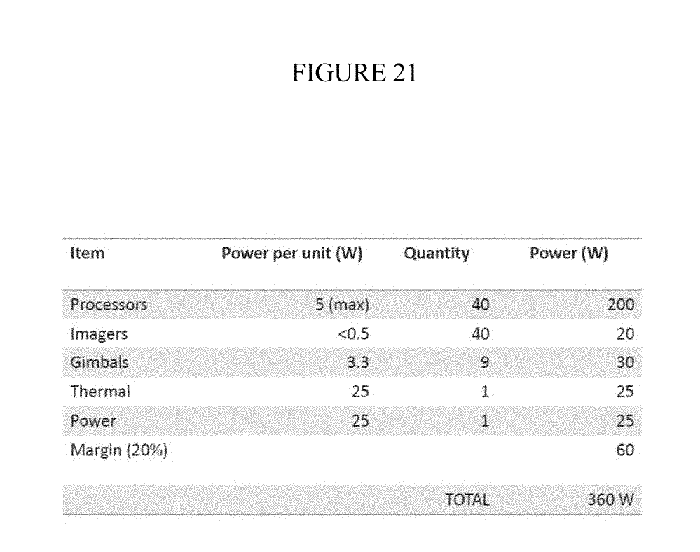

The image processors 504 and 504N can be dedicated to respective ones of the array of first imaging unit types 202 and 202N, the array of second imaging unit types 204 and 204N, the array of independently movable third imaging unit types 104 and 104N, and the at least one fourth imaging unit type 210/210N. Alternatively, the image processors 504 and 504N can be part of a processor bank that is fluidly assignable to any of the array of first imaging unit types 202 and 202N, the array of second imaging unit types 204 and 204N, the array of independently movable third imaging unit types 104 and 104N, and the at least one fourth imaging unit type 210/210N, on an as needed basis. For example, high levels of redundancy can be provided whereby any image sensor 508 and 508N of any of the array of first imaging unit types 202 and 202N, the array of second imaging unit types 204 and 204N, the array of independently movable third imaging unit types 104 and 104N, and the at least one fourth imaging unit type 210/210N, on an as needed basis, can communicate with any of the image processors 504 and 504N. For example, a supervisor CPU can monitor each of the image processors 504 and 504N and any of the links between those image processors 504 and 504N and any of the image sensors 508 and 508N of any of the array of first imaging unit types 202 and 202N, the array of second imaging unit types 204 and 204N, the array of independently movable third imaging unit types 104 and 104N, and the at least one fourth imaging unit type 210/210N. In an event a failure or exception is detected a crosspoint switch can reassign one of the functional image processors 504 and 504N (e.g., a backup or standby image processor) to continue image processing operations with respect to the particular image sensor 508 or 508N. A possible power budget of imaging system 100 of satellite 500 is provided in FIG. 21.

The hub processor 502 manage, triage, delegate, coordinate, and/or satisfy incoming or programmed image requests using appropriate ones of the image processors 504 and 504N. For instance, hub processor 502 can coordinate with any of the image processors 504 to perform initial image reduction, image selection, image processing, pixel identification, resolution reduction, cropping, object identification, pixel extraction, pixel decimation, or perform other actions with respect to imagery. These and other operations performed by the hub processor 502 and the image processors 504 and 504N enable local/on-board/edge/satellite-level processing of ultra-high resolution imagery in real-time, whereby the amount of image data captured outstrips the bandwidth capabilities of the wireless communication interface 506 (e.g., Gigabytes vs. Megabytes). For instance, full resolution imagery can be processed at the satellite to identify and send select portions of the raw image data at relatively high resolutions for a particular receiving device (e.g., APPLE IPHONE, PC, MACBOOK, or tablet). Alternatively, satellite-hosted applications can process raw high resolution imagery to identify objects and communicate text or binary data requiring only a few bytes per second. These types of operations and others, which are discussed herein, enable many simultaneous users and application processes at even a single satellite 500.

The wireless communication interface 506 can be coupled to the hub processor 502 via a high speed data communication connection (e.g., conductive wiring or copper trace). The wireless communication interface 506 can include a satellite radio communication link (e.g., Ka-band, Ku-band, or Q/V-band) with communication speeds of approximately one to two-hundred megabytes per second.

In any event, the combination of multiple imaging units and image processors enables parallel capture, recording, and processing of tens or even hundreds of video streams simultaneously with full access to ultra high resolution video and/or static imagery. The image processors 504 and 504N can collect and process up to approximately 400 gigabytes per second or more of image data per satellite 500 and as much as 30 terabytes per second of image data per constellation of satellites 500N (e.g. based on a capture rate of approximately 20 megapixels at 20 frames per second for each image sensor 508 and 508N). The image processors 504 and 504N can include approximately 20 teraflops or more of processing power per satellite 500 and as much as 2 petaflops of processing power per constellation of satellites 500N.

Many functions and/or operations can be performed by the image processors 504 and 504N and the hub processor 502 including, but not limited to, (1) real-time or near-real-time processing and transmission from space to ground only imagery wanted or needed or required to reduce bandwidth requirements and overcome the space-to-ground bandwidth bottleneck; (2) hosting local applications for analyzing and reporting on pre or non-transmitted high resolution imagery; (3) building a substantially full earth video database; (4) scaling video so that resolution remains substantially constant regardless of zoom level (e.g., by discarding pixels captured at a variable amount that is inversely proportionate to a zoom level); (5) extracting key information from a scene such as text to reduce bandwidth requirements to only a few bytes per second; (6) cropping and pixel decimation based on field of view (e.g., throwing away up to 99 percent of captured pixels); (7) obtaining parallel streams (e.g., 10-17 streams) and cutting up image data into a pyramid of resolutions before sectioning and compressing the data; (8) obtaining, stitching, and compressing imagery from different fields of view; (9) distributing image processing load to image processors having access to desired imagery without requiring all imagery to be obtained and processed by a hub processor; (10) obtaining a request, identifying which image processors correspond to a portion of the request, and transmitting sub request to the appropriate image processors; (11) obtain image data in pieces and stitch the image data to form a composite image; (12) coordinate requests between users and the array of image processors; (13) host applications or APIs for accessing and processing image data; (14) perform image resolution reduction or compression; (15) perform character or object recognition; (16) provide a client websocket to obtain a resolution and field of view request, obtain image data to satisfy the request, and return image data, timing data, and any metadata to the client (e.g., browser); (17) perform multiple levels of pixel reduction; (18) attach metadata to image data prior to transmission; (19) performing background subtraction; (20) perform resolution reduction or selection reduction to at least partially reduce pixel data; (21) coding; (22) perform feature recognition; (23) extract or determine text or binary data for transmission with or without image data; (24) perform physical or geographical area monitoring; (25) process high resolution raw image data prior to transmission; (26) enable APIs for custom configurations and applications; (27) enable live, deep-zoom video by multiple simultaneous clients; (28) enable independent focus, zoom, and steering by multiple simultaneous clients; (29) enable pan and zoom in real-time; (30) enable access to imagery via smartphone, tablet, computer, or wearable device; and/or (31) identify and track important objects or events.

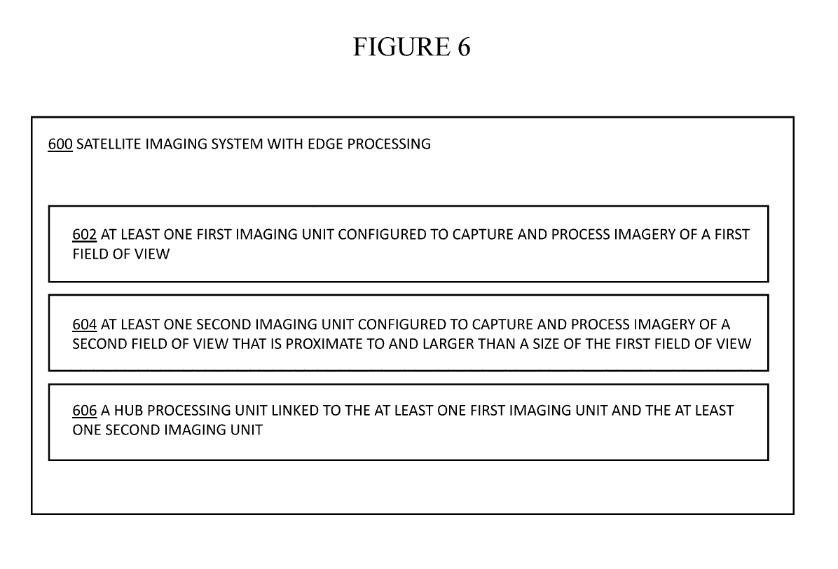

FIG. 6 is a component diagram of a satellite imaging system with edge processing, in accordance with an embodiment. In one embodiment, a satellite imaging system 600 with edge processing includes, but is not limited to, at least one first imaging unit configured to capture and process imagery of a first field of view at 602; at least one second imaging unit configured to capture and process imagery of a second field of view that is proximate to and larger than a size of the first field of view at 604; and a hub processing unit linked to the at least one first imaging unit and the at least one second imaging unit at 606.

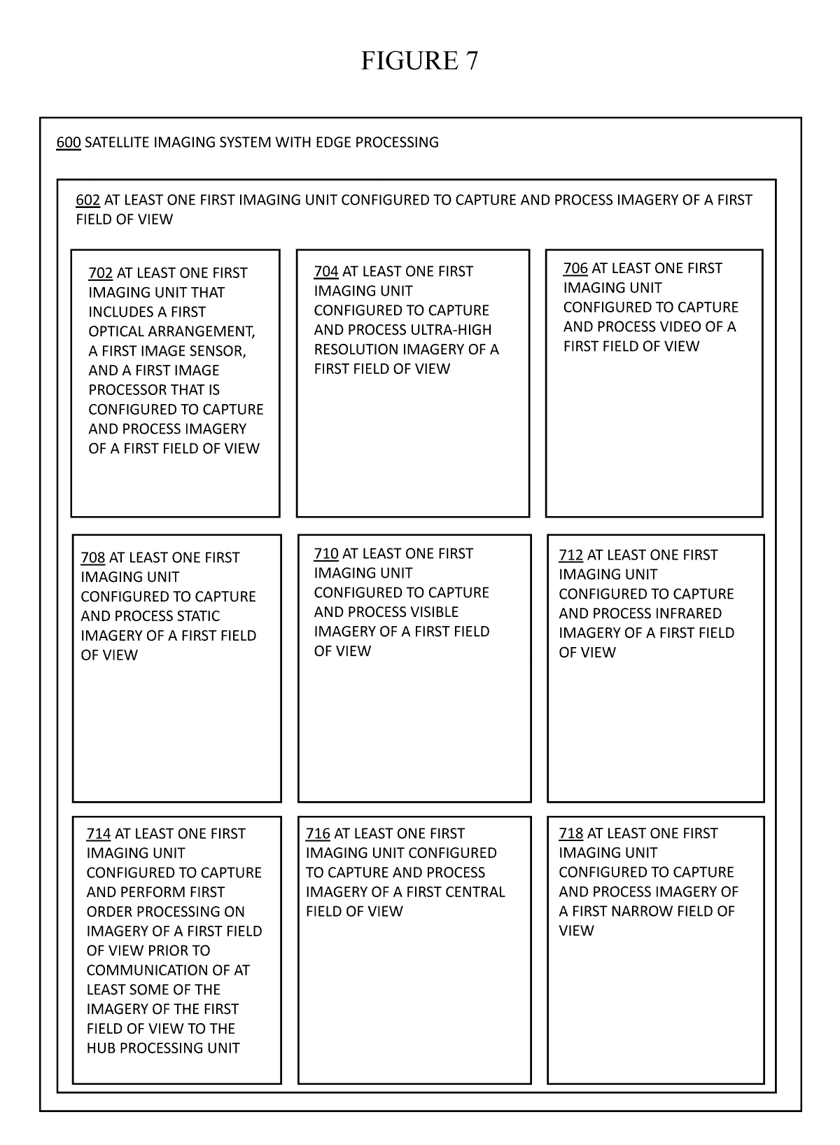

FIG. 7 is a component diagram of a satellite imaging system 600 with edge processing, in accordance with an embodiment.

In one embodiment, the at least one first imaging unit configured to capture and process imagery of a first field of view includes, but is not limited to, at least one first imaging unit that includes a first optical arrangement, a first image sensor, and a first image processor that is configured to capture and process imagery of a first field of view at 702. For example, the at least one first imaging unit 202 includes a first optical arrangement 510, a first image sensor 508, and a first image processor 504 that is configured to capture and process imagery of a first field 406. The first imaging unit 202 and its constituent components can be physically integrated and tightly coupled, such as within a same physical housing or within mm or centimeters of proximity. Alternatively, the first imaging unit 202 and its constituent components can be physical separated, within a particular satellite 500. In one particular example, the optical arrangement 510 and the image sensor 508 are integrated and the image processor 504 is located within a processor bank and coupled via a high-speed communication link to the image sensor 508 (e.g., USBx.x or equivalent). The image processor 504 can be dedicated to the image sensor 508 or alternatively, the image processor 504 can be assigned on an as-needed basis to one or more other image sensors 508 (e.g., to other of the first imaging units 202, second imaging units 204, third imaging units 104, or fourth imaging units 210). On one particular satellite 500, there can be anywhere from one to hundreds of the first imaging units 202, such as nine of the first imaging units 202.

In one embodiment, the at least one first imaging unit configured to capture and process imagery of a first field of view includes, but is not limited to, at least one first imaging unit configured to capture and process ultra-high resolution imagery of a first field of view at 704. For example, the at least one first imaging unit 202 is configured to capture and process ultra-high resolution imagery of a first field of view 406. Ultra-high resolution imagery can include imagery of one to hundreds of megapixels, such as for example twenty megapixels. The imagery can be captured as a single still image or as video at a rate of tens of frames per second (e.g., twenty frames per second). The combination of multiple imaging units 202/202N, 204/204N, 104/104N, and 210/210N and image processors 508/508N enables parallel capture, recording, and processing of tens or even hundreds of ultra-high resolution video streams of different fields of view simultaneously. The amount of image data collected can be approximately 400 gigabytes per second or more per satellite 500 and as much as approximately 30 terabytes or more per second per constellation of satellites 500N. The total amount of ultra-high resolution imagery is therefore more than a satellite to ground bandwidth capability, such as orders of magnitude more.

In certain embodiments, the ultra-high resolution imagery provides acuity of approximately 1-40 meters spatial resolution from approximately 400-700 km altitude, depending upon the particular optical arrangement. Thus, a ship, car, animals, people, structures, weather, natural disasters, and other surface or atmospheric objects, events, or activities can be discerned from the image data collected.

In one embodiment, the at least one first imaging unit configured to capture and process imagery of a first field of view includes, but is not limited to, at least one first imaging unit configured to capture and process video of a first field of view at 706. For example, the at least one first imaging unit 202 is configured to capture and process video of a first field of view 406. In one example, the video can be captured at approximately one or more megapixels at approximately tens of frames per second (e.g., around twenty megapixels at approximately twenty frames per second). The first imaging unit 202 is fixed relative to the satellite 500, in certain embodiments, and the satellite 500 is in orbit with respect to Earth. Therefore, the video of the field of view 406 has constantly changing coverage of Earth as the satellite 500 moves in its orbital path. Thus, the video image data can include subject matter or content of oceans, seas, lakes, streams, flat land, mountainous terrain, glaciers, cities, people, vehicles, aircraft, boats, weather systems, natural disasters, and the like. In some embodiments, the first imaging unit 202 is fixed and aligned substantially perpendicular to Earth (nadir). However, oblique alignments are possible and the first imaging unit 202 may be movable or steerable.

In one embodiment, the at least one first imaging unit configured to capture and process imagery of a first field of view includes, but is not limited to, at least one first imaging unit configured to capture and process static imagery of a first field of view at 708. For example, the at least one first imaging unit 202 is configured to capture and process static imagery of a first field of view 406. The static imagery can be captured at approximately one or more megapixel pixel resolution (e.g., approximately twenty megapixels). While the at least one first imaging unit 202 is fixed, in certain embodiments, the satellite 500 to which the at least one first imaging unit 202 is coupled is orbiting Earth. Accordingly, the field of view 406 of the at least one first imaging unit 202 covers changing portions of Earth throughout the orbital path of the satellite 500. Thus, the static imagery can be of people, animals, archaeological events, weather, cities and towns, roads, crops and agriculture, structures, military activities, aircraft, boats, water, or the like. In certain embodiments, the static imagery is captured in response to a particular event detected (e.g., a fisheye fourth imaging unit 210 detects a hurricane and triggers the first imaging unit 202 to capture an image of the hurricane with higher spatial resolution).

In one embodiment, the at least one first imaging unit configured to capture and process imagery of a first field of view includes, but is not limited to, at least one first imaging unit configured to capture and process visible imagery of a first field of view at 710. For example, the at least one first imaging unit 202 is configured to capture and process visible imagery of a first field of view 406. Visible imagery is that light reflected off of Earth, weather, or that emitted from objects or events on Earth, for example, that is within the visible spectrum of approximately 390 nm to 700 nm. Visible imagery of the first field of view 406 can include content such as video and/or static imagery obtained from the first imaging unit 202 as the satellite 500 progresses through its orbital path. Thus, the visible imagery can include a video of the outskirts of Bellevue, Wash. to Bremerton, Wash. via Mercer Island, Lake Washington, Seattle, and Puget Sound, following the path of the satellite 500. The terrain, traffic, cityscape, people, aircraft, boats, and weather can be captured at spatial resolutions of approximately one to forty meters.

In one embodiment, the at least one first imaging unit configured to capture and process imagery of a first field of view includes, but is not limited to, at least one first imaging unit configured to capture and process infrared imagery of a first field of view at 712. For example, the at least one first imaging unit 202 is configured to capture and process infrared imagery of a first field of view 406. Infrared imagery is light having a wavelength of approximately 700 nm to 1 mm. Near-infrared imagery is light having a wavelength of approximately 0.75-1.4 micrometers. The infrared imagery can be used for night vision, thermal imaging, hyperspectral imaging, object or device tracking, meteorology, climatology, astronomy, and other similar functions. For example, infrared imagery of the first imaging unit 202 can include scenes of the Earth experiencing nighttime (e.g., when the satellite 500 is on a side of the Earth opposite the Sun). Alternatively, infrared imagery of the first imaging unit 202 can include scenes of the Earth experiencing cloud coverage. In certain embodiments, the infrared imagery and visible imagery are captured simultaneously by the first imaging unit 202 using a beam splitter. As discussed with respect to visible imagery, the infrared imagery of the first field of view 406 covers changing portions of the Earth based on the orbital progression of the satellite 500 to which the first imaging unit 202 is included.

In one embodiment, the at least one first imaging unit configured to capture and process imagery of a first field of view includes, but is not limited to, at least one first imaging unit configured to capture and perform first order processing on imagery of a first field of view prior to communication of at least some of the imagery of the first field of view to the hub processing unit at 714. For example, the at least one first imaging unit 202 is configured to capture and perform first order processing on imagery of a first field of view 406 using the image processor 504 prior to communication of at least some of the imagery of the first field of view 406 to the hub processing unit 502. The first imaging unit 202 captures ultra high resolution imagery of a small subfield of the field of view 406 (FIG. 4). The ultra-high resolution imagery can be on the order of 20 megapixels per frame and 20 frames per second, or more. However, not all of the ultra-high resolution imagery of the subfield of field 406 may be needed or required. Accordingly, the image processor 504 of the first imaging unit 202 can perform first order reduction operations on the imagery prior to communication to the hub processor 502. Reduction operations can include those such as pixel decimation, cropping, static or background object removal, un-selected area removal, unchanged area removal, previously transmitted area removal, or the like. For example, in an instance where a low-zoom distant wide area view is requested involving imagery captured of subfield of view 406, pixel decimation can be performed by the image processor 504 to remove a portion of the pixels unneeded (e.g., due to a requesting device of an IPHONE having a limit to screen resolution of 1136×640 many of the captured pixels are not useful). The pixel decimation can be uniform (e.g., every other or every second or every specified pixel can be removed). Alternatively, the pixel decimation can be non-uniform (e.g., variable pixel decimation involving uninteresting and interesting objects such as background vs. foreground or moving vs. non-moving objects). Pixel decimation can be avoided or minimized in certain circumstances within portions of the subfields of the field of view 406 that overlap, to enable stitching of adjacent subfields by the hub processor 502. Object and area removal can be performed by the image processor 504, involving removal of pixels that are not requested or that correspond to pixel data previously transmitted and/or that is unchanged since a previous transmission. For example, a close-up image of a shipping vessel against an ocean background can involve the image processor 504 of the first imaging unit 202 removing pixel data associated with the ocean that was previously communicated in an earlier frame, is unchanged, and that does not contain the shipping vessel. In certain embodiments, the image processor 504 performs machine vision or artificial intelligence operations on the image data of the field of view 406. For instance, the image processor 504 can perform image, object, feature, or pattern recognition with respect to the image data of the field of view 406. Upon detecting a particular aspect, the image processor 504 can output binary data, text data, program executables, or a parameter. An example of this in operation includes the image processor 504 detecting a presence of an aircraft within the field of view 406 that is unrecognized against flight plan data or ADS-B transponder data. Output of the image processor 504 may include GPS coordinates and a flag, such as “unknown aircraft”, which can be used by law enforcement, aviation authorities, or national security personnel to monitor the aircraft without necessarily requiring image data.

In one embodiment, the at least one first imaging unit configured to capture and process imagery of a first field of view includes, but is not limited to, at least one first imaging unit configured to capture and process imagery of a first central field of view at 716. For example, the at least one first imaging unit 202 is configured to capture and process imagery of a first central field of view 406. The central field of view 406 can be comprised of a plurality of subfields, such as nine subfields that at least partially overlap as depicted in FIG. 4. The first central field of view 406 can be square, rectangular, triangular, oval, or other regular or irregular shape. Surrounding the first central field of view 406 can be one or more other fields of view that may at least partially overlap, such as outer field of view 404, fisheye field of view 402, or spot field of view 408. The first central field of view 406 can be adjustable, movable, or fixed. In one particular example, the at least one first imaging unit 202 is associated with a single subfield of the field of view 406, such as the lower left, middle bottom, upper right, etc., as depicted in FIG. 4.

In one embodiment, the at least one first imaging unit configured to capture and process imagery of a first field of view includes, but is not limited to, at least one first imaging unit configured to capture and process imagery of a first narrow field of view at 718. For example, the at least one first imaging unit 202 is configured to capture and process imagery of a first narrow field of view 406. Narrow is relative to an outer field of view 404 or fisheye field of view 402, which have larger or wider fields of view. The narrow field of view 406 may be composed of a plurality of subfields as depicted in FIG. 4. The narrow size of the field of view 406 permits high acuity and high spatial resolution imagery to be captured over a relatively small area.

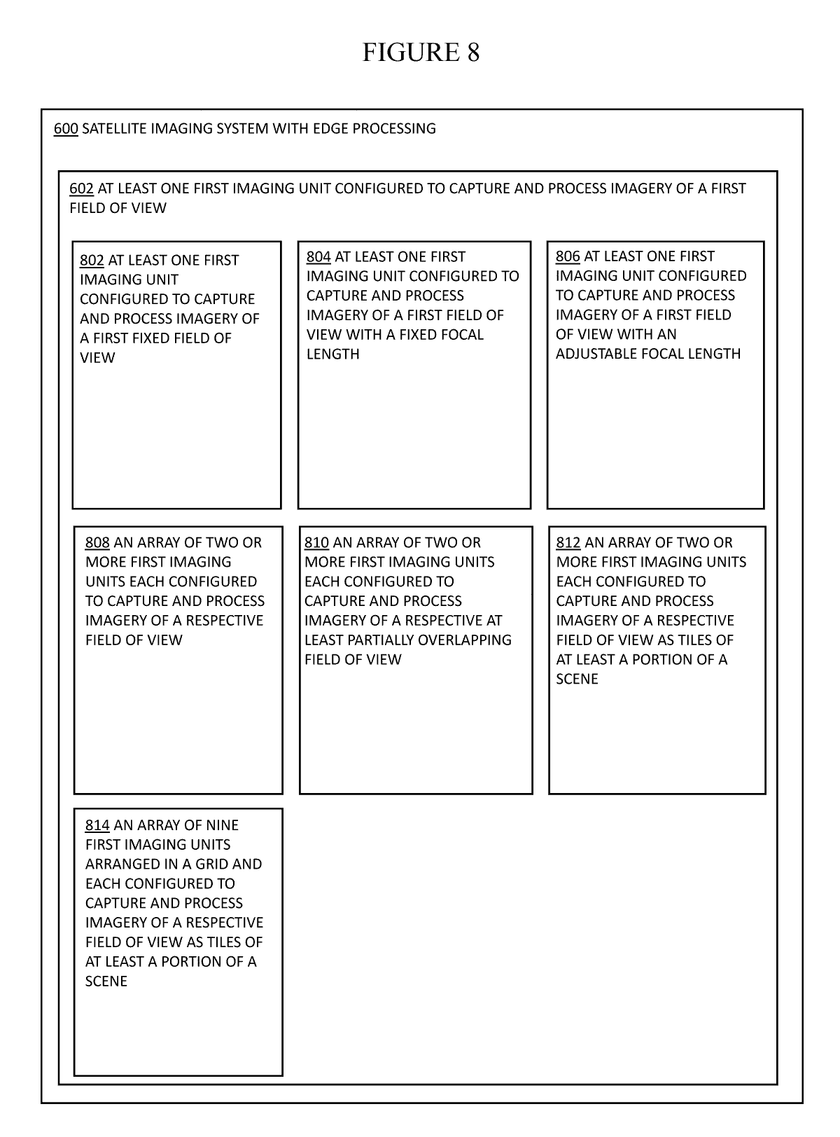

FIG. 8 is a component diagram of a satellite imaging system 600 with edge processing, in accordance with an embodiment.

In one embodiment, the at least one first imaging unit configured to capture and process imagery of a first field of view includes, but is not limited to, at least one first imaging unit configured to capture and process imagery of a first fixed field of view at 802. For example, the at least one first imaging unit 202 is configured to capture and process imagery of a first fixed field of view 406. The optical arrangement 510 can be fixedly mounted on the central mounting plate 206 as depicted in FIG. 2. In instances of nine subfields of the field of view 406, nine optical arrangements of the first imaging units 202 an 202N can be oriented as follows: bottom lens on opposing sides each oriented to capture opposing side top subfields of field of view 406; middle lens on opposing sides each oriented to capture opposing middle side subfields of field of view 406; top lens on opposing sides each oriented to capture opposing bottom side subfields of field of view 406, middle bottom lens oriented to capture top middle subfield of field of view 406; middle center lens oriented to capture middle center subfield of field of view 406, and middle top lens oriented to capture bottom middle subfield of field of view 406. In each of these cases, the respective side lens to subfield is cross-aligned such that left lenses are associated with right subfields and vice versa. The respective bottom lens to subfield is also cross-aligned such that bottom lenses are associated with top subfields and vice versa. Other embodiments of the optical arrangements 510 of the imaging units 202 and 202N are possible, including positioning of the lenses radially, in a cone, convexly, concavely, facing oppositely, or cubically, for example. Additionally, the second imaging unit 202 and 202N can be repositionable or movable to change a position of a corresponding subfield of the field of view 206. While the field of view 406 may be fixed, zoom and pan operations can be performed digitally by the image processor 504. For instance, the optical arrangement 510 can have a fixed field of view 406 to capture image data that is X mm wide and Y mm in height using the image sensor 508. The image processor 504 can manipulate the retained pixel data to digitally recreate zoom and pan effects within the X by Y envelope. Additionally, the optical arrangement 510 can be configured for adjustable focal length and/or configured to physically pivot, slide, or rotate for panning. Moreover, movement can be accomplished within the optical arrangement 510 or by movement of the plate 108.

In one embodiment, the at least one first imaging unit configured to capture and process imagery of a first field of view includes, but is not limited to, at least one first imaging unit configured to capture and process imagery of a first field of view with a fixed focal length at 804. For example, the at least one first imaging unit 202 is configured to capture and process imagery of a first field of view 406 with a fixed focal length. The optical arrangement 510 can comprise a 22 mm F/1.8 high resolution ⅔″ format machine vision lens from THORLABS. Characteristics of this lens include a focal length of 25 mm, F-number F/1.8-16; image size 6.6×8.8 mm; diagonal field of view 24.9 degrees, working distance 0.1 m, mount C, front and rear effective aperture 18.4 mm, temperature range 10 to 50 centigrade, resolution 200p/mm at center and 160p/mm at corner. Other lenses of similar characteristics can be substituted for this particular example lens.

In one embodiment, the at least one first imaging unit configured to capture and process imagery of a first field of view includes, but is not limited to, at least one first imaging unit configured to capture and process imagery of a first field of view with an adjustable focal length at 806. For example, the at least one first imaging unit 202 is configured to capture and process imagery of a first field of view 406 with an adjustable focal length. The adjustable focal length can be enabled, for example, by mechanical threads that adjust a distance of one or more of the lenses of the optical arrangement 510 relative to the image sensor 508. In instances of mechanically adjustable focal lengths, the image processor 504 can further digitally recreate additional zoom and/or pan operations within the envelope of image data captured by the image sensor 508.

In one embodiment, the at least one first imaging unit configured to capture and process imagery of a first field of view includes, but is not limited to, an array of two or more first imaging units each configured to capture and process imagery of a respective field of view at 808. For example, the array of two or more first imaging units 202 and 202N are each configured to capture and process imagery of a respective subfield of the field of view 406. Optical arrangement 510 of the first imaging unit 202 can be posited adjacent, opposing, opposite, diagonally, or otherwise in proximity to an optical arrangement of another of the first imaging units 202N. Each of the optical arrangements of the first imaging units 202 and 202N are associated with a different subfield of the field of view 406 (e.g., the top left and top center subfields of the field of view 406). The size of the fields of view can be modified or varied and can range; however, in one particular example each subfield is approximately 10×14 degrees for a total of approximately 10 degrees by 24 degrees in combination for two side by side subfields. More than two subfields of the field of view 406 are possible, such as tens or hundreds of subfields. FIG. 4 depicts a particular example embodiment where nine subfields are arranged in a grid of 3×3 to constitute the field of view 406. Each of the subfields are approximately 10.5×13.8 degrees for a total field of view 406 of approximately 30×45 degrees. Thus, the image sensor 508 of the first imaging unit 202 captures image data of a first subfield of field of view 406 and the image sensor of the first imaging unit 202N captures image data of a second subfield of field of view 406. Additional first imaging units 202N can capture additional image data for additional subfields of field of view 406. The image processors 504 and 504N associated with the respective image sensors therefore have access to different image content for processing, which image content corresponds to the subfields of the field of view 406.

In one embodiment, the at least one first imaging unit configured to capture and process imagery of a first field of view includes, but is not limited to, an array of two or more first imaging units each configured to capture and process imagery of a respective at least partially overlapping field of view at 810. In one embodiment, the array of two or more first imaging units 202 and 202N each are configured to capture and process imagery of a respective at least partially overlapping subfield of the field of view 406. The optical arrangement 510 of the first imaging unit 202 and the optical arrangement of the first imaging unit 202N can be physically aligned such that their respective subfields of the field of view 406 are at least partially overlapping. The overlap of the subfields of the field of view 406 can be on a left, right, bottom, top, or corner. Depicted in FIG. 4 are nine subfields of the field of view 406 with adjacent ones of the subfields overlapping by a relatively small amount (e.g., around one to twenty percent or around five percent). The overlap of subfields of the field of view 406 permit image processors 504 and 504N, associated with adjacent subfields of the field of view 406, to have access to at least some of the same imagery to enable the hub processor 502 to stitch together image content. For example, the image processor 504 can obtain image content from the top left subfield of the field of view 406, which includes part of an object of interest such as a road ferrying military machinery. Image processor 504N can likewise obtain image content from a top center subfield of the field of view 406, including an extension of the road ferrying military machinery. Image processor 504 and 504N each have different image content of the road with some percentage of overlap. Following any reduction or first order processing performed by the respective image processors 504 and 504N, the residual image content can be communicated to the hub processor 502. The hub processor 502 can stitch the image content from the image processors 504 and 504N to create a composite image of the road ferrying military machinery, using the overlapping portions for alignment.

In one embodiment, the at least one first imaging unit configured to capture and process imagery of a first field of view includes, but is not limited to, an array of two or more first imaging units each configured to capture and process imagery of a respective field of view as tiles of at least a portion of a scene 812. For example, an array of two or more first imaging units 202 and 202N are each configured to capture and process imagery of a respective subfield of the field of view 406 as tiles of at least a portion of a scene 400. Tiling of the scene 400 combined with parallel processing by an array of image processors 504 and 504N enables higher speed image processing with access to more raw image data. With respect to image data, the raw image data is substantially increased for the overall scene 400 by partitioning the scene 400 into tiles, such as subfields of the field of view 406. Each of the tiles is associated with an optical arrangement 510 and an image sensor 508 that captures megapixels of image data per frame with multiples of frames per second. A single image sensor may capture approximately 20 megapixels of image data at a rate of approximately 20 frames per second. This amount of image data is multiplied for each additional tile to generate significant amounts of image data, such as approximately 400 gigabytes per second per satellite 500 and as much as 30 terabytes per second or more of image data per constellation of satellites 500N. Thus, the combination of multiple tiles and multiple image sensors results in significantly more image data than would be possible with a single lens and sensor arrangement covering the scene 400 in its entirety. Processing of the significant raw image data is enabled by parallel image processors 504 and 504N, which each perform operations for a specified tile (or group of tiles) of the plurality of tiles. The image processing operations can be performed by the image processors 504 and 504N simultaneously with respect to different tiled portions of the scene 400.

In one embodiment, the at least one first imaging unit configured to capture and process imagery of a first field of view includes, but is not limited to, an array of nine first imaging units arranged in a grid and each configured to capture and process imagery of a respective field of view as tiles of at least a portion of a scene at 814. For example, satellite 500, includes an array of nine first imaging units 202 and 202N arranged in a three-by-three grid that are each configured to capture and process imagery of a respective subfield of the field of view 406 as tiles of at least a portion of a scene 400.

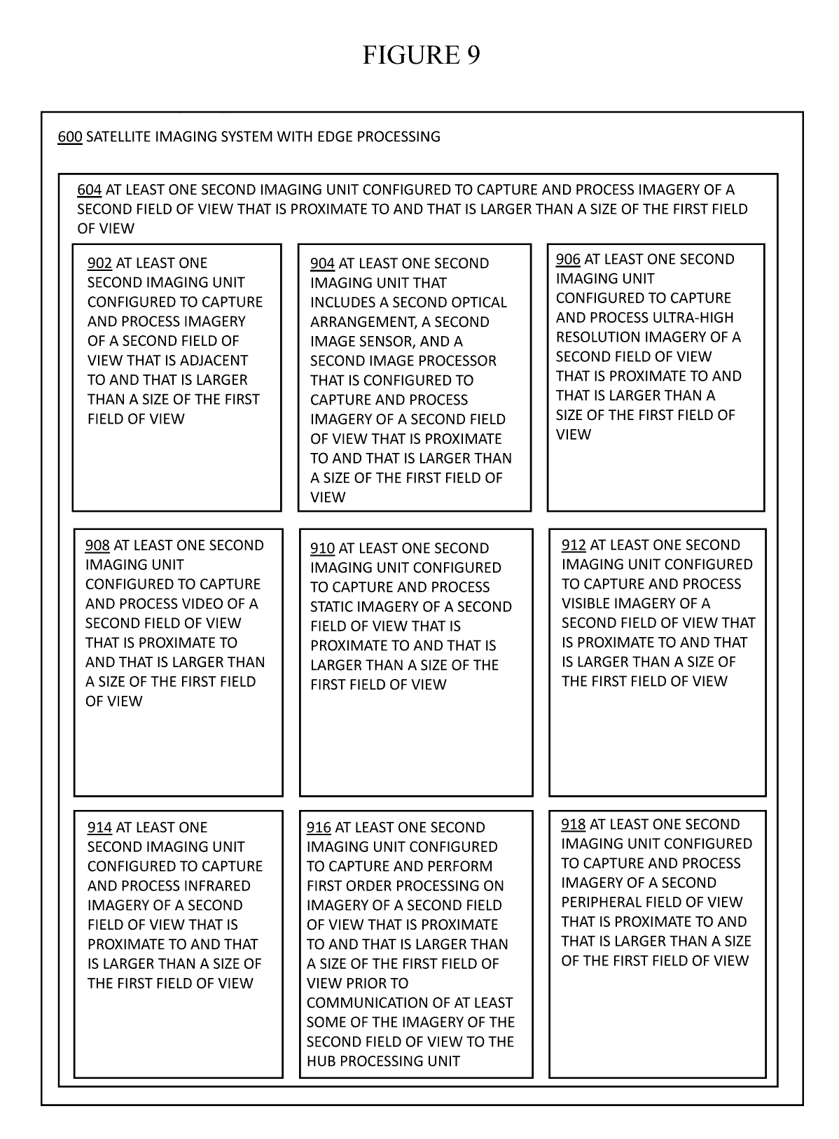

FIG. 9 is a component diagram of a satellite imaging system 600 with edge processing, in accordance with an embodiment.

In one embodiment, the at least one second imaging unit configured to capture and process imagery of a second field of view that is proximate to and that is larger than a size of the first field of view includes, but is not limited to, at least one second imaging unit configured to capture and process imagery of a second field of view that is adjacent to and that is larger than a size of the first field of view at 902. For example, the at least one second imaging unit 204 is configured to capture and process imagery of a second field of view 404 that is adjacent to and that is larger than a size of the first field of view 406. The second imaging unit 204 includes the optical arrangement 512 that is directed at the field of view 404, which is larger and adjacent to the field of view 406. For example, the field of view 404 maybe approximately five to seventy-five degrees, twenty to fifty degrees, or thirty to forty-five degrees. In one particular embodiment, the field of view 404 is approximately 42.2 by 32.1 degrees. The field of view 404 may be adjacent to the field of view 406 in a sense of being next to, above, below, opposing, opposite, or diagonal to the field of view 406.

In one embodiment, the at least one second imaging unit configured to capture and process imagery of a second field of view that is proximate to and that is larger than a size of the first field of view includes, but is not limited to, at least one second imaging unit that includes a second optical arrangement, a second image sensor, and a second image processor that is configured to capture and process imagery of a second field of view that is proximate to and that is larger than a size of the first field of view at 904. For example, the at least one second imaging unit 204 includes the optical arrangement 512, an image sensor 508N, and an image processor 504N that is configured to capture and process imagery of a second field of view 404 that is proximate to and that is larger than a size of the first field of view 406. In certain embodiments, a plurality of second imaging units 204 and 204N are included, each having the optical arrangement 512 and an image sensor 508N. Each of the plurality of second imaging units 204 and 204N have image processors 504N dedicated at least temporarily to processing image data of respective image sensors 508N of the plurality of second imaging units 204 and 204N. The optical arrangements 512 of each of the plurality of second imaging units 204 and 204N are directed toward subfields of the field of view 404, which subfields are arranged at least partially around the periphery of the field of view 406, in one embodiment. Thus, the image sensors 508N of the second imaging units 204 and 204N capture image data of each of the subfields of the field of view 404 for processing by the respective image processors 504N.

As a particular example, the field of view 404 provides lower spatial resolution imagery of portions of Earth ahead of, below, above, and behind that of the field of view 406 in relation to the orbital path of the satellite 500. Imagery associated with field of view 404 can be output to satisfy requests for image data or can be used for machine vision such as to identify or recognize areas, objects, activities, events, or features of potential interest. In certain embodiments, one or more areas, objects, features, events, activities, or the like within the field of view 404 can be used to trigger one or more computer processes, such as to configure image processor 504 associated with the first imaging unit 202 to begin monitoring for a particular area, object, feature, event, or activity. For instance, image data indicative of smoke within field of view 404 can configure processor 504 associated with the first imaging unit and field of view 406 to begin monitoring for fire or volcanic activity, even prior to such activity being within the field of view 406.

In one embodiment, the at least one second imaging unit configured to capture and process imagery of a second field of view that is proximate to and that is larger than a size of the first field of view includes, but is not limited to, at least one second imaging unit configured to capture and process ultra-high resolution imagery of a second field of view that is proximate to and that is larger than a size of the first field of view at 906. For example, the at least one second imaging unit 204 is configured to capture and process ultra-high resolution imagery of a second field of view 404 that is proximate to and that is larger than a size of the first field of view 406. While the second field of view 404 is relatively larger than the first field of view 406, the optical arrangement 512 and the image sensor 508N of the second imaging unit 204 can capture significant amounts of high resolution image data. For instance, the optical arrangement 512 may yield an approximately 42.2 by 32.1 degree subfield of the field of view 404 and the image sensor 508N can be approximately a twenty megapixel sensor. At approximately twenty frames per second, the second imaging unit 204 can capture ultra-high resolution imagery over a greater area, providing a spatial resolution of approximately one to forty meters from altitudes ranging from 400 to 700 km above Earth.

In one embodiment, the at least one second imaging unit configured to capture and process imagery of a second field of view that is proximate to and that is larger than a size of the first field of view includes, but is not limited to, at least one second imaging unit configured to capture and process video of a second field of view that is proximate to and that is larger than a size of the first field of view at 908. For example, the at least one second imaging unit 204 is configured to capture and process video of a second field of view 404 that is proximate to and that is larger than a size of the first field of view 406. Video of the second field of view 404 can be captured at range of frames per second, such as a few to tens of frames per second. Twenty-frames per second provides substantially smooth animation to the human visual system and is one possible setting. The portions of Earth covered by the field of view 404 changes due to the orbital path of the satellite 500 to which the second imaging unit 204 is included. Thus, raw video content of the field of view 404 may transition from Washington to Oregon to Idaho to Wyoming due to the orbital path of the satellite 500. Likewise, objects or features present within video content associated with field of view 404 can transition and become present within video content associated with field of view 406 or vice versa, depending upon the arrangement of the field of view 404 relative to the field of view 406 and/or the orbital path of the satellite 500. In embodiments with multiple subfields of the field of view 404 circumscribing the field of view 406, an object may transition into one subfield on one side of the field of view 404 and then into the field of view 406 and then back into another subfield of the field of view 404 on an opposing side. In certain embodiments, image content within one subfield of the field of view 404 can trigger actions, such as movement of a steerable spot imaging unit 104 to track the content through different subfields.

In one embodiment, the at least one second imaging unit configured to capture and process imagery of a second field of view that is proximate to and that is larger than a size of the first field of view includes, but is not limited to, at least one second imaging unit configured to capture and process static imagery of a second field of view that is proximate to and that is larger than a size of the first field of view at 910. For example, the at least one second imaging unit 204 is configured to capture and process static imagery of a second field of view 404 that is proximate to and that is larger than a size of the first field 406. The second imaging unit 204 can be dedicated to collection of static imagery, can be configured to extract static imagery from video content, or can be configured to capture static imagery in addition to video at alternating or staggered time periods. For example, the at least one second imaging unit 204 can extract a static image of a particular feature within field of view 404 and pass the static image to the hub processor 502. The hub processor 502 can signal one or more other image processors 504N to monitor for the particular feature in anticipation of the particular feature moving into another field of view such as field of view 406 or fisheye field of view 402. Alternatively, the particular feature can be used as the basis for pixel decimation in one or more image processors 504N, such as programming the one or more image processors 504N to decimate pixels other than that of the particular feature.

In one embodiment, the at least one second imaging unit configured to capture and process imagery of a second field of view that is proximate to and that is larger than a size of the first field of view includes, but is not limited to, at least one second imaging unit configured to capture and process visible imagery of a second field of view that is proximate to and that is larger than a size of the first field of view at 912. For example, the at least one second imaging unit 204 is configured to capture and process visible imagery of a second field of view 404 that is proximate to and that is larger than a size of the first field of view 406. Visible imagery is that associated with the visible spectrum of approximately 390 nm to 700 nm. Thus, the image sensor 508N of the second imaging unit 204 can be sensitive to wavelengths of light within the visible spectrum. Certain ones of the second imaging unit 204 and 204N can be dedicated to visible image capture or can be configured for combination infrared and visible image capture. In some embodiments, the image processor 504N is configured to trigger collection of visible image data from the image sensor 508N, versus infrared image capture, based on detection of high light levels, an orbital path position indicative of sunlight, or detection of visual ground contact unobscured by clouds.

In one embodiment, the at least one second imaging unit configured to capture and process imagery of a second field of view that is proximate to and that is larger than a size of the first field of view includes, but is not limited to, at least one second imaging unit configured to capture and process infrared imagery of a second field of view that is proximate to and that is larger than a size of the first field of view at 914. For example, at least one second imaging unit 204 is configured to capture and process infrared imagery of a second field of view 404 that is proximate to and that is larger than a size of the first field of view 406. Infrared imagery is light having a wavelength of approximately 700 nm to 1 mm. Near-infrared imagery is light having a wavelength of approximately 0.75-1.4 micrometers. The infrared imagery can be used for night vision, thermal imaging, hyperspectral imaging, object or device tracking, meteorology, climatology, astronomy, and other similar functions. The image sensor 508N of the second imaging unit 204 can be dedicated to infrared image collection as static imagery or as video imagery. Alternatively, the image sensor 508N of the second imaging unit 204 can be configured for simultaneous capture of infrared and visible imagery through use of a beam splitter within the optical arrangement 512. Additionally, the at least one second imaging unit 204 can be configured for infrared image capture automatically upon detection of low light levels or upon detection of cloud obscuration of Earth. Thus, an object detected within the field of view 404 through use of visual image data can be continued to be tracked as the object moves below a cloud obscuration or into a nighttime area of Earth. In certain embodiments, infrared image data captured is used for object tracking and to determine a position of an object within a background scene. For instance, a user request to view video of a migration of animals may be satisfied using old non-obscured or daylight visual imagery of the animals that are moved in line with real-time or near-real time position data of the animals detected through infrared imagery.

In one embodiment, the at least one second imaging unit configured to capture and process imagery of a second field of view that is proximate to and that is larger than a size of the first field of view includes, but is not limited to, at least one second imaging unit configured to capture and perform first order processing on imagery of a second field of view that is proximate to and that is larger than a size of the first field of view prior to communication of at least some of the imagery of the second field of view to the hub processing unit at 916. For example, the at least one second imaging unit 204 is configured to capture and perform first order processing on imagery of a second field of view 404 that is proximate to and that is larger than a size of the first field of view 406 prior to communication of at least some of the imagery of the second field of view 404 to the hub processing unit 502. The image sensor 508N of the second imaging unit 204 captures significant amounts of image data through use of high resolution sensors and high frame rates, for example. However, some or most of the image data collected by the image sensor 508N may not be needed, such as because it fails to contain any feature, device, object, activity, object, event, vehicle, terrain, weather, etc. of interest or because the image data has previously been communicated and is unchanged or because the image data is simply not requested. Thus, the image processor 504N associated with the image sensor 508N can perform first order processing on the image data prior to transmission of the image data to the hub processor 502. Such first order processing can include operations such as pixel decimation (e.g., dispose up to 99.9 percent of pixel data captured), resolution reduction (e.g., remove a percentage of pixels based on a digital zoom level requested), static object or unchanged object removal (e.g., remove pixel data that has previously been transmitted and hasn't changed more than a specified percentage amount), or parallel request removal (e.g., transmit image data that overlaps with another request only once to the hub processor 502). Other first order processing operations can include color changes, compression, shading additions, or other image processing functions. Further first order processing can include machine vision or artificial intelligence operations, such as outputting binary, alphanumeric text, parameters, or executable instructions based on content present within the field of view 404. For example, the image processor 504N can obtain image data captured by the image sensor 508N. Multiple parallel operations can be performed with respect to the content within the image data, such as one application may monitor for ships and aircraft, another may detect forest fire flames or heat, and another may monitor for low pressure and weather systems. Upon detection of one or more of these items, the processor 504N can communicate pixels associated with each, GPS coordinates, and an alphanumeric description of the subject matter detected, for example. Hub processor 502 can program other image processors 504N to monitor or detect similar items in anticipation of those items being present within one or more other fields of view 402, 404, 406, or 408.

In one embodiment, the at least one second imaging unit configured to capture and process imagery of a second field of view that is proximate to and that is larger than a size of the first field of view includes, but is not limited to, at least one second imaging unit configured to capture and process imagery of a second peripheral field of view that is proximate to and that is larger than a size of the first field of view at 918. For example, the at least one second imaging unit 204 is configured to capture and process imagery of a second peripheral field of view 404 that is proximate to and that is larger than a size of the first field of view 406. Field of view 404 can be peripheral to field of view 406 in the sense that it is outside and adjacent to the field of view 406. In circumstances where field of view 404 is composed of a plurality of subfields, such as between two and tens of subfields or around six subfields, the plurality of subfields can form a perimeter around the field of view 406 with a center punch-out portion for the field of view 404 (e.g., larger in this context may mean wider but including less area due to a center void). For instance, two subfields of the field of view 404 can be arranged above the field of view 406, two subfields of the field of view 404 can be arranged below the field of view 406, and two subfields of the field of view 404 can be arranged on opposing sides of the field of view 406. Overlap between adjacent subfields can be approximately one to tens of percentage amounts or approximately five percent. Furthermore, overlap between subfields of the field of view 404 may overlap with the field of view 406, such as by one to tens of percentage amounts or approximately five percent.

In one particular embodiment, the image processor 504N associated with the field of view 404 is configured to detect motion, which may be the result of human, environmental, or geological activities, for example. Detected motion by the image processor 504N is used to trigger detection functions within the field of view 406 or movement of the steerable spot imaging units 104. In another example, a user request for an object within the field of view 404 may be satisfied by the image processor 504N using the image content of the image sensor 508N of the second imaging unit 204, until a limit is reached for zoom level. At such time, the steerable spot imaging unit 104 may be called upon to the field of view 406 to align with the object to enable additional zoom capabilities and increased spatial resolution.

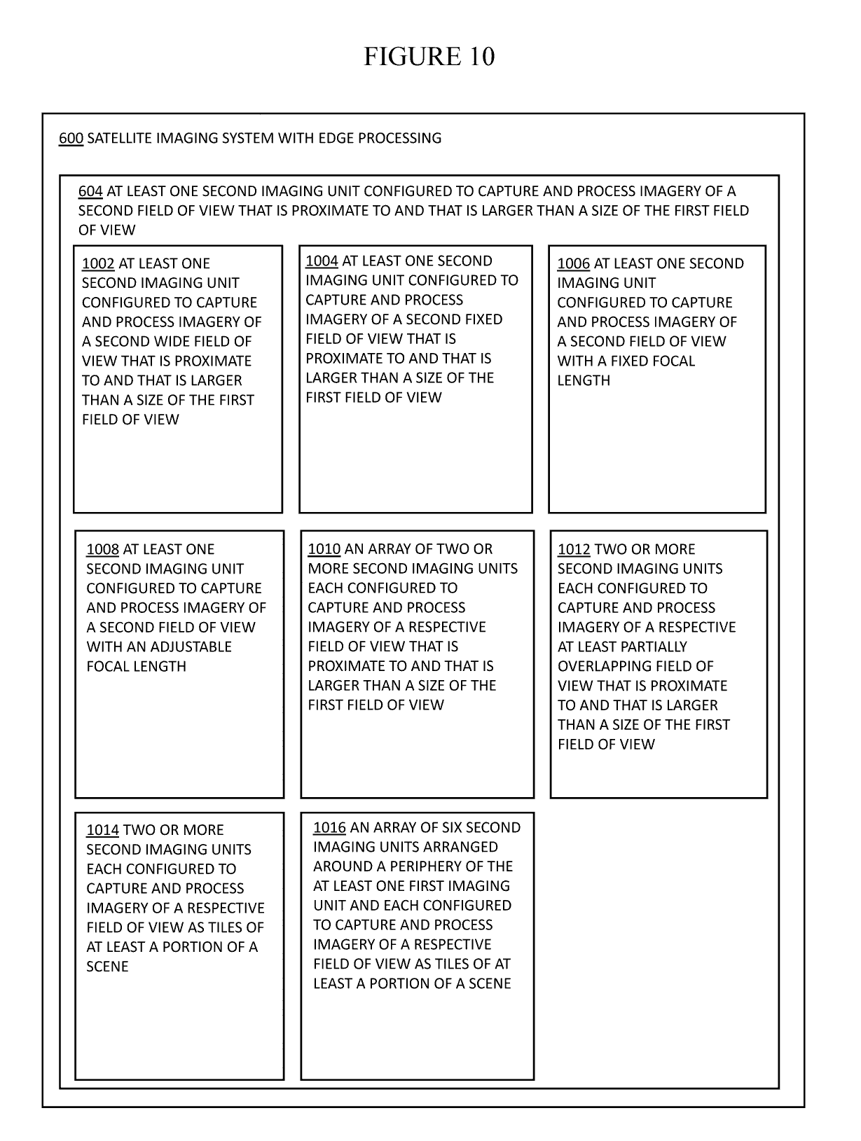

FIG. 10 is a component diagram of a satellite imaging system with edge processing, in accordance with an embodiment.

In one embodiment, the at least one second imaging unit configured to capture and process imagery of a second field of view that is proximate to and that is larger than a size of the first field of view includes, but is not limited to, at least one second imaging unit configured to capture and process imagery of a second wide field of view that is proximate to and that is larger than a size of the first field of view 1002. For example, the at least one second imaging unit 204 is configured to capture and process imagery of a second wide field of view 404 that is proximate to and that is larger than a size of the first field of view 406. The second wide field of view 404 can therefore be larger in a width or height dimension as compared to the field of view 406. For example, the second wide field of view 404 can be between approximately five to a few hundred percent larger than the field of view 406 or approximately fifty or one hundred percent of the dimensions of the field of view 406. In one particular embodiment, the field of view 404 includes dimensions of approximately ninety degrees by ninety degrees with a center portion carve out of approximately thirty by forty degrees for the field of view 406 (which can result in an overall area of field of view 404 being less than that of the field of view 406). The field of view 404 can be composed of subfields, such as approximately six subfields of view of approximately 42×32 degrees each. The field of view 406 by comparison can be composed of subfields that are narrower, such as approximately nine subfields of view of approximately 10.5×14 degrees each. In certain embodiments, field of view 404 at least partially or entirely overlaps field of view 406 (e.g., field of view 406 can be covered by field of view 404).

In one embodiment, the at least one second imaging unit configured to capture and process imagery of a second field of view that is proximate to and that is larger than a size of the first field of view includes, but is not limited to, at least one second imaging unit configured to capture and process imagery of a second fixed field of view that is proximate to and that is larger than a size of the first field of view at 1004. For example, the at least one second imaging unit 204 is configured to capture and process imagery of a second fixed field of view 404 that is proximate to and that is larger than a size of the first field 406. The optical arrangement 512 can be fixedly mounted on the outer mounting plate 208 as depicted in FIG. 2. In instances of six subfields of the field of view 404, six optical arrangements of the second imaging units 204 and 204N can be oriented as follows: bottom lens on opposing sides each oriented to capture top two subfields of field of view 404; middle lens on opposing sides each oriented to capture side subfields of field of view 404; and top lens on opposing sides each oriented to capture bottom two subfields of field of view 404. In each of these cases, the respective lens to subfield is cross-aligned such that left lens are associated with right subfields and vice versa. Other embodiments of the optical arrangements of the imaging units 204 and 204N are possible, including positioning of the lenses above, on a side, on a corner, opposing, oppositely facing, or intermixed with optical arrangements of the first imaging unit 202. While the field of view 404 may be mechanically fixed, zoom and pan operations can be performed digitally by the image processor 504N. For instance, the optical arrangement 512 can be fixed to capture a field of view that is X wide and Y in height using the image sensor 508N. The image processor 504N can manipulate the captured image data within the X by Y envelop to digitally recreate zoom and pan effects. Additionally, the second imaging unit 204 and 204N can be repositionable or movable to change a position of a corresponding subfield of the field of view 404. Additionally, the optical arrangement 512 can be configured with an adjustable focal length and configured to pivot, slide, or rotate for panning. Movement can 270 be accomplished by moving the optical arrangement 512 or by moving the plate 108.

In one embodiment, the at least one second imaging unit configured to capture and process imagery of a second field of view that is proximate to and that is larger than a size of the first field of view includes, but is not limited to, at least one second imaging unit configured to capture and process imagery of a second field of view with a fixed focal length at 1006. For example, the at least one second imaging unit 204 is configured to capture and process imagery of a second field of view 404 with a fixed focal length. The optical arrangement 512 can comprise a 8.0 mm focal length, high resolution infinite conjugate micro video lens. Characteristics of this lens include a field of view on ½″ sensor of 46 degrees; working distance of 400 mm to infinity; maximum resolution full field 20 percent at 160 lp/mm; distortion-diagonal at full view −10 percent; aperture f/2.5; maximum MTF listed at 160 lp/mm. Other lenses of similar characteristics can be substituted for this particular example lens.

In one embodiment, the at least one second imaging unit configured to capture and process imagery of a second field of view that is proximate to and that is larger than a size of the first field of view includes, but is not limited to, at least one second imaging unit configured to capture and process imagery of a second field of view with an adjustable focal length at 1008. In one embodiment, at least one second imaging unit 204 is configured to capture and process imagery of a second field of view 404 with an adjustable focal length. The adjustable focal length can be performed, for example, by mechanical threads that adjust a distance of one or more of the lenses of the optical arrangement 512 relative to the image sensor 508N. In instances of mechanically adjustable focal lengths, the image processor 504N can further digitally recreate additional zoom and/or pan operations within the envelope of image data captured by the image sensor 508N.

In one embodiment, the at least one second imaging unit configured to capture and process imagery of a second field of view that is proximate to and that is larger than a size of the first field of view includes, but is not limited to, an array of two or more second imaging units each configured to capture and process imagery of a respective field of view that is proximate to and that is larger than a size of the first field of view at 1010. For example, an array of two or more second imaging units 204 and 204N are each configured to capture and process imagery of a respective subfield of the field of view 404 that is proximate to and that is larger than a size of the first field of view 406. The array of two or more second imaging units 204 and 204N can include approximately two to tens or hundreds of imaging units. Optical arrangements 512 of the two or more second imaging units 204 and 204N can be oriented to form subfields of the field of view 404 that are aligned in a circle, grid, rectangle, square, triangle, line, concave, convex, cube, pyramid, sphere, oval, or other regular or irregular pattern. Further, subfields of the field of view 404 can be layered, such as to form circles of increasing radiuses about a center. In one particular embodiment, the subfields of the field of view 404 comprise six in number and are arranged around a circumference of the field of view 406.

In one embodiment, the at least one second imaging unit configured to capture and process imagery of a second field of view that is proximate to and that is larger than a size of the first field of view includes, but is not limited to, two or more second imaging units each configured to capture and process imagery of a respective at least partially overlapping field of view that is proximate to and that is larger than a size of the first field of view at 1012. For example, the two or more second imaging units 204 and 204N are each configured to capture and process imagery of a respective at least partially overlapping subfield of the field of view 404 that is proximate to and that is larger than a size of the first field of view 406. The subfields of the field of view 404 can overlap with one another as well as with the field of view 406, spot fields of view 408, and/or fisheye field of view 402. Overlap degrees can range from approximately one to a hundred percent. In one particular example, subfields of the field of view 404 overlap by approximately 5 percent with adjacent subfields of the field of view 404. Additionally, the subfields of the field of view 404 overlap with adjacent subfields of the field of view 406 by approximately 5 percent. Spot fields 408 can movably overlap with any of the subfields of the field of view 404 and fisheye field of view 402 can overlap subfields of the field of view 406. Overlap of subfields of the field of view 404 permit image processors 504N, associated with adjacent subfields of the field of view 404, to have access to at least some of the same imagery to enable the hub processor 502 to stitch together image content. For example, the image processor 504N can obtain image content from the bottom left subfield of the field of view 404, which includes part of an object of interest such as a hurricane cloud formation. Another image processor 504N can likewise obtain image content from a bottom right subfield of the field of view 404, including an extension of the hurricane cloud formation. Image processor 504N and the other image processor 504N each have different image content of the hurricane cloud formation with some percentage of overlap. Following any pixel reduction performed by the respective image processor 504N and the other image processor 504N, the residual image content can be communicated to the hub processor 502. The hub processor 502 can stitch the image content from the image processor 504N and the other image processor 504N to create a composite image of the hurricane cloud formation, using the overlapping portions for alignment.

In one embodiment, the at least one second imaging unit configured to capture and process imagery of a second field of view that is proximate to and that is larger than a size of the first field of view includes, but is not limited to, two or more second imaging units each configured to capture and process imagery of a respective field of view as tiles of at least a portion of a scene at 1014. Tiling of the scene 400 combined with parallel processing by an array of image processors 504 and 504N enables higher speed image processing with access to more raw image pixels. With respect to image data, the raw image data is substantially increased for the overall scene 400 by partitioning the scene 400 into tiles, such as subfields of the field of view 404. Each of the tiles is associated with an optical arrangement 512 and an image sensor 508N that captures megapixels of image data per frame with multiples of frames per second. A single image sensor can capture approximately 20 megapixels of image data at a rate of approximately 20 frames per second. This amount of image data is multiplied for each additional tile to generate significant amounts of image data, such as approximately 400 gigabytes per second per satellite 500 and approximately 30 terabytes per second or more of image data per constellation of satellites 500N. Thus, the combination of multiple tiles and multiple image sensors results in significantly more image data than would be possible with a single lens and sensor arrangement covering an entirety of the scene 400. Processing of the significant raw image data is enabled by parallel image processors 504N, which each perform operations for a specified tile of the plurality of tiles. These operations can include those referenced herein, such as image reduction, resolution reduction, object and pixel removal, previously transmitted or overlapping pixel removal, etc. and can be performed at the same time with respect to each of the tiled portions of the scene 400.

In one embodiment, the at least one second imaging unit configured to capture and process imagery of a second field of view that is proximate to and that is larger than a size of the first field of view includes, but is not limited to, an array of six second imaging units arranged around a periphery of the at least one first imaging unit and each configured to capture and process imagery of a respective field of view as tiles of at least a portion of a scene at 1016. For example, satellite 500 includes an array of six second imaging units 204 and 204N arranged around a periphery of the at least one first imaging unit 202 that are each configured to capture and process imagery of a respective subfield of the field of view 404 as six tiles of at least a portion of a scene 400 using a plurality of parallel image processors 504N.

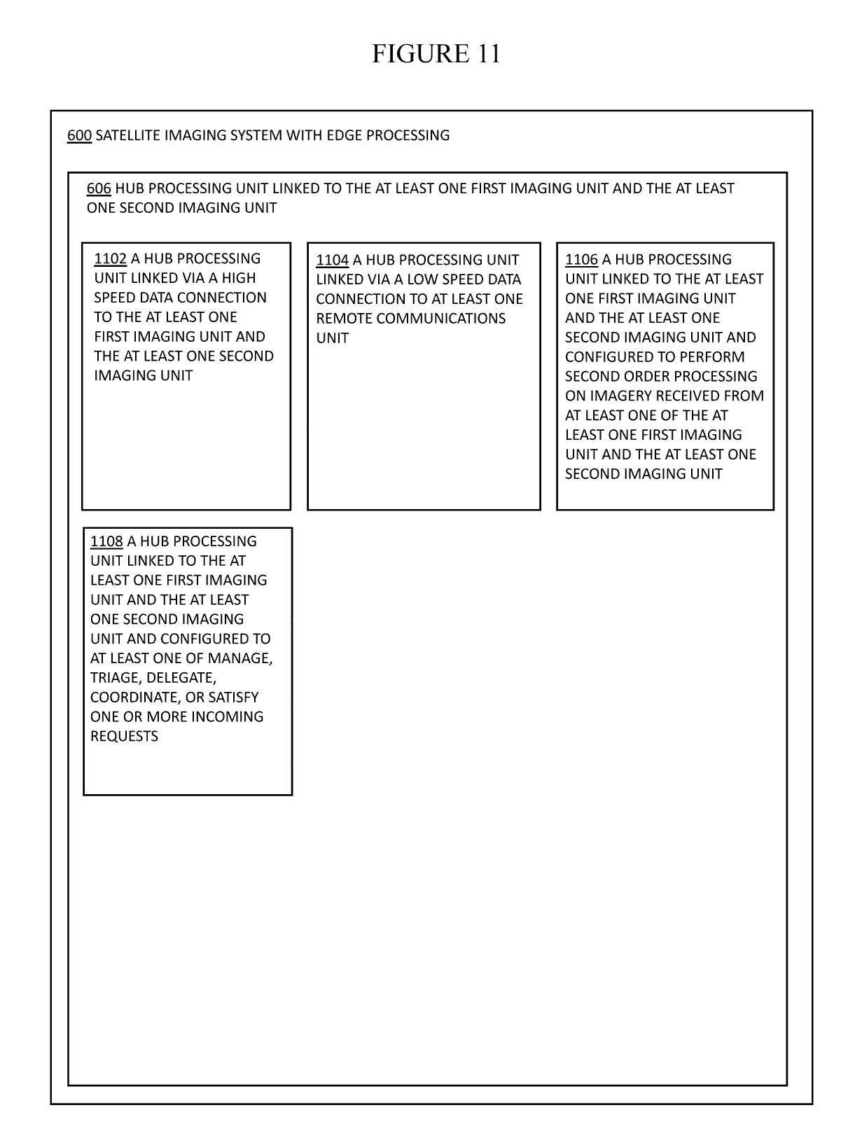

FIG. 11 is a component diagram of a satellite imaging system with edge processing, in accordance with an embodiment.

In one embodiment, the hub processing unit linked to the at least one first imaging unit and the at least one second imaging unit includes, but is not limited to, a hub processing unit linked via a high speed data connection to the at least one first imaging unit and the at least one second imaging unit at 1102. In one example, a hub processing unit 502 is linked via a high speed data connection to the image processors 504 and 504N of the at least one first imaging unit 202 and the at least one second imaging unit 204, respectively. The high speed data connection is provided by a wire or trace coupling and communications protocol. Data speeds between the hub processing unit 502 and the image processors 504 and 504N can be in the range of tens of megabytes per second through hundreds of gigabytes or more per second. For instance, data rates of approximately 10 gigabytes per second are possible with USB 3.1 and data rates of approximately 10 to a 100 gigabytes per second are possible with ethernet. Thus, the hub processor 502 can obtain image data provided by the image processors 504 and 504N in real-time or near real-time as capture of the image data by the image sensors 508 and 508N without substantial lag due to communications constraints.

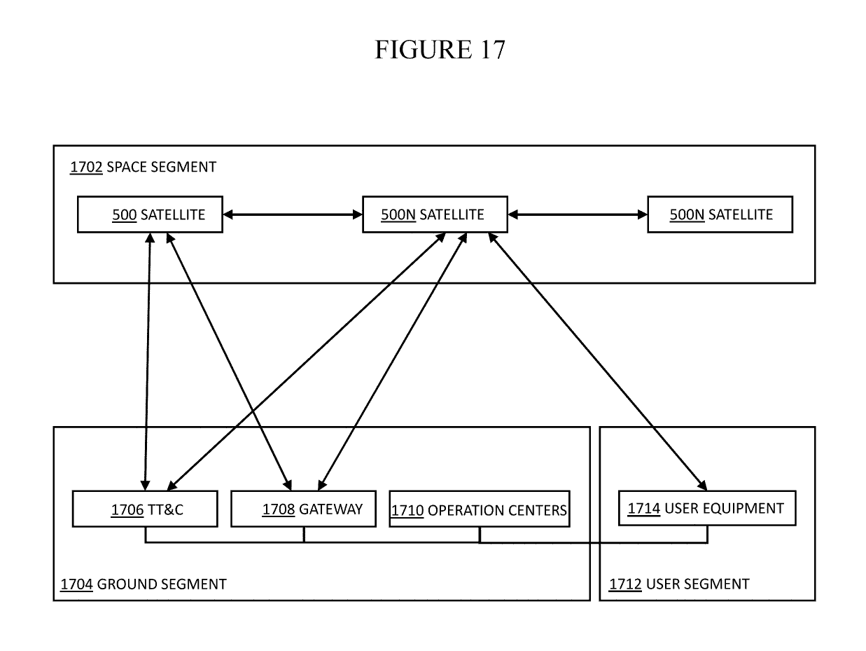

In one embodiment, the hub processing unit linked to the at least one first imaging unit and the at least one second imaging unit includes, but is not limited to, a hub processing unit linked via a low speed data connection to at least one remote communications unit at 1104. For example, the hub processing unit 502 is linked via a low speed data connection using the wireless communication interface or gateway 506 to at least one remote communications unit on the ground (FIG. 17). Low speed data connection does not necessarily mean slow in terms of user or consumer perception. Low speed data connection in the context used herein is intended to mean slower relative to the high speed data connection that exists on-board the satellite (e.g., between the hub processor 502 and the image processor 504). The wireless communication interface or gateway 506 between the satellite 500 and a ground station or another satellite 500N can use one or more of the following frequency bands: Ka-band, Ku-band, X-band, or similar. There can be one, two, or more wireless communication interfaces or gateways 506/antennas per satellite 500 (e.g., one antenna can be positioned forward and another antenna can be positioned aft relative to an orbital progression). Data bandwidth rates of the wireless communication interface or gateway 506 can range from a few kilobytes per second to hundreds of megabytes per second or even gigabytes per second. More specifically, bandwidth rates can be approximately 200 Mbps per satellite with a burst of around two times this amount for a period of hours. The bandwidth rate of the wireless communication interface or gateway 506 to the ground stations is therefore substantially dwarfed by the image capture data rate of the satellite 500, which can in some embodiments be approximately 400 gigabytes per second. Through the image reduction operations and other edge processing operations performed on-board the satellite 500 and discussed herein, high resolution imagery can still be transmitted over the wireless communication interface 506 despite its constraints with an average user-to-satellite latency of less than 250 milliseconds or preferrably less than around 100 milliseconds.

In one embodiment, the hub processing unit linked to the at least one first imaging unit and the at least one second imaging unit includes, but is not limited to, a hub processing unit linked to the at least one first imaging unit and the at least one second imaging unit and configured to perform second order processing on imagery received from at least one of the at least one first imaging unit and the at least one second imaging unit at 1106. For example, the hub processing unit 502 is linked to the at least one first imaging unit 202 and the at least one second imaging unit 204 and is configured to perform second order processing on imagery received from at least one of the at least one first imaging unit 202 and the at least one second imaging unit 204. The hub processor 502 can receive constituent component parts of imagery from one or more of the at least one first imaging unit 202 and the at least one second imaging unit 204 each associated with different fields of view, such as fields of view 404 and 406, via the image processors 504 and 504N. The hub processor 502 obtains the component parts of the imagery and performs second order processing prior to communication of image data associated with the imagery via the wireless communication interface or gateway 506. For example, the second order processing can include any of the first order processing discussed and illustrated with respect to the image processor 504 or 504N. These operations include pixel decimation, resolution reduction, pixel reduction, background subtraction, unchanged area removal, previously transmitted area removal, image pre-processing, etc. Additionally or alternatively, the hub processor 502 can perform operations such as stitching of constituent image parts into a composite image, compression, and/or encoding. Stitching can involve aligning, comparison, keypoint detection, registration, calibration, compositing, and/or blending, for example, to combine two image parts into a composite image. Compression can involve reduction of image data to use fewer bits than an original representation and can include lossless data compression or lossy data compression. Encoding can involve storing information in accordance with a protocol and/or providing information on how a recipient should process data.

As an example, hub processor 502 can receive three video parts A, B, and C from three image processors 504 and 504N1 and 504N2. The three video parts A, B, and C cover content of subfields of fields of view 404 and 406, which were captured by image sensors 508 and 508N1 and 508N2. The three image processors 504 and 504N1 and 504N2 performed first order processing on the respective video parts A, B, and C in parallel to identify and retain video portions related to a major calving of an iceberg near the North Pole. The first order processing included removal of pixel data associated with unchanging ocean imagery, unchanging snow and icebergy imagery, and resolution reduction by approximately fifty percent of the remaining imagery associated with the calving itself. The hub processor 502 obtains the residual video image content A, B, and C from each of the image processors 504 and 504N1 and 504N2 and stitches the constituent parts into a composite video. The composite video is compressed and encoded for transmission as a video of the calving with few to no indications that the video was actually sourced from disparate sources. The resultant composite video of the calving is communicated via the wireless communication interface or gateway 506 within milliseconds for high resolution display on one or more ground devices (e.g., a computer, laptop, tablet or smartphone).

In one embodiment, the hub processing unit linked to the at least one first imaging unit and the at least one second imaging unit includes, but is not limited to, a hub processing unit linked to the at least one first imaging unit and the at least one second imaging unit and configured to at least one of manage, triage, delegate, coordinate, or satisfy one or more incoming requests at 1108. For example, the hub processing unit 502 is linked to the at least one first imaging unit 202 and the at least one second imaging unit 204 and is configured to at least one of manage, triage, delegate, coordinate, or satisfy one or more incoming requests received via the communication interface or gateway 506. Requests received via the communication interface or gateway 506 can include program requests or user requests from a ground station or device. Furthermore requests can be generated on-board the satellite 500 or another satellite 500N via any of the image processors 504 and 504N and/or the hub processor 502, such as by an application for performing machine vision or artificial intelligence. Requests can be for imagery associated with a particular field of view, imagery associated with a particular object, imagery associated with a GPS coordinate, imagery associated with a particular event or activity, text output, binary output, or the like. Management of the requests can include obtaining the request, determining the operations required to satisfy the request, identifying one or more of the imaging units 202, 204, 104, or 210 with access to content for satisfying the request, obtaining image data responsive to the request, generating binary or text data responsive to the request, initiating responsive processes or actions based on image or binary or text data, and/or transmitting communication data responsive to the request. Triage can include the hub processor 502 determining which of the image processors 504 and 504N have access to information required for satisfying a request. The hub processor 502 can determine the access based on queries to the image processors 504 and 504N; based on stored information regarding orbital path, GPS location, and alignment of respective fields of view; or based on image data or other information previously transmitted by the image processors 504 and 504N. Delegating can include the hub processor 502 initiating processes or actions with respect to one or more of the image processors 504 and 504N, such as initiating multiple parallel actions by a plurality of the image processors 504 and 504N. Coordinating can include the hub processor 502 serving as an intermediary between a plurality of the image processors 504 and 504N, such as transmitting information to one image processor 504N in response to information received from another image processor 504.

For example, hub processor 502 can receive a program request of an on-board machine vision application for detecting smoke or fire associated with a wildfire and determining locations of a wildfire. The hub processor 502 can transmit image recognition content to each of the image processors 504 and 504N for storage in memory. The image processors 504 and 504N perform image recognition operations in parallel using the image recognition content with respect to imagery obtained for respective fields of view, such as fields of view 404 and 406, to detect imagery associated with a wildfire. In response to detection of a wildfire by at least one of the image processors 504 and 504N, the image processors 504 and 504N perform pixel decimation, pixel reduction, and cropping operations on respective imagery to retain that which pertains to the wildfire at a specified resolution (e.g., mobile phone screen resolution). The reduced imagery is obtained by the hub processor 502 from the image processors 504 and 504N, which transmits to a recipient (e.g., natural disaster personnel) a binary indication of wildfire detection, GPS coordinate data of the wildfire, and a video of the wildfire stitched together from multiple constituent parts. Additionally, the hub processor 502 may trigger one or more other image processors 504N to begin tracking video information associated with vehicles in and around an area where the wildfire exists, which video can be used for investigative purposes.

Reference and illustration has been made to a single hub processor 502 linked with a plurality of image processors 504 and 504N. However, in certain embodiments a plurality of hub processors 502 are provided on the satellite 500, whereby each of the hub processors 502 are associated with a plurality of image processors. In this example, a hub manager processor can perform management operations with respect to the plurality of hub processors 502.

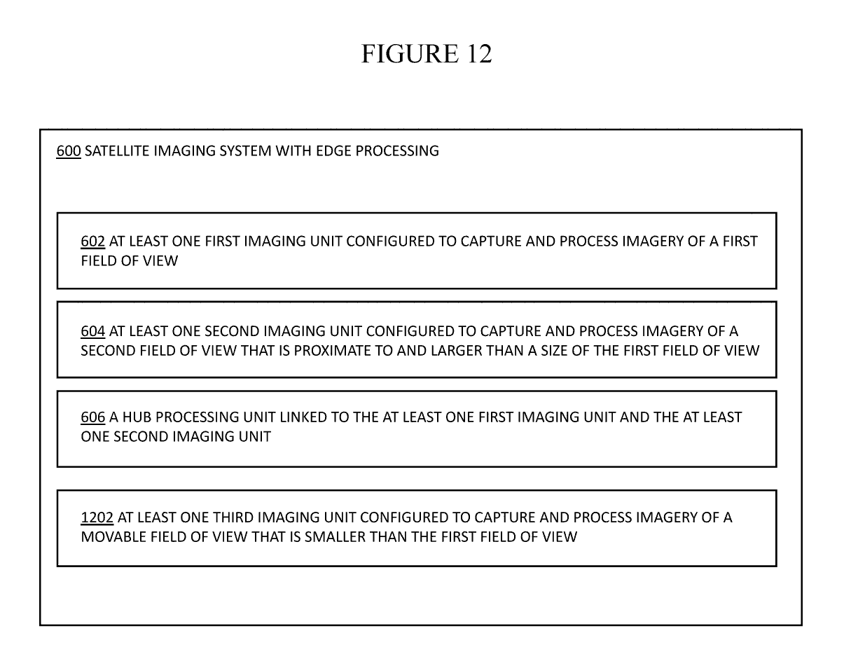

FIG. 12 is a component diagram of a satellite imaging system with edge processing, in accordance with an embodiment. In one embodiment, a satellite imaging system with edge processing 600 includes, but is not limited to, at least one first imaging unit configured to capture and process imagery of a first field of view at 602; at least one second imaging unit configured to capture and process imagery of a second field of view that is proximate to and larger than a size of the first field of view at 604; at least one third imaging unit configured to capture and process imagery of a movable field of view that is smaller than the first field of view at 1202; and a hub processing unit linked to the at least one first imaging unit and the at least one second imaging unit and the at least one third imaging unit at 606. For example, a satellite 500 includes an imaging system 100 with edge processing. The satellite imaging system 100 includes, but is not limited to, at least one first imaging unit 202 configured to capture and process imagery of a first field of view 406; at least one second imaging unit 204 configured to capture and process imagery of a second field of view 404 that is proximate to and larger than a size of the first field of view 406; at least one third imaging unit 104 configured to capture and process imagery of a movable field of view 408 that is smaller than the first field of view 406; and a hub processing unit 502 communicably linked to the at least one first imaging unit 202 and the at least one second imaging unit 204 and the at least one third imaging unit 104.

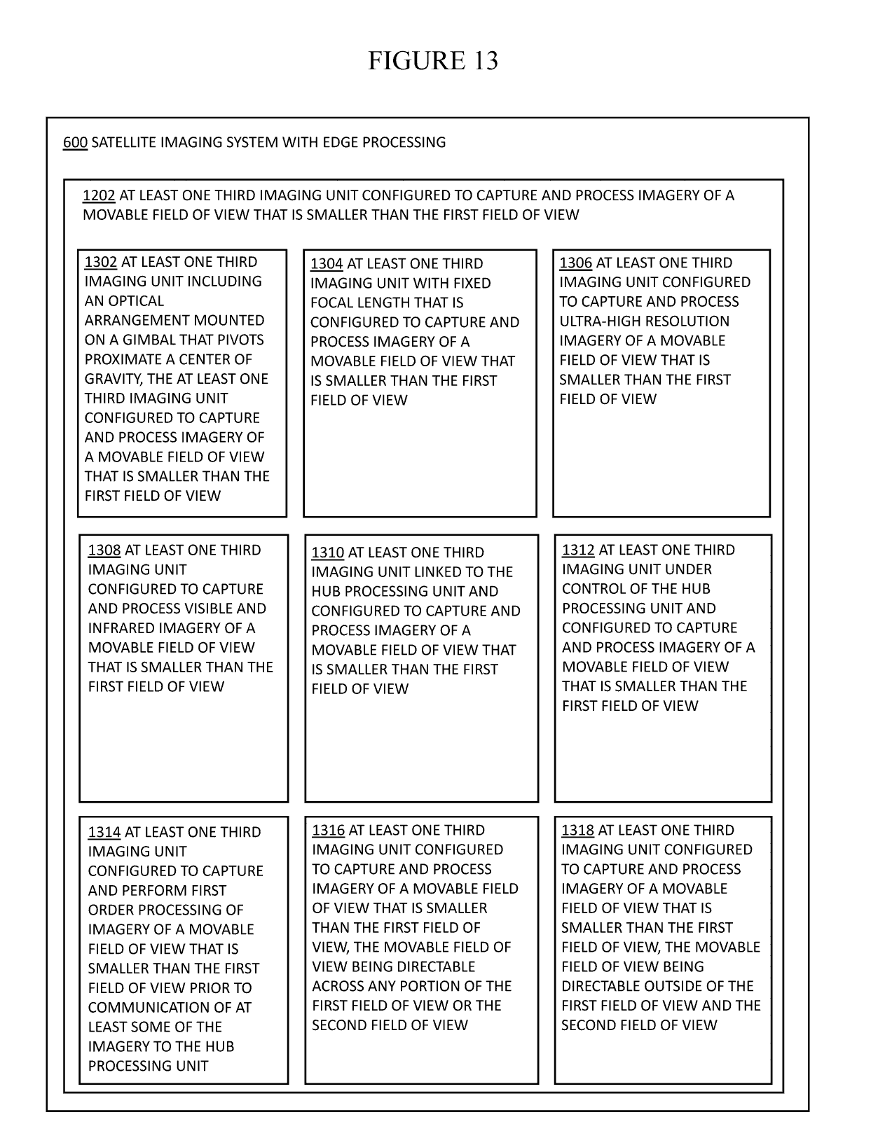

FIG. 13 is a component diagram of a satellite imaging system with edge processing, in accordance with an embodiment.

In one embodiment, the at least one third imaging unit configured to capture and process imagery of a movable field of view that is smaller than the first field of view includes, but is not limited to, at least one third imaging unit including an optical arrangement mounted on a gimbal that pivots proximate a center of gravity, the at least one third imaging unit configured to capture and process imagery of a movable field of view that is smaller than the first field of view 1302. For example, the at least one third imaging unit 104 includes an optical arrangement 514 mounted on a gimbal that pivots proximate a center of gravity. The optical arrangement 514 pivots, rotates, moves, and/or steers to adjust alignment of a field of view 408. Slew of the optical arrangement 514 can therefore result in counter-forces that may affect the stability of image capture of one or more other imaging units (e.g., another third imaging unit 104, a fourth imaging unit 210, the second imaging unit 204, or the first imaging unit 202). In this particular embodiment, a gimbal is mounted to the optical arrangement 514 near or at a center of gravity of the optical arrangement 514 to reduce counter-effects of slew.

In one embodiment, the at least one third imaging unit configured to capture and process imagery of a movable field of view that is smaller than the first field of view includes, but is not limited to, at least one third imaging unit with fixed focal length that is configured to capture and process imagery of a movable field of view that is smaller than the first field of view at 1304. For example, the at least one third imaging unit 104 includes an optical arrangement 514 with a fixed focal length that is configured to capture and process imagery of a movable field of view 408 that is smaller than the first field of view 406. In certain embodiments, a catadioptric design of the spot imager 104 can include a primary reflector 306; a secondary reflector 308; three meniscus singlets as refractive elements 310 positioned within a lens barrel 312; a beamsplitter cube 314 to split visible and infrared channels; a visible image sensor 316; and an infrared image sensor 318. The primary reflector 306 and the secondary reflector 308 can include mirrors of Zerodur or CCZ; a coating of aluminum having approximately 10 A RMS surface roughness; a mirror substrate thickness to diameter ratio of approximately 1:8. The dimensions of the steerable spot imager 104 include an approximately 114 mm tall optic that is approximately 134 mm in diameter across the primary reflector 306 and approximately 45 mm in diameter across the secondary reflector 308. Characteristics of the steerable spot imager 104 can include temperature stability; low mass (e.g., approximately 1 kg of mass); few to no moving internal parts; and positioning of the image sensors within the optical arrangement 514.

Many other steerable spot imager 104 configurations are possible, including a number of all-refractive type lens arrangements. For instance, one possible spot imager 104 achieving less than approximately 3 m spatial resolution at 500 km orbit includes a 209.2 mm focal length, a 97 mm opening lens height; a 242 mm lens track; less than F/2.16; spherical and aspherical lenses of approximately 1.3 kg; and a beam splitter for a 450 nm-650 nm visible channel and an 800 nm to 900 nm infrared channel.

Another steerable spot imager 104 configuration includes a 165 mm focal length; F/1.7; 2.64 degree diagonal object space; 7.61 mm diagonal image; 450-650 nm waveband; fixed focus; limited diffraction; and anomalous-dispersion glasses. Potential lens designs include a 9-element all-spherical design with a 230 mm track and a 100 mm lens opening height; a 9-element all-spherical design with 1 triplet and a 201 mm track with a 100 mm lens opening height; and an 8-element design with 1 asphere and a 201 mm track with a 100 mm lens opening height. Other steerable spot imager 104 configurations can include any of the following lens or lens equivalents having focal lengths of approximately 135 mm to 200 mm: OLYMPUS ZUIKO; SONY SONNAR T*; CANON EF; ZEISS SONNAR T*; ZEISS MILVUS; NIKON DC-NIKKOR; NIKON AF-S NIKKOR; SIGMA HSM DG ART LENS; ROKINON 135M-N; ROKINON 135M-P, or the like.

In one embodiment, the at least one third imaging unit configured to capture and process imagery of a movable field of view that is smaller than the first field of view includes, but is not limited to, at least one third imaging unit configured to capture and process ultra-high resolution imagery of a movable field of view that is smaller than the first field of view at 1306. For example, the at least one third imaging unit 104 is configured to capture and process ultra-high resolution imagery of a movable field of view 408 that is smaller than the first field of view 406. The field of view 408 is movable and steerable in certain embodiments anywhere throughout the fisheye 402 field of view, the outer field of view 404, and/or the inner field of view 406. In some embodiments, the field of view 408 is additionally movable outside the fisheye field of view 402. In embodiments with additional third imaging units 104, a plurality of fields of view 408 are independently movable and/or overlappable within and/or outside any of the fisheye field of view 402, the outer field of view 404, and the inner field of view 406. The field of view 408 is smaller in size that the field of views 406, 402, and 404 and, in one particular embodiment, corresponds to an approximate area of coverage of a 20 kilometer diagonal portion of Earth at an approximately 4:3 aspect ratio and yields an approximate spatial resolution of 1-3 meters.

In certain embodiments, the third imaging unit 104 is programmed to respond to objects, features, activities, events, or the like detected within one or more other fields of view 408, 406, 404, and/or 402. Alternatively and/or additionally, the third imaging unit 104 is programmed to respond to one or more user requests or program requests for panning and/or alignment. In certain cases, the third imaging unit 104 responds to client or program instructions for alignment, but in an event no client or program instructions are received reverts to automated alignment on detected objects, events, features, activities, or the like within field of view 400. In one particular embodiment, the spot field of view 408 dwells on a particular target constantly as the satellite 500 progresses in its orbital path, thereby creating multiple frames of video of the target. Small movements of the third imaging unit 104 are automatically made to accomplish the fixation despite satellite 500 orbital movement.

For example, a ballistic missile launch can be detected within the fisheye field of view 402 by an image processor 504N. Hub processor 502 can then control image processor 504N1 to hone the third imaging unit 104 and the spot field of view 408 on the ballistic missile. Updated tracking information from the image processor 504N can be provided as ongoing feedback to the image processor 504N1 to control movement of the third imaging unit 104 and the spot field of view 408.

In one embodiment, the at least one third imaging unit configured to capture and process imagery of a movable field of view that is smaller than the first field of view includes, but is not limited to, at least one third imaging unit configured to capture and process visible and infrared imagery of a movable field of view that is smaller than the first field of view at 1308. For example, the at least one third imaging unit 104 is configured to capture and process visible and infrared imagery of a movable field of view 408 that is smaller than the first field of view 406. Visible imagery is that light reflected off of Earth, weather, or that emitted from objects or devices on Earth, for example, that is within the visible spectrum of approximately 390 nm to 700 nm. Visible imagery of the spot field of view 408 can include content such as video and/or static imagery obtained using the third imaging unit 104 as the satellite 500 progresses through its orbital path and the third imaging units 104 is moved within its envelope (e.g., plus or minus 70 degrees). Thus, visible imagery can include a video of any specific areas within the outskirts of Bellevue to Bremerton in Washington via Mercer Island, Lake Washington, Seattle, Puget Sound, following the path of the satellite 500. This visible imagery can therefore include a momentary or dwelled focus on terrain (e.g., Mercer Island), traffic (e.g., 520 bridge), cityscape (e.g., Queen Anne Hill), people (e.g., a protest march downtown Seattle), aircraft (e.g., planes on approach to or taxing at Boeing Field Airport), boats (e.g., cargo ships within Puget Sound and Elliot Bay), and weather (e.g., clouds at convergence zone near Everett, Washington) at spatial resolutions of approximately one to three meters.

Infrared imagery is light having a wavelength of approximately 700 nm to 1 mm. Near-infrared imagery is light having a wavelength of approximately 0.75-1.4 micrometers. The infrared imagery can be used for night vision, thermal imaging, hyperspectral imaging, object or device tracking, meteorology, climatology, astronomy, and other similar functions. For example, infrared imagery of the third imaging unit 104 can includes scenes of Earth experiencing nighttime (e.g., when the satellite 500 is on a side of the Earth opposite the Sun). Alternatively, infrared imagery of the third imaging unit 104 can include scenes of Earth experiencing cloud coverage. In certain embodiments, the infrared imagery and visible imagery are captured simultaneously by the third imaging unit 104 using a beam splitter. In other embodiments, the third imaging unit 104 is configured to capture infrared imagery of the field of view 408 that overlaps a particular other field of view (e.g., field of view 404) having visible imagery captured or vice versa to enable combination infrared and visible imagery capture.

In one embodiment, the at least one third imaging unit configured to capture and process imagery of a movable field of view that is smaller than the first field of view includes, but is not limited to, at least one third imaging unit linked to the hub processing unit and configured to capture and process imagery of a movable field of view that is smaller than the first field of view at 1310. For example, the at least one third imaging unit 104 is linked to the hub processing unit 502 via an image processor 504N and is configured to capture and process imagery of a movable field of view 408 that is smaller than the first field of view 406. The hub processor 502 can provide instructions to the image processor 504N of the third imaging unit 104 to capture imagery of particular objects, events, activities, or the like. Alternatively, hub processor 502 can provide instructions to the image processor 504N of the third imaging unit 104 to capture imagery associated with a particular GPS coordinate or geographic location. Hub processor 502 can also provide instructions or requests based on image content detected using one or more of the other imaging units (e.g., first imaging unit 202, second imaging unit 204, fourth imaging unit 210, or third imaging unit 104N). Hub processor 502 can also receive and perform second order processing on image content or data provided by an image processor 504N associated with the third imaging unit 104.

As an example, hub processor 502 can request of the plurality of third imaging units 104 and 104N a scan of the field of view 400 for a missing vessel. The third imaging units 104 and 104N can execute systematic scans of the field of view 400, such as each scanning a particular area repetitively using the fields of view 408. Image processors 504N and 504N1 can process the image data obtained from the image sensors 508N of each of the third imaging units 104 in parallel in an attempt to identify an object or feature indicative of the missing vessel. The hub processor 502 can receive the GPS coordinates of the missing vessel along with select imagery of the missing vessel from the image processor 504N associated with the third imaging unit 104N that identified the missing vessel.

In one embodiment, the at least one third imaging unit configured to capture and process imagery of a movable field of view that is smaller than the first field of view includes, but is not limited to, at least one third imaging unit under control of the hub processing unit and configured to capture and process imagery of a movable field of view that is smaller than the first field of view at 1312. For example, the at least one third imaging unit 104 is under control of the hub processing unit 502 and is configured to capture and process imagery of a movable field of view 408 that is smaller than the first field of view 406. The hub processing unit 502 can provide actuation signals directly or indirectly to the gimbal 110 of the third imaging unit 104 to control alignment of the field of view 408. Alternatively, the hub processing unit 502 can provide varying levels of instruction to a control unit of the gimbal 110 (or an independent actuation control unit) to direct alignment of the field of view 408. The various levels of instruction include, for example, a coordinate, an area, or a pattern, which can be reduced by the control unit of the gimbal 110 to precise parameter values for directing one or more motors of the gimbal 110. Control of actuation of the third imaging unit 104 can also be provided by a processor physically independent of the third imaging unit 104 and the hub processor 502 or by the image processor 504N.

In certain embodiments, a movement coordination control unit is provided for concerted control of a plurality of the third imaging unit 104 and/or the third imaging unit 104N. For example, the movement coordination control unit can determine the actuation position of each of the third imaging units 104 and 104N to determine whether actuation of one particular third imaging unit 104 would result in crashing with respect to an adjacent third imaging unit 104 (e.g., adjacent imaging units 104 and 104N pointed at each other resulting in lens crashing). In an event of lens crashing appears likely, the movement coordination control unit can identify another of the third imaging units 104N available for actuation. The movement coordination control unit can therefore avoid physical conflict between the third imaging units 104 and 104N thereby enabling a smaller footprint of the imaging system 100. Another operation of the movement coordination control unit can include movement balancing among the plurality of third imaging units 104 and 104N in an effort to cancel out motion as much as possible (e.g., movement to left and movement to right provided by select third imaging units 104 and 104N to cancel motion forces).

In one embodiment, the at least one third imaging unit configured to capture and process imagery of a movable field of view that is smaller than the first field of view includes, but is not limited to, at least one third imaging unit configured to capture and perform first order processing of imagery of a movable field of view that is smaller than the first field of view prior to communication of at least some of the imagery to the hub processing unit at 1314. For example, the at least one third imaging unit 104 is configured to capture and perform using the image processor 504N first order processing of imagery of a movable field of view 408 that is smaller than the first field of view 406 prior to communication of at least some of the imagery to the hub processing unit 502. The third imaging unit 104 captures ultra high resolution imagery of a small spot field of view 408. The ultra-high resolution imagery can be video on the order of 20 megapixels per frame and 20 frames per second, or more. However, not all of the ultra-high resolution imagery of the spot field of view 408 may be needed or required. Accordingly, the image processor 504N of the third imaging unit 104 can perform first order reduction operations on the imagery prior to communication to the hub processor 502. Reduction operations can include those such as pixel decimation, resolution reduction, cropping, static or background object removal, un-selected area removal, unchanged area removal, previously transmitted area removal, parallel request consolidation, or the like.

For example, in an instance where a high-zoom area is requested within the overall spot view 408 (e.g., the lower right portion of the spot view 408 comprising only a few percentage of the overall area of the spot view 408), pixel cropping can be performed by the image processor 504N to remove all pixel data outside the area requested. Pixel decimation can be avoided within the remaining high-zoom area requested to preserve as much pixel data as possible. Additionally, the image processor 504N can perform pixel decimation involving uninteresting objects within the high-zoom area requested, such as removing background or non-moving objects. Additionally, image processor 504N can remove pixels that are not requested or that correspond to pixel data previously transmitted and/or that is unchanged since a previous transmission. For example, a close-up image of a highway and moving vehicles can involve the image processor 504N of the third imaging unit 104 removing pixel data associated with the highway that was previously communicated in an earlier frame, is unchanged, and that does not contain any moving vehicles (e.g., all road surface pixel data).

In certain embodiments, the image processor 504N performs machine vision or artificial intelligence operations on the image data of the field of view 408. For instance, the image processor 504N can perform image or object or feature or pattern recognition with respect to the image data of the field of view 408. Upon detecting a particular aspect, the image processor 504N can output binary data, text data, program executables, or a parameter. An example of this in operation includes the image processor 504N detecting a presence of a whale breach within the field of view 408. Output of the image processor 504N may include GPS coordinates and a count increment, which can be used by environmentalists and government agencies to track whale migration and population, without necessarily requiring transmission of any image data.

In one embodiment, the at least one third imaging unit configured to capture and process imagery of a movable field of view that is smaller than the first field of view includes, but is not limited to, at least one third imaging unit configured to capture and process imagery of a movable field of view that is smaller than the first field of view, the movable field of view being directable across any portion of the first field of view or the second field of view at 1316. For example, the at least one third imaging unit 104 is configured to capture and process imagery of a movable field of view 408 that is smaller than the first field of view 406, the movable field of view 408 being directable across any portion of the first field of view 406, the second field of view 404, or the fourth field of view 402. The third imaging unit 104 is substantially unconstrained (e.g., +/−70 degree×360 degrees articulation envelop) and is directable on an as needed basis to move and align the field of view 408 where requested and/or needed. The field of view 408 offers enhanced spatial resolution and acuity and can be used for increased discrimination of areas, objects, features, events, activities, or the like.

For example, a user request for a global scene view can be satisfied by the first imaging unit 202 or the second imaging unit 204 or even the fourth imaging unit 210 without burdening the spot imaging unit 104. However, a user request for imagery associated with a particular building, geographical feature, or address can be satisfied by the spot field of view 408 and the third imaging unit 104 given the ultra high spatial resolution and acuity offered by the third imaging unit 104. As another example, a user request for a particular cityscape can be satisfied by the field of view 404 and the second imaging unit 204 at one moment, but not possible over time due to the orbital path of the satellite 500. In this instance, spot field of view 408 can be controlled to track the particular cityscape as it moves beyond the field of view 404. An additional operation of the spot field of view 408 and the third imaging unit 104 is to enhance the resolution of the image data obtained using another imaging unit (e.g., the first imaging unit 202). For instance, parking lots can be enhanced in image data obtained using the first imaging unit 202 using image data obtained using the third imaging unit 104, to enable vehicle counting and determining shopping trends for example.

In one embodiment, the at least one third imaging unit configured to capture and process imagery of a movable field of view that is smaller than the first field of view includes, but is not limited to, at least one third imaging unit configured to capture and process imagery of a movable field of view that is smaller than the first field of view, the movable field of view being directable outside of the first field of view and the second field of view at 1318. For example, the at least one third imaging unit 104 is configured to capture and process imagery of a movable field of view 408 that is smaller than the first field of view 406, the movable field of view 408 being directable outside of the first field of view 406 and the second field of view 404. As referenced above, spot field of view 408 is substantially unconstrained and can travel within a substantial entirety of the field of view 400 (e.g., plus or minus 70 degrees×360 degrees of motion). Imagery captured by the fourth imaging unit 210 associated with the fisheye field of view 402 can be relatively low in spatial resolution as compared to that captured by the third imaging unit 104 associated with the field of view 408. Accordingly, fisheye field of view 402 is useful for providing overall big picture scene information, context, and motion detection, but may not enable the acuity, spatial resolution, and zoom levels required. Accordingly, spot field of view 408 can be used to supplement the fisheye field of view 402 when additional acuity or resolution is needed or requested.

As an example, infrared image content captured by the fourth imaging unit 210 covering the fisheye field of view 402 can indicate severe temperature gradations over a particular geographical area. The third imaging unit 104 can be directed to the particular geographical area to sample video content associated with the spot field of view 408. Image processor 504N can obtain the video content and process the video content using feature, object, pattern, or image recognition to determine the source and/or effects of the temperature gradation (e.g., a wildfire, a hurricane, an explosion, etc.). Image processor 504N can then return a binary or textual indication of the cause and/or reduced imagery associated with the cause.

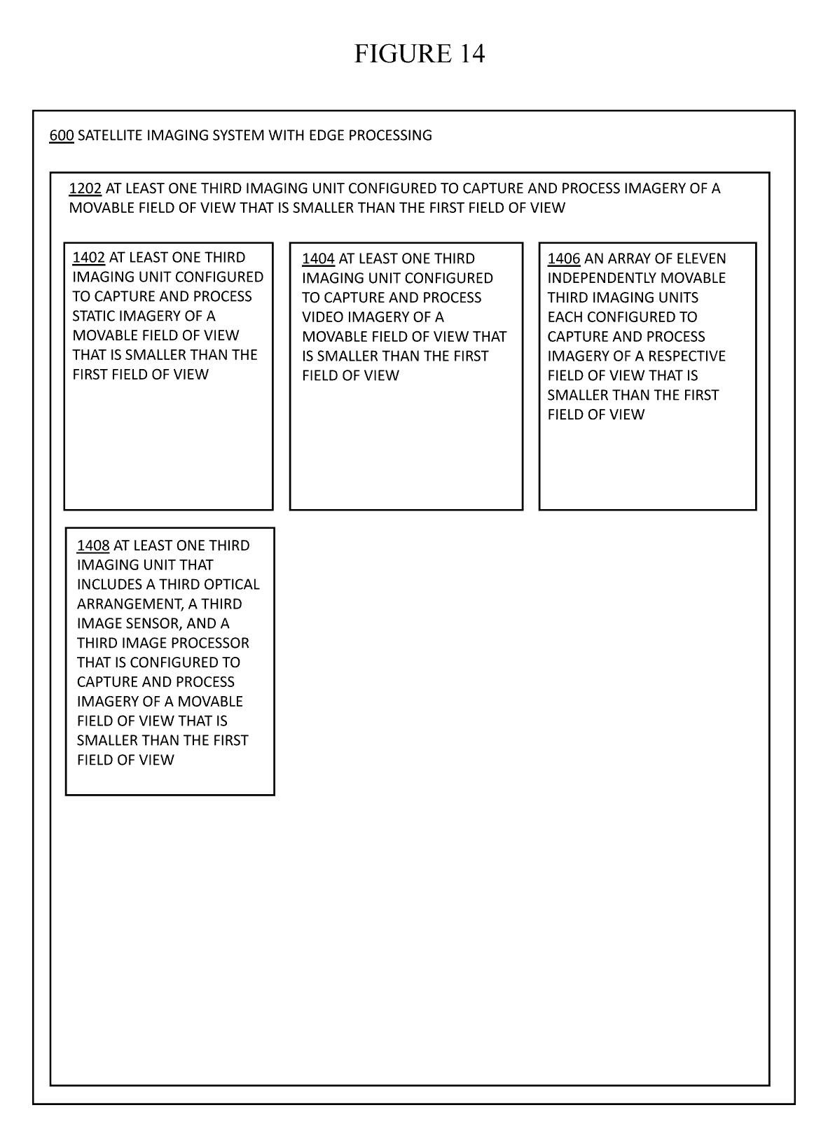

FIG. 14 is a component diagram of a satellite imaging system with edge processing, in accordance with an embodiment.

In one embodiment, the at least one third imaging unit configured to capture and process imagery of a movable field of view that is smaller than the first field of view includes, but is not limited to, at least one third imaging unit configured to capture and process static imagery of a movable field of view that is smaller than the first field of view at 1402. For example, the at least one third imaging unit 104 is configured to capture and process static imagery of a movable field of view 408 that is smaller than the first field of view 406. The at least one third imaging unit 104 can capture static imagery in response to a program command, a user request, or a hub processor 502 request, such as in response to one or more objects, features, events, activities, or the like detected within one or more other fields of view (e.g., field of view 402, 404, or 406). Static imagery can include a still visible and/or infrared or near-infrared images. Additionally, static imagery can include a collection of still visible and/or infrared or near-infrared images. For example, image processor 504 can detect one or more instances of crop drought or infestation using video imagery captured by the first imaging unit 202 and corresponding to the field of view 406. Hub processor 502 can then instruct the third imaging unit 104 to steer to and/or align the field of view 408 on the area of crop drought or infestation. Third imaging unit 104 can capture one or more still images of the crop drought or infestation and the image processor 504N can perform first order processing on the one or more still images and/or determine an assessment of the damage. As another example, the at least one third imaging unit 104 can capture one or more still images of a city or other structure over the course of the satellite 500 orbit. The one or more still images will have different vantage points of the city or other structure and can be used to recreate a high spatial resolution three-dimensional image of the city or other structure.

In one embodiment, the at least one third imaging unit configured to capture and process imagery of a movable field of view that is smaller than the first field of view includes, but is not limited to, at least one third imaging unit configured to capture and process video imagery of a movable field of view that is smaller than the first field of view at 1404. For example, the at least one third imaging unit 104 is configured to capture and process video imagery of a movable field of view 408 that is smaller than the first field of view 406. The third imaging unit 104 can capture video at approximately one to sixty frames per second or approximately twenty frames per second. The third imaging unit 104 can capture video of a fixed field of view 408 or can capture video of a moving field of view 408 using one or more pivots, joints, or other articulations such as gimbal 110. The moving field of view 408 enables tracking of moving content and also enables dwelling on fixed content, albeit at different vantage points due to orbital transgression of the satellite 500.

In one embodiment, the at least one third imaging unit configured to capture and process imagery of a movable field of view that is smaller than the first field of view includes, but is not limited to, an array of eleven independently movable third imaging units each configured to capture and process imagery of a respective field of view that is smaller than the first field of view at 1406. For example, the array of eleven independently movable third imaging units 104 and 104N are each configured to capture and process imagery of a respective field of view that is smaller than the first field of view 406. The array of eleven independently movable third imaging units 104 and 104N can be arranged in a 3×3 grid of active third imaging units 104 and 104N1-N8 with two additional non-active backup third imaging units 104N9 and 104N10 flanking the global imaging array 102. Each of the independently movable third imaging units 104 and 104N1-N10 can pivot with a range of motion of approximately 360 degrees in an X plane and approximately 180 degrees in a Y plane. In one particular embodiment, the Y plane movement is constrained to approximately +/−70 degrees. Spacing of the independently movable third imaging units 104 and 104N1-N10 can be such that the range of motion envelopes do not overlap or partially overlap. Partial overlap of the motion envelopes enables a smaller footprint of the imaging system 500 but has the potential for adjacent ones of the movable third imaging units 104 and 104N1-N10 to crash or physically touch. Proximity sensing at the third imaging units 104 and 104N1-N10 or coordinated motion control of each of the independently movable third imaging units 104 and 104N1-N10 (e.g., using proximity sensors or a reservation or occupation table) can be implemented to prevent crashing. Although reference is made to eleven of the third imaging units 104 and 104N1-N10, in practice other amounts are possible. For instance, the third imaging units 104 and 104N can range from zero to tens or even hundreds in amount. Additionally, the third imaging units 104 and 104N1-N10 can be arranged in a line, circle, square, rectangle, triangle, or other regular or irregular pattern. The third imaging units 104 and 104N1-N10 can also be arranged on opposing faces (e.g., to capture images of earth and outerspace) or in cube, pyramid, sphere, or other regular or irregular two or three-dimensional form.

In one embodiment, the at least one third imaging unit configured to capture and process imagery of a movable field of view that is smaller than the first field of view includes, but is not limited to, at least one third imaging unit that includes a third optical arrangement, a third image sensor, and a third image processor that is configured to capture and process imagery of a movable field of view that is smaller than the first field of view at 1408. For example, the at least one third imaging unit 104 includes a third optical arrangement 516, a third image sensor 508N, and a third image processor 504N that is configured to capture and process imagery of a movable field of view 408 that is smaller than the first field of view 406. The third image processor 504N can process raw ultra-high resolution imagery associated with the field of view 408 in real-time or near-real-time independent of image data associated with one or more of the other fields of view (e.g., fields of view 402, 404, and 406). Processing operations can include machine vision, artificial intelligence, resolution reduction, image recognition, object recognition, feature recognition, activity recognition, event recognition, text recognition, pixel decimation, pixel cropping, parallel request reductions, background subtraction, unchanged or previously communicated image decimation, or the like. Output of the image processor 504 can include image data, binary data, alphanumeric text data, parameter values, control signals, function calls, application initiation, or other data or function.

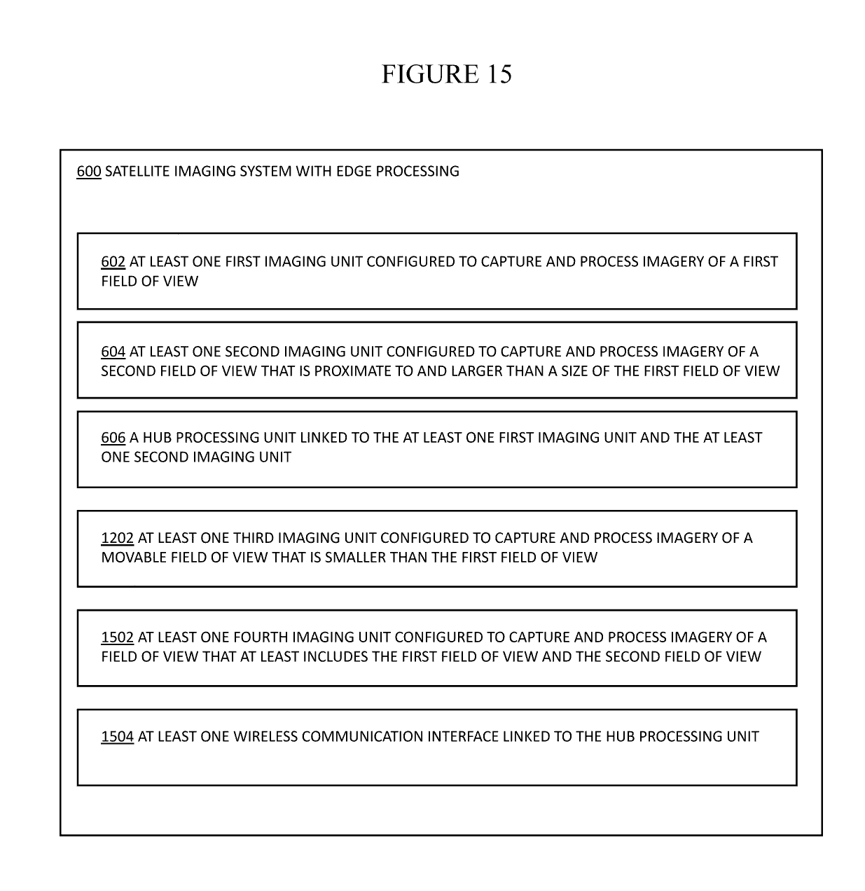

FIG. 15 is a component diagram of a satellite imaging system with edge processing, in accordance with an embodiment. In one embodiment, a satellite imaging system with edge processing 600 includes, but is not limited to, at least one first imaging unit configured to capture and process imagery of a first field of view at 602; at least one second imaging unit configured to capture and process imagery of a second field of view that is proximate to and larger than a size of the first field of view at 604; at least one third imaging unit configured to capture and process imagery of a movable field of view that is smaller than the first field of view at 1202; at least one fourth imaging unit configured to capture and process imagery of a field of view that at least includes the first field of view and the second field of view at 1502; a hub processing unit linked to the at least one first imaging unit, the at least one second imaging unit, the at least one third imaging unit and the at least one fourth imaging unit at 606; and at least one wireless communication interface linked to the hub processing unit at 1504. For example, a satellite imaging system 100 with edge processing includes, but is not limited to, at least one first imaging unit 202 configured to capture and process imagery of a first field of view 406; at least one second imaging unit 204 configured to capture and process imagery of a second field of view 404 that is proximate to and larger than a size of the first field of view 406; at least one third imaging unit 104 configured to capture and process imagery of a movable field of view 408 that is smaller than the first field of view 406; at least one fourth imaging unit 210 configured to capture and process imagery of a field of view 402 that at least includes the first field of view 406 and the second field of view 404; a hub processing unit 502 linked to the at least one first imaging unit 202, the at least one second imaging unit 204, the at least one third imaging unit 104, and the at least one fourth imaging unit 210; and at least one wireless communication interface 506 linked to the hub processing unit 502.

The fisheye imaging unit 210 provides a super wide field of view for an overall scene view 402. There can be one, two, or more of the fisheye imaging unit 210 per satellite 500. The fisheye imaging unit includes an optical arrangement 516 that includes a lens, image sensor 508N (infrared and/or visible), and an image processor 504N, which may be dedicated or part of a pool of available image processors (FIG. 5). The lens can comprise a ½ Format C-Mount Fisheye Lens with a 1.4 mm focal length from EDMUND OPTICS. This particular lens has the following characteristics: focal length 1.4; maximum sensor format ½″, field of view for ½″ sensor 185×185 degrees; working distance of 100 mm-infinity; aperture f/1.4-f/16; maximum diameter 56.5 mm; length 52.2 mm; weight 140 g; mount C; type fixed focal length; and RoHS C. Other lenses of similar characteristics can be substituted for this particular example lens.

The field of view 402 can span approximately 180 degrees in diameter to provide an overall scene view of Earth from horizon to horizon and that overlaps spot field of view 408, inner field of view 406, and outer field of view 404. Spatial resolution can be approximately 25 meters to 100 meters from 400-700 km altitude (e.g., 50 meter spatial resolution). The field of view 402 therefore includes areas of Earth in front of, behind, above, and below the field of view 406 and the field of view 404 and includes areas overlapping with the field of view 406 and field of view 404. During an orbital path of the satellite 500, therefore, portions of Earth will first appear in the fisheye field of view 402 before moving through the outer field of view 404 and the inner field of view 406. Likewise, portions of the Earth will leave through the fisheye field of view 402 of the satellite 500. The fourth imaging unit 210 can therefore capture video, still, and/or infrared imagery that can be used for change detection, movement detection, object detection, event or activity identification, or for overall scene context. Content of the fisheye field of view 402 can trigger actuation of the third imaging unit 104 or initiate machine vision or artificial intelligence processes of one or more of the image processors 504N associated with one or more of the first imaging unit 202, second imaging unit 204, and/or third imaging unit 104; or of the hub processor 502.

For example, the fourth imaging unit 210 can detect ocean discoloration present in imagery associated with the fisheye field of view 402, which may be caused by oil spillage or leakage, organisms, or the like. The detection of the discoloration can be performed locally using the image processor 504N associated with the fourth imaging unit 210 and can include comparisons with historical image data obtained by satellite 500 or another satellite 500N. Spot imaging units 104 can be called to align with the ocean discoloration and can collect ultra-high resolution video and infrared imagery. Image processors 504N associated with the spot imaging units 104 can perform image recognition processes on the imagery to further determine a cause and/or source of the ocean discoloration. Additionally, image processors 504N associated with the first imaging unit 202 and the second imaging unit 204 can have processes initiated associated with spillage detection and recognition in advance of the ocean discoloration coming into the field of view 406 and 404.

FIG. 16 is a perspective view of a satellite constellation 1600 of an array of satellites that each include a satellite imaging system, in accordance with an embodiment. For example, satellite constellation 1600 includes an array of satellites 500 and 500N that each include a satellite imaging system 100 to provide substantially constant real-time “fly-over” video of Earth.

Each satellite 500 and 500N can be equipped with the satellite imaging system 100 to continuously collect and process approximately 400 Gbps or more of image data. The satellite constellation 1600 in its entirety can therefore collect and process approximately 30 Tbps or more of image data (e.g., approximately 20 frames per second using image sensors of approximately 20 megapixels). Processing power for each of the satellites 500 and 500N can be approximately 20 teraflops and processing power for the satellite constellation 1600 can be approximately 2 petaflops.

Satellite constellation 1600 can include anywhere from 1 to approximately 1400 or more satellites 500 and 500N. For instance, the satellites 500 and 500N can range in number from 84 to 252 with spares of approximately 2 to 7.

Satellite constellation 1600 can be at anywhere between approximately 55 to 65 degrees inclination and at anywhere between approximately 400-700 km altitude. One specific inclination range is between 60 to 65 degrees relative to the equator. A dog-leg maneuver with NEW GLENN can be used for higher angles of inclination (e.g., 65 degrees). A more specific altitude range can include 550 km to 600 km above Earth.

Satellite constellation 1600 can include anywhere from approximately 1 to 33 planes with anywhere from one to sixty satellites 500 and 500N per plane. Satellite constellation 1600 can include a sufficient number of satellites to provide substantially complete temporal coverage (e.g., 70 percent of the time or more) for elevation angles of 10 degrees, 20 degrees, and 30 degrees above the horizon on positions of Earth between approximately +/−75 degrees N/S latitudes. In one embodiment, the satellite constellation 1600 includes at least two satellites 500 and 500N above the horizon (e.g., above 15 degrees elevation) substantially all times (e.g., 70 percent of the time or more) at positions on Earth between approximately +/−70 degrees North and South latitudes. Additionally, the satellite constellation 1600 can include at least one satellite 500N above approximately 30 degrees elevation at substantially all times (e.g., 70 percent of the time or more), which can limit spot view imaging unit 210 slew amounts to less than approximately 45-50 degrees from nadir. Further, the satellite constellation 1600 can include at least one satellite 500N above approximately 40 degrees elevation at substantially all times (e.g., 70 percent of the time or more), which can improve live 3D video capabilities and limit spot view imaging unit 210 slew amounts to less than approximately 30 degrees from nadir.

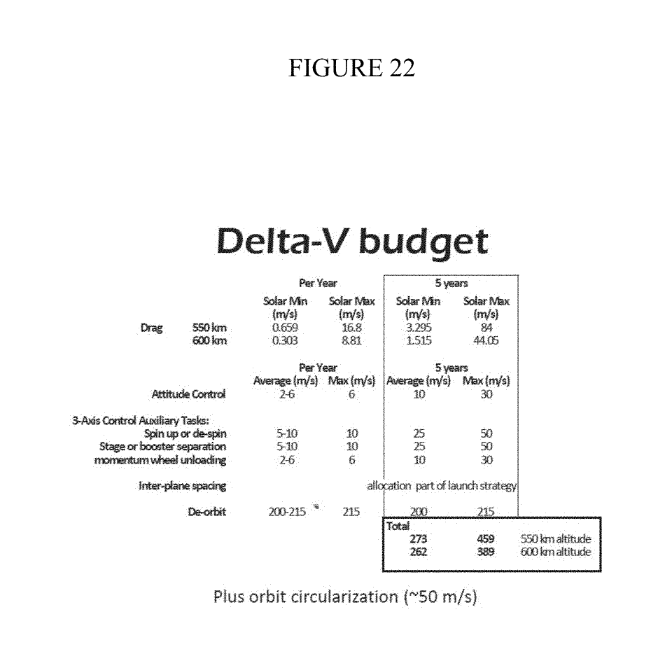

Satellite constellation 1600 can be launched using one or more of the following options: FALCON 9 (around 40 satellites per launch); NEW GLENN (around 66 satellites per launch); ARIANE 6; SOYUZ; or the like. The satellite constellation 1600 can be launched in large clusters into a Hohmann transfer orbit followed by sequenced orbit raising. One possible Delta-V budget that can be used as part of the launch strategy is included in FIG. 22.

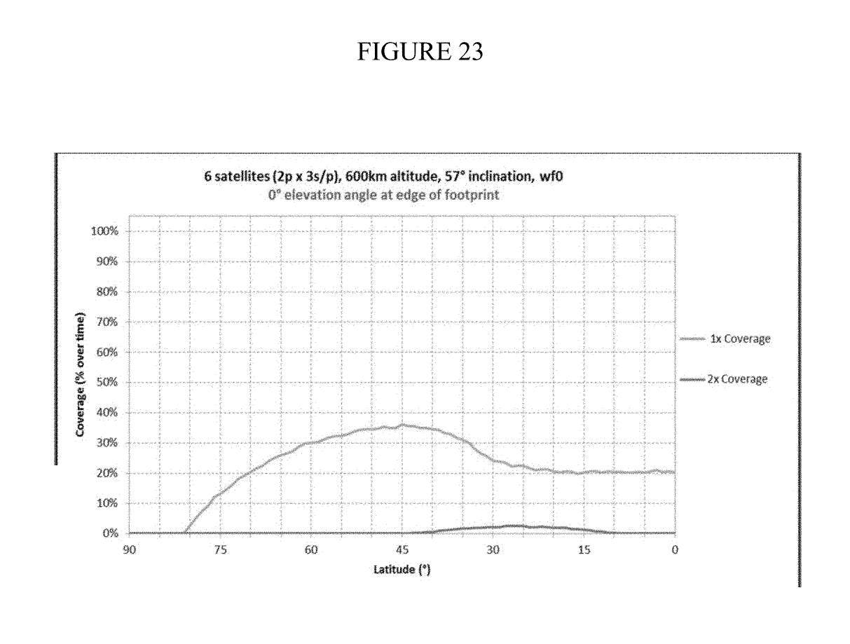

A number of specific satellite constellation 1600 configurations are possible. One particular configuration includes 6 satellites 500 and 500N1-N5 within 2 planes of 3 satellites/plane at 600 km altitude and 57 degrees inclination and a Walker Factor of 0. The amount of coverage of this satellite configuration is provided in FIG. 23.

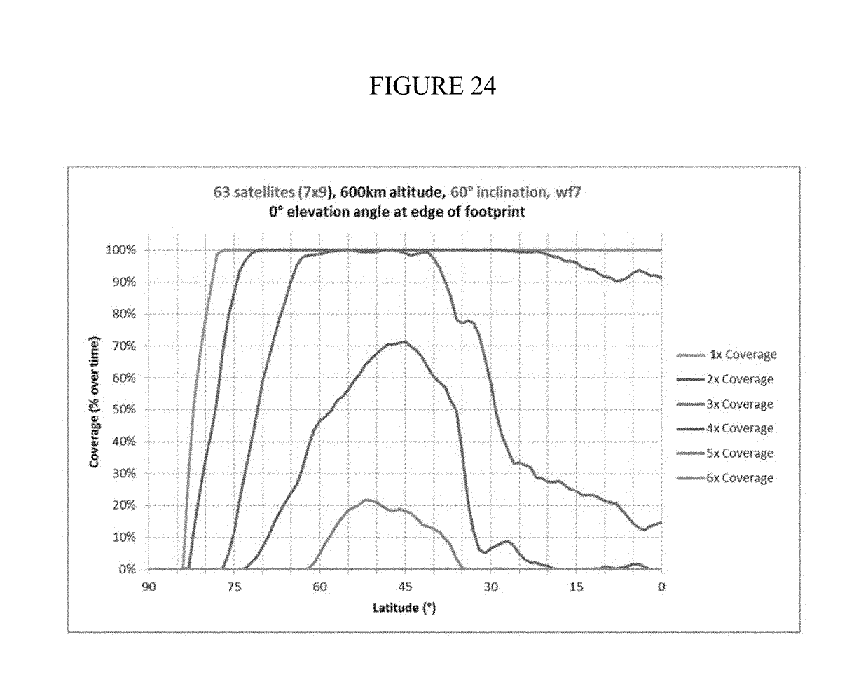

Another particular configuration includes 63 satellites 500 and 500N1-N62 within 7 planes of 9 satellites/plane at 600 km altitude and 60 degrees inclination and a Walker Factor of 7. The amount of coverage of this satellite configuration is provided in FIG. 24.

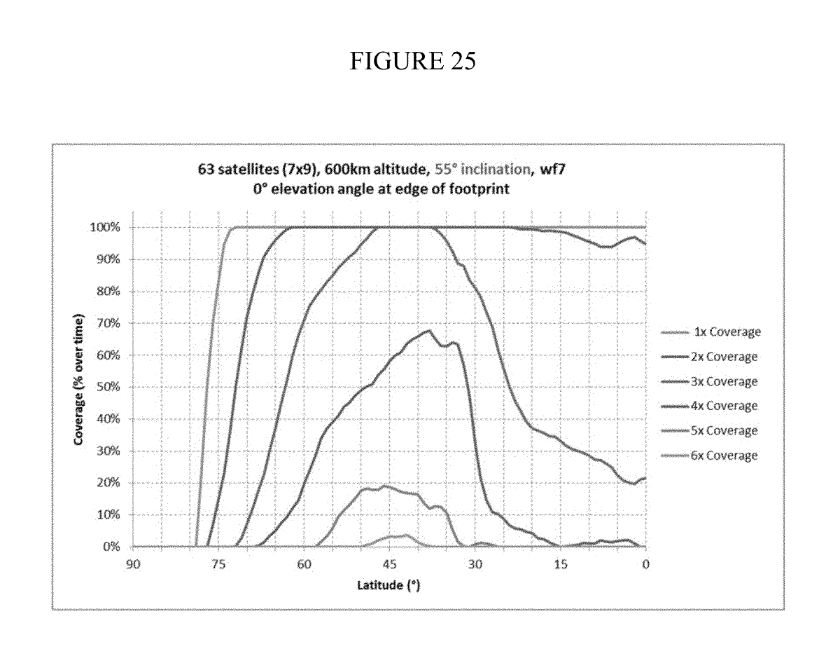

Another particular configuration includes 63 satellites 500 and 500N1-N62 within 7 planes of 9 satellites/plane at 600 km altitude and 55 degrees inclination and a Walker Factor of 7. The amount of coverage of this satellite configuration is provided in FIG. 25.

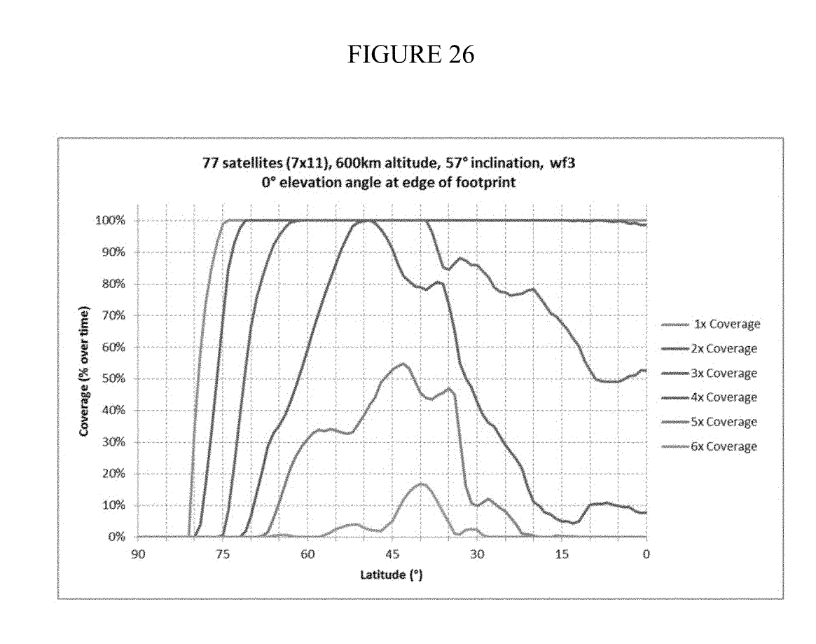

Another particular configuration includes 77 satellites 500 and 500N1-N76 within 7 planes of 11 satellites/plane at 600 km altitude and 57 degrees inclination and a Walker Factor of 3. Approximately 7 spare satellites may be included. The amount of coverage of this satellite configuration is provided in FIG. 26.

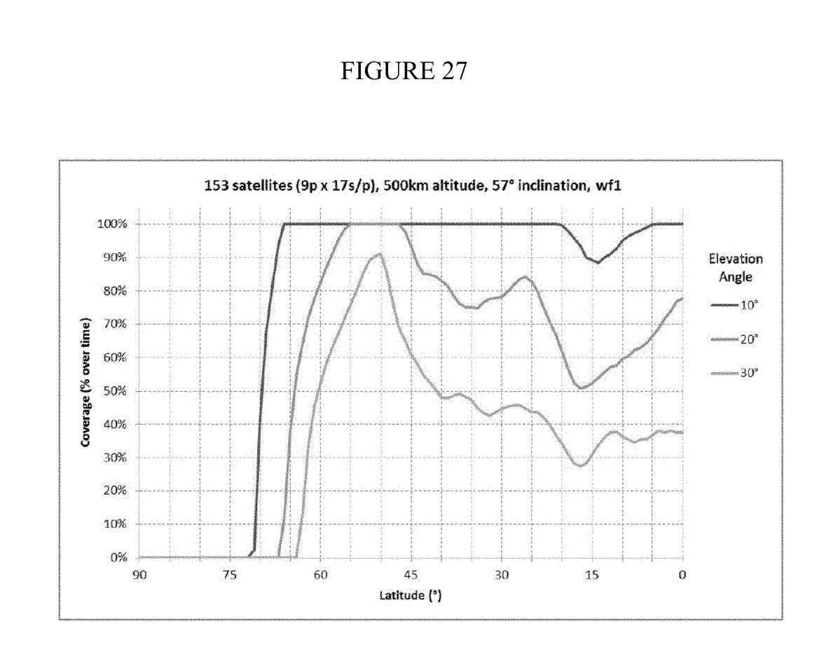

Another particular configuration includes 153 satellites 500 and 500N1-N152 within 9 planes of 17 satellites/plane at 500 km altitude and 57 degrees inclination. The amount of coverage of this satellite configuration is provided in FIG. 27.

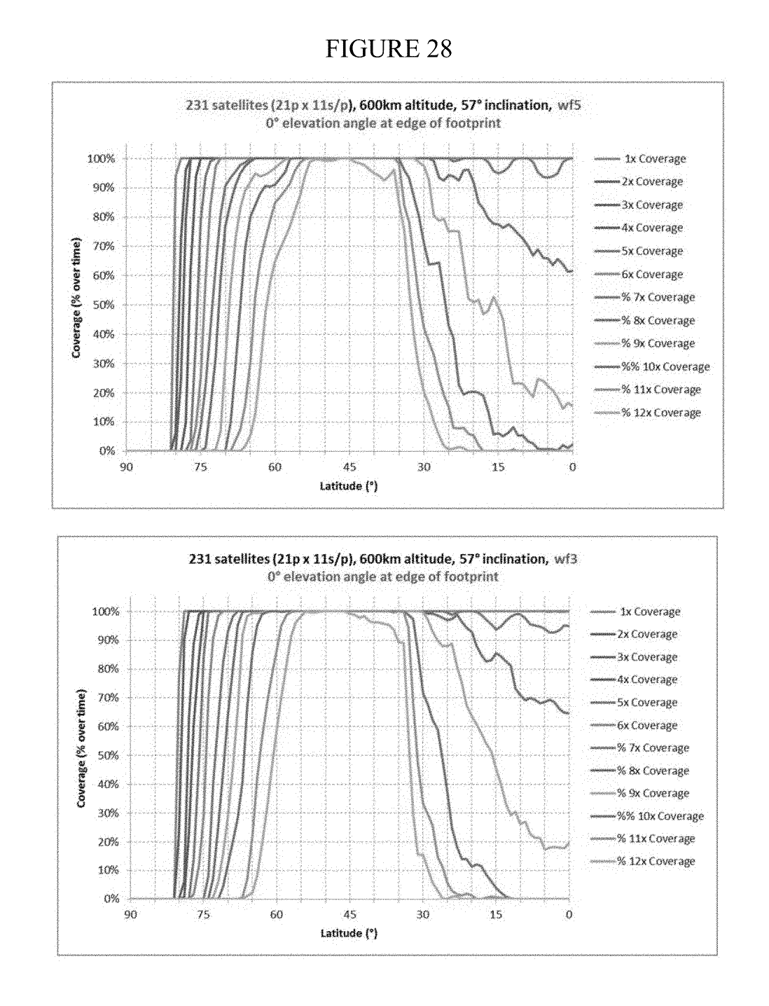

Another particular configuration includes 231 satellites 500 and 500N1-N230 within 21 planes of 11 satellites/plane at 600 km altitude and 57 degrees inclination. Approximately 21 spare satellites can be included and Walker Factors can range from 3 to 5. The amount of coverage of these satellite configurations is provided in FIGS. 28-31.

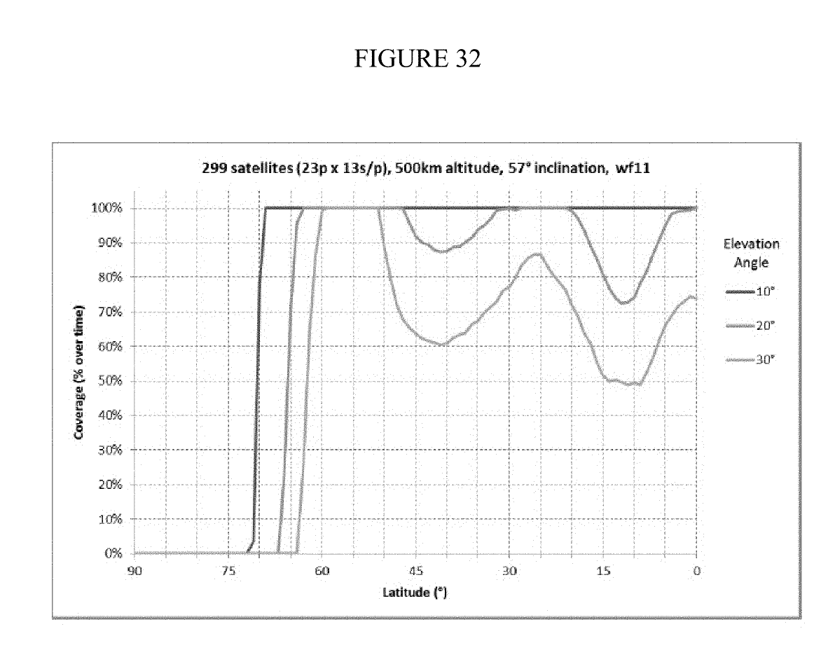

Another particular configuration includes 299 satellites 500 and 500N1-N298 within 23 planes of 13 satellites/plane at 500 km altitude and 57 degrees inclination. The amount of coverage of this satellite configuration is provided in FIG. 32.

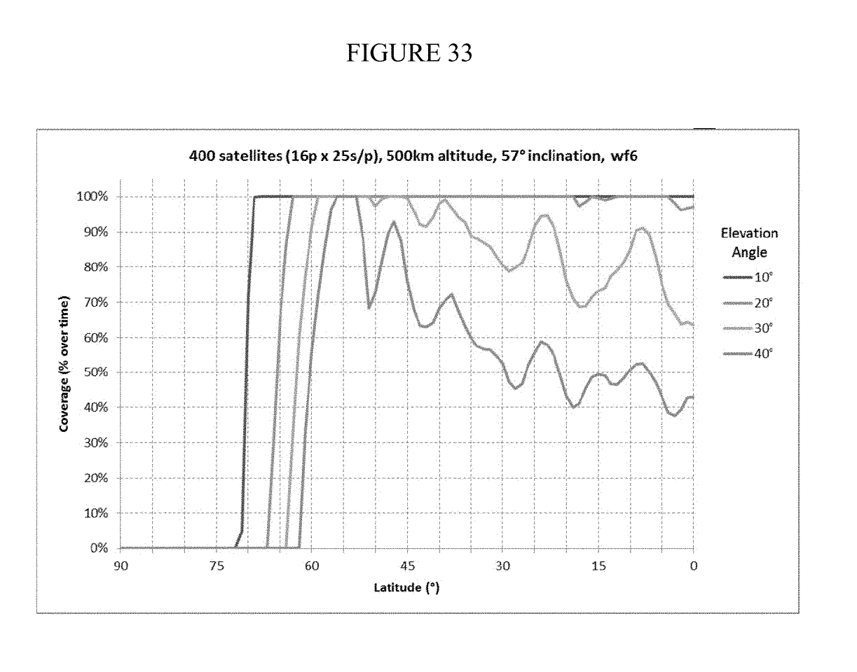

Another particular configuration includes 400 satellites 500 and 500N1-N399 within 16 planes of 25 satellites/plane at 500 km altitude and 57 degrees inclination. The amount of coverage of this satellite configuration is provided in FIG. 33.

The satellite constellation orbital altitude can range from low to medium to high altitudes, such as between 160 km to approximately 2000 km or more. Orbits can be circular or elliptical or the like.

FIG. 17 is a diagram of a communications system 1700 involving the satellite constellation 1600, in accordance with an embodiment. In one embodiment, communications system 1700 includes a space segment 1702, a ground segment 1704, and a user segment 1712. Space segment 1702 includes the satellite constellation 1600 comprised of satellites 500 and 500N. The ground segment 1704 includes TT&C 1706, gateway 1708, and an operation center 1710. The user segment 1712 includes user equipment 1714.

The satellites 500 and 500N can communicate directly between each other via an inter-satellite link (ISL). The TT&C 1706, the gateway 1708, and the user equipment 1714 can each communicate with the satellites 500 and 500N. The TT&C 1706, the gateway 1708, the operations center 1710, and the user equipment 1714 can also communicate with one another via a private and/or public network. The TT&C 1706 provides an interface to telemetry data and commanding. The gateway 1708 provides an interface between satellites 500 and 500N and the ground segment 1704 and the user segment 1712. The operations center 1710 provides satellite, network, mission, and/or business operation functions. User equipment 1714 may be part of the user segment 1712 or the ground segment 1704 and can include equipment for accessing satellite services (e.g., tablet computer, smartphone, wearable device, virtual reality goggles, etc.). The satellites 500 and 500N provide communication, imaging capabilities, on-board processing, on-board switching, sufficient power to meet mission objectives, and/or other features and/or applications. In certain embodiments, any of the TT&C 1706, gateway 1708, operation center 1710, and user equipment 1714 can be consolidated in whole or in part into integrated systems. Additionally, any of the specific responsibilities or subsystems of the TT&C 1706, gateway 1708, operation center 1710, and user equipment 1714 can be distributed or separated into disparate systems.

TT&C 1706 (Tracking, Telemetry & Control) includes the following responsibilities: ground to satellite secured communications, carrier tracking, command reception and detection, telemetry modulation and transmission, ranging, receive commands from command and data handling subsystems, provide health and status information, perform mission sequence operations, and the like. Interfaces of the TT&C 1706 include one or more of a satellite operations system, an altitude determination and control, command and data handling, electrical power, propulsion, thermal—structural, payload, or other related interfaces.

Gateway 1708 can include one or more of the following responsibilities: receive and transmit communications radio frequency signals to/from satellites 500 and 500N, provide an interconnect between the satellite segment 1702 and the ground segment 1704, provide ground processing of received data before transmitting back to the satellite 500 and to user equipment 1714, and other related responsibilities. Subsystems and components of the gateway 1708 can include one or more of a satellite antenna, receive RF equipment, transmit RF equipment, station control center, internet/private network equipment, COMSEC/network security, TT&C equipment, facility infrastructure, data processing and control capabilities, and/or other related subsystems or components.

The operation center 1710 can include a data center, a satellite operation center, a network center, and/or a mission center. The data center can include a system infrastructure, servers, workstations, cloud services, or the like. The data center can include one or more of the following responsibilities: monitor system and servers, system performance management, configuration control and management, system utilization and account management, system software updates, service/application software updates, data integrity assurance, data access security management and control, data policy management, or related responsibility. The data center can include data storage, which can be centralized, distributed, cloud-based, or scalable. The data center can provide data retention and archivable for short, medium, or long term purposes. The data center can also include redundancy, load-balancing, real-time fail-over, data segmentation, data security, or other related features or functionality.

The satellite operation center can include one or more of the following responsibilities: verify and maintain satellite health, reconfigure and command satellites, detect and identify and resolve anomalies, perform launch and early orbit operations, perform deorbit operations, coordinate mission operations, coordinate the constellation 1600, or other related management operations with respect to launch and early orbit, commissioning, routine/normal operation, and/or disposal of satellites. Additional satellite operations include one or more of access availability to each satellite for telemetry, command, and control; integrated satellite management and control; data analysis such as historical and comparative analyses about subsystems within a satellite 500 and throughout the constellation 1600; storage of telemetry and anomaly data for each satellite 500; provide defined telemetry and status information; or related operations. Note that the satellite bus of satellite 500 can include subsystems including command and data handling, communications system, electrical power, propulsion, thermal control, altitude control, guidance navigation and control, or related subsystems.

The network operations center can include one or more of the following responsibilities with respect to the satellite and terrestrial network: network monitoring; problem or issue response and resolution; configuration management and control; network system performance and reporting; network and system utilization and accounting; network services management; security (e.g., firewall and instruction protection management, antivirus and malware scanning and remediation, threat analysis, policy management, etc.); failure analysis and resolution; or related operations.

The mission center can include one or more of the following responsibilities: oversight, management, decision making; reconciling and prioritizing payload demands with bus resources; provide linkage between business operations demands and capabilities and capacity; planning and allocating resources for mission; managing tasking and usage and service level performance; verifying and maintaining payload health; reconfiguring and commanding payload; determining optimal attitude control; or related operation. The mission center can include one or more of the following subsystems: payload management and control system; payload health monitoring system; satellite operations interface; service request/tasking interface; configuration management system; service level statistics and management; or related system.

Connectivity and communications support for satellites 500, TT&C 1706, gateway 1708, and operation center(s) 1710 can be provided by a network. The network can include space-based and terrestrial networks and can provide support for both mission and operations. The network can include multiple routes and providers and enable incremental growth for increased demand. Network security can include link encryption, access control, application security, behavioral analytics, intrusion detection and prevention, segmentation, or related security features. The network can further include disaster recovery, dynamic environment and route management, component selection, or other related features.

User equipment 1714 can include computers and interfaces, such as a mobile phone, smart phone, laptop computer, desktop computer, server, tablet computer, wearable device, or other device. User equipment 1714 can be connected to the ground segment via the Internet or private network.

In one particular embodiment, the satellites 500 and 500N are configured for inter-satellite links or communication. The satellite 500 can include two communication antennas with one pointing forward and the other pointing aft. One antenna can be dedicated to transmit operations and the other antenna can be dedicated to receive operations. Another satellite 500N in the same orbital plane can be a dedicated satellite-to-ground conduit and can be configured to receive and transmit communications to and from the satellite 500 and to and from the gateway 1708. Thus, in instances where a plurality of satellites 500 and 500N are within a single orbital plane, one or more satellites 500N can be a designated conduit and the other satellite 500 can transmit and receive communications to and from the gateway 1708 via the designated conduit satellite 500N. Communications can hop between satellites within an orbital plane until a dedicated conduit gateway satellite 500N is reached, which conduit gateway satellite 500N can route the communications to the gateway 1708 in the ground segment 1704. A constellation 1600 of satellites can include as many as approximately 30 to 60 dedicated conduit gateway satellites 500N. In certain embodiments, there can be cross-link communications between satellites 500 and 500N in different orbital planes. In other embodiments, there are no cross-links and inter-satellite links are confined to within a same orbital path. In this instance a flat and low mass holographic antenna can be used that does not require beam steering. In certain embodiments, the conduit gateway satellite 500N can communicate with the gateway 1708 upon passing over the gateway 1708. Space-to-ground communications can include use of Ka-band; Ku-band; Q/V-band; X-band; or the like and can enable approximately 200 Mbps of bandwidth with bursts of approximately two times this amount for a period of hours and enable average latency of less than approximately 100-250 milliseconds. Higher ultra-high capacity data links can be used to enable at least approximately 1-5 Gbps bandwidth.

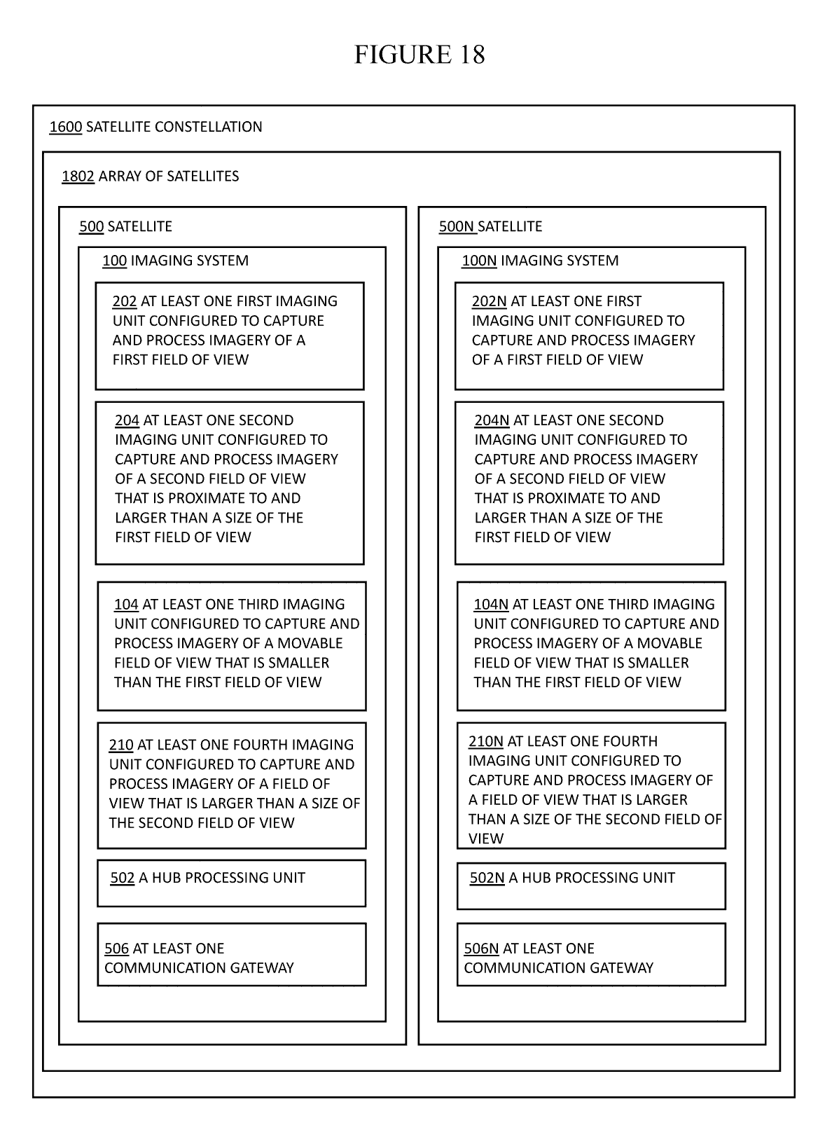

FIG. 18 is a component diagram of a satellite constellation 1600 of an array of satellites that each include a satellite imaging system, in accordance with an embodiment. In one embodiment, a satellite constellation 1600 includes, but is not limited to, an array 1802 of satellites 500 and 500N that each include a satellite imaging system 100 and 100N including at least: at least one first imaging unit 202 configured to capture and process imagery of a first field of view 406; at least one second imaging unit 204 configured to capture and process imagery of a second field of view 404 that is proximate to and that is larger than a size of the first field of view 406; at least one third imaging unit 104 configured to capture and process imagery of a movable field of view 408 that is smaller than the first field of view 406; at least one fourth imaging unit 210 configured to capture and process imagery of a field of view 402 that is larger than a size of the second field of view 404; a hub processing unit 502; and at least one communication gateway 506.

The satellites 500 and 500N of the satellite constellation 1600 are arranged in an orbital configuration that can be defined by: altitude, angle of inclination, number of planes, number of satellites per plane, number of spares, phase between adjacent planes, and other relevant factors. For example, one satellite constellation 1600 configuration can include 400 satellites 500 and 500N1-N399 within 16 planes at 57 degrees of inclination with 25 satellites per plane at 500 km altitude. Other configurations are possible and have been discussed and illustrated herein.

Each of the satellites 500 and 500N of the satellite constellation 1600 include an array of imaging units (e.g., imaging units 202, 204, 104, and/or 210) that each include optical arrangements and image sensors (FIG. 5) for capturing high resolution imagery associated with field of view 400. Image processors 500 and 504N (FIG. 5) are configured to perform parallel image processing operations on captured imagery associated with the array of imaging units. Thus, each satellite 500 and 500N is configured to obtain high resolution imagery associated with a respective field of view 400, which field of view 400 is tiled into a plurality of fields of view (e.g., fields of view 402, 404, 406), which plurality of fields of view are tiled into subfields thereof (FIG. 4). The satellite constellation 1600 can therefore be configured to capture and process high resolution fly-over video imagery of substantially all portions of Earth in real-time using on-board parallel image processing of high resolution imagery associated with tens, hundreds, or even thousands of tiles of fields and subfields of view. Depending on the satellite constellation 1600 configuration implemented, there can be overlap in some fields of view 402, 404, 406, and subfields thereof between adjacent or proximate satellites 500 and 500N. For example, fisheye field of view 402 of satellite 500 can at least partially overlap with fisheye field of view 402 of adjacent satellite 500N. The satellite constellation 1600 and the constituent satellites 500 and 500N can work in concert to provide real-time video, still images, and/or infrared images of high resolution on an as-needed and as-requested basis for satellite-based applications (e.g., machine vision or artificial intelligence) and to user equipment 1714.

For example, sources of imagery can transition from one satellite 500 to another satellite 500N based on orbital path position and/or elevation above the horizon. For instance, a user device 1714 can output a video of a particular city over the course of a day, which video can be captured by a plurality of satellites 500 and 500N throughout the orbital progression. Beginning at an angle of elevation above the horizon of approximately 15 degrees, satellite 500 can function as the initial source of the video imagery of the city. As satellite 500 moves to approximately less than 15 degrees of the opposing horizon, the source of the video imagery can transition to satellite 500N which has risen or is positioned more than approximately 15 degrees of the horizon.

As another example, handoffs between sources of imagery can be made to track moving objects, events, activities, or features. For example, satellite 500 can serve as a source of imagery associated with a particular fast moving aircraft being tracked by a flight security application on-board at least one of the satellites 500 and 500N. As the aircraft moves within the field of view 400 of the satellite 500 and transitions to an edge of the field of view 400, the source of the imagery associated with the aircraft can transition to a second satellite 500N and its respective field of view 400. This type of transition can occur between satellites 500 and 500N within a same orbital plane or within adjacent orbital planes.

As another example, a source of imagery being output on user equipment 1714 can seamlessly jump from one satellite 500 to another satellite 500N based on requested information. For example, a user device 1714 can output imagery associated with a hurricane off the coast of Florida that is sourced from a satellite 500. In response to a user request for any shipping vessels that may be affected by the hurricane, satellite 500N1 can identify and detect shipping vessels within a specified distance of the hurricane and serve as the source of real-time video imagery of those vessels for output via the user equipment 1714. Another satellite 500N2 can additionally serve as the source of real-time imagery associated with flooding detected on coastal sections of Florida with on-board processing.

A further example includes a machine vision application that is hosted on one satellite 500. The machine vision application can perform real-time or near-real-time image data analysis and can obtain the imagery for processing from the satellite 500 as well as from another satellite 500N via inter-satellite communication links. For example, satellite 500 can host a machine vision application for identifying locations and durations of traffic congestion and capturing imagery associated with the same. Satellite 500 can perform these operations with respect to imagery obtained within its associated field of view 400, but can also perform these operations with respect to imagery obtained from another satellite 500N. Alternatively, machine vision applications can be distributed among one or more of the satellites 500 and 500N for the image recognition and first order processing to reduce communication bandwidth of imagery between satellites 500 and 500N.

The present disclosure may have additional embodiments, may be practiced without one or more of the details described for any particular described embodiment, or may have any detail described for one particular embodiment practiced with any other detail described for another embodiment. Furthermore, while certain embodiments have been illustrated and described, as noted above, many changes can be made without departing from the spirit and scope of the disclosure.

Use of the term N in the numbering of elements means an additional one or more instances of the particular element, which one or more instances may be identical in form or can include one or more variations therebetween. Use of “one or more” or “at least one” or “a” is intended to include one or a plurality of the element referenced. Reference to an element in singular form is not intended to mean only one of the element and does include instances where there are more than one of an element unless context dictates otherwise. Use of the term ‘and’ or ‘or’ is intended to mean ‘and/or’ unless context dictates otherwise.

1. A satellite imaging system with edge processing, the satellite imaging system comprising:
at least one first imaging unit configured to capture and process imagery of a first field of view;
at least one second imaging unit configured to capture and process imagery of a second field of view that is proximate to and larger than a size of the first field of view; and
a hub processing unit linked to the at least one first imaging unit and the at least one second imaging unit.

2. The satellite imaging system of claim 1, wherein the at least one first imaging unit configured to capture and process imagery of a first field of view comprises:
at least one first imaging unit that includes a first optical arrangement, a first image sensor, and a first image processor that is configured to capture and process imagery of a first field of view.

3. The satellite imaging system of claim 1, wherein the at least one first imaging unit configured to capture and process imagery of a first field of view comprises:
at least one first imaging unit configured to capture and process ultra-high resolution imagery of a first field of view.

4-5. (canceled)

6. The satellite imaging system of claim 1, wherein the at least one first imaging unit configured to capture and process imagery of a first field of view comprises:
at least one first imaging unit configured to capture and process visible imagery of a first field of view.

7. The satellite imaging system of claim 1, wherein the at least one first imaging unit configured to capture and process imagery of a first field of view comprises:
at least one first imaging unit configured to capture and process infrared imagery of a first field of view.

8. The satellite imaging system of claim 1, wherein the at least one first imaging unit configured to capture and process imagery of a first field of view comprises:
at least one first imaging unit configured to capture and perform first order processing on imagery of a first field of view prior to communication of at least some of the imagery of the first field of view to the hub processing unit.

9. The satellite imaging system of claim 1, wherein the at least one first imaging unit configured to capture and process imagery of a first field of view comprises:
at least one first imaging unit configured to capture and process imagery of a first central field of view.

10-13. (canceled)

14. The satellite imaging system of claim 1, wherein the at least one first imaging unit configured to capture and process imagery of a first field of view comprises:
an array of two or more first imaging units each configured to capture and process imagery of a respective field of view.

15. The satellite imaging system of claim 1, wherein the at least one first imaging unit configured to capture and process imagery of a first field of view comprises:
an array of two or more first imaging units each configured to capture and process imagery of a respective at least partially overlapping field of view.

16. The satellite imaging system of claim 1, wherein the at least one first imaging unit configured to capture and process imagery of a first field of view comprises:
an array of two or more first imaging units each configured to capture and process imagery of a respective field of view as tiles of at least a portion of a scene.

17. (canceled)

18. The satellite imaging system of claim 1, wherein the at least one second imaging unit configured to capture and process imagery of a second field of view that is proximate to and that is larger than a size of the first field of view comprises:
at least one second imaging unit configured to capture and process imagery of a second field of view that is adjacent to and that is larger than a size of the first field of view.

19. The satellite imaging system of claim 1, wherein the at least one second imaging unit configured to capture and process imagery of a second field of view that is proximate to and that is larger than a size of the first field of view comprises:
at least one second imaging unit that includes a second optical arrangement, a second image sensor, and a second image processor that is configured to capture and process imagery of a second field of view that is proximate to and that is larger than a size of the first field of view.

20. The satellite imaging system of claim 1, wherein the at least one second imaging unit configured to capture and process imagery of a second field of view that is proximate to and that is larger than a size of the first field of view comprises:
at least one second imaging unit configured to capture and process ultra-high resolution imagery of a second field of view that is proximate to and that is larger than a size of the first field of view.

21. The satellite imaging system of claim 1, wherein the at least one second imaging unit configured to capture and process imagery of a second field of view that is proximate to and that is larger than a size of the first field of view comprises:
at least one second imaging unit configured to capture and process video of a second field of view that is proximate to and that is larger than a size of the first field of view.

22-23. (canceled)

24. The satellite imaging system of claim 1, wherein the at least one second imaging unit configured to capture and process imagery of a second field of view that is proximate to and that is larger than a size of the first field of view comprises:
at least one second imaging unit configured to capture and process infrared imagery of a second field of view that is proximate to and that is larger than a size of the first field of view.

25. The satellite imaging system of claim 1, wherein the at least one second imaging unit configured to capture and process imagery of a second field of view that is proximate to and that is larger than a size of the first field of view comprises:
at least one second imaging unit configured to capture and perform first order processing on imagery of a second field of view that is proximate to and that is larger than a size of the first field of view prior to communication of at least some of the imagery of the second field of view to the hub processing unit.

26. The satellite imaging system of claim 1, wherein the at least one second imaging unit configured to capture and process imagery of a second field of view that is proximate to and that is larger than a size of the first field of view comprises:
at least one second imaging unit configured to capture and process imagery of a second peripheral field of view that is proximate to and that is larger than a size of the first field of view.

27-30. (canceled)

31. The satellite imaging system of claim 1, wherein the at least one second imaging unit configured to capture and process imagery of a second field of view that is proximate to and that is larger than a size of the first field of view comprises:
an array of two or more second imaging units each configured to capture and process imagery of a respective field of view that is proximate to and that is larger than a size of the first field of view.

32. The satellite imaging system of claim 1, wherein the at least one second imaging unit configured to capture and process imagery of a second field of view that is proximate to and that is larger than a size of the first field of view comprises:
two or more second imaging units each configured to capture and process imagery of a respective at least partially overlapping field of view that is proximate to and that is larger than a size of the first field of view.

33. The satellite imaging system of claim 1, wherein the at least one second imaging unit configured to capture and process imagery of a second field of view that is proximate to and that is larger than a size of the first field of view comprises:
two or more second imaging units each configured to capture and process imagery of a respective field of view as tiles of at least a portion of a scene.

34. (canceled)

35. The satellite imaging system of claim 1, wherein the hub processing unit linked to the at least one first imaging unit and the at least one second imaging unit comprises:
a hub processing unit linked via a high speed data connection to the at least one first imaging unit and the at least one second imaging unit.

36. The satellite imaging system of claim 1, wherein the hub processing unit linked to the at least one first imaging unit and the at least one second imaging unit comprises:
a hub processing unit linked via a low speed data connection to at least one remote communications unit.

37. The satellite imaging system of claim 1, wherein the hub processing unit linked to the at least one first imaging unit and the at least one second imaging unit comprises:
a hub processing unit linked to the at least one first imaging unit and the at least one second imaging unit and configured to perform second order processing on imagery received from at least one of the at least one first imaging unit and the at least one second imaging unit.

38. The satellite imaging system of claim 1, wherein the hub processing unit linked to the at least one first imaging unit and the at least one second imaging unit comprises:
a hub processing unit linked to the at least one first imaging unit and the at least one second imaging unit and configured to at least one of manage, triage, delegate, coordinate, or satisfy one or more incoming requests.

39. The satellite imaging system of claim 1, further comprising:
at least one third imaging unit configured to capture and process imagery of a movable field of view that is smaller than the first field of view.

40. The satellite imaging system of claim 39, wherein the at least one third imaging unit configured to capture and process imagery of a movable field of view that is smaller than the first field of view comprises:
at least one third imaging unit including an optical arrangement mounted on a gimbal that pivots proximate a center of gravity, the at least one third imaging unit configured to capture and process imagery of a movable field of view that is smaller than the first field of view.

41. (canceled)

42. The satellite imaging system of claim 39, wherein the at least one third imaging unit configured to capture and process imagery of a movable field of view that is smaller than the first field of view comprises:
at least one third imaging unit configured to capture and process ultra-high resolution imagery of a movable field of view that is smaller than the first field of view.

43. The satellite imaging system of claim 39, wherein the at least one third imaging unit configured to capture and process imagery of a movable field of view that is smaller than the first field of view comprises:
at least one third imaging unit configured to capture and process visible and infrared imagery of a movable field of view that is smaller than the first field of view.

44. The satellite imaging system of claim 39, wherein the at least one third imaging unit configured to capture and process imagery of a movable field of view that is smaller than the first field of view comprises:
at least one third imaging unit linked to the hub processing unit and configured to capture and process imagery of a movable field of view that is smaller than the first field of view.

45. The satellite imaging system of claim 39, wherein the at least one third imaging unit configured to capture and process imagery of a movable field of view that is smaller than the first field of view comprises:
at least one third imaging unit under control of the hub processing unit and configured to capture and process imagery of a movable field of view that is smaller than the first field of view.

46. The satellite imaging system of claim 39, wherein the at least one third imaging unit configured to capture and process imagery of a movable field of view that is smaller than the first field of view comprises:
at least one third imaging unit configured to capture and perform first order processing of imagery of a movable field of view that is smaller than the first field of view prior to communication of at least some of the imagery to the hub processing unit.

47. The satellite imaging system of claim 39, wherein the at least one third imaging unit configured to capture and process imagery of a movable field of view that is smaller than the first field of view comprises:
at least one third imaging unit configured to capture and process imagery of a movable field of view that is smaller than the first field of view, the movable field of view being directable across any portion of the first field of view or the second field of view.

48. The satellite imaging system of claim 39, wherein the at least one third imaging unit configured to capture and process imagery of a movable field of view that is smaller than the first field of view comprises:
at least one third imaging unit configured to capture and process imagery of a movable field of view that is smaller than the first field of view, the movable field of view being directable outside of the first field of view and the second field of view.

49-51. (canceled)

52. The satellite imaging system of claim 39, wherein the at least one third imaging unit configured to capture and process imagery of a movable field of view that is smaller than the first field of view comprises:
at least one third imaging unit that includes a third optical arrangement, a third image sensor, and a third image processor that is configured to capture and process imagery of a movable field of view that is smaller than the first field of view.

53. The satellite imaging system of claim 1, further comprising:
at least one fourth imaging unit configured to capture and process imagery of a field of view that at least includes the first field of view and the second field of view.

54. The satellite imaging system of claim 1, further comprising:
at least one wireless communication interface linked to the hub processing unit.

55. The satellite imaging system of claim 1, further comprising:
at least one satellite bus to which the at least one first imaging unit, the at least one second imaging unit, and the hub processing unit are mounted.

56-68. (canceled)

69. A satellite with image edge processing, the satellite comprising:
a satellite bus with an imaging system including at least:
an array of nine first imaging units arranged in a grid and each configured to capture and process imagery of a respective first field of view;
an array of six second imaging units each configured to capture and process imagery of a respective second field of view that is proximate to and larger than the first field of view;
an array of eleven independently movable third imaging units each configured to capture and process imagery of a third field of view that is smaller than the first field of views and that is directable at least within the first field of views and the second field of views;
at least one fourth imaging unit configured to capture and process imagery of an fourth field of view that at least includes the first field of views and the second field of views; and
a hub processing unit linked to each of the nine first imaging units, the six second imaging units, the eleven independently movable third imaging units, and the at least one fourth imaging unit.

70. A process performed by a satellite imaging system with edge processing, the satellite imaging system including at least one first imaging unit, at least one second imaging unit, and a hub processing unit linked to the at least one first imaging unit and the at least one second imaging unit, the process comprising:
capture and process imagery of a first field of view using the at least one first imaging unit; and
capture and process imagery of a second field of view that is proximate to and larger than a size of the first field of view using the at least one second imaging unit.

71-120. (canceled)
